(19) United States
(12) Patent Application Publication
(10) Pub. No.: US 2011/0246133 A1
(43) Pub. Date: Oct. 6, 2011

(54) ROTATOR SENSOR

(75) Inventors: Tomoyuki HARADA, Nagoya-city (JP); Hirofumi Uenoyama, Kitanagoya-city (JP); Takashi Ishikawa, Anjo-city (JP)

(73) Assignee: DENSO CORPORATION, Kariya-city (JP)

(21) Appl. No.: 13/031,810

(22) Filed: Feb. 22, 2011

(30) Foreign Application Priority Data
Mar. 2, 2010 (JP) 2010-45175
Mar. 2, 2010 (JP) 2010-45176
Dec. 2, 2010 (JP) 2010-269131

(51) Int. Cl. G01B 7/30; G06F 15/00

(52) U.S. Cl. 702/151; 324/207.14

(57) ABSTRACT

A rotation sensor includes: a magnetism generator; a sensor chip having a magneto-resistance element region and a Hall element region; and a detection circuit for detecting a relative rotation angle with reference to the magnetism generator according to output signals from each magneto-resistance element and each Hall element to detect. A phase difference is provided between output signals from the magneto-resistance elements. A phase difference is provided between output signals from the Hall elements. The magneto-resistance element region and the Hall element region at least partially overlap with each other. The detection circuit includes a comparison section, an angle computing section, and an output section. The comparison section compares an output level from each Hall element with a predetermined threshold value level, and provides a comparison result for each Hall element. The angle computing section calculates a calculation angle corresponding to the relative rotation angle with using an output signal from each magneto-resistance element. The output section compares the calculation angle with a predetermined threshold value, and provides a comparison result for each magneto-resistance element. The output section outputs a signal corresponding to the relative rotation angle based on a comparison result from the output section and a comparison result from the comparison section.

### CROSS REFERENCE TO RELATED APPLICATIONS

This application is based on Japanese Patent Applications No. 2010-45175 filed on Mar. 2, 2010, No. 2010-45176 filed on Mar. 2, 2010, No. 2010-269131 filed on Dec. 2, 2010, the disclosures of which are incorporated herein by reference.

### FIELD OF THE INVENTION

The present invention relates to a to a rotation sensor that includes a magneto-resistance element, a Hall element, and a sensor chip rotating relatively to a magnetism generator, and detects a relative rotation angle with reference to the magnetism generator using output signals from the magneto-resistance element and the Hall element. More particularly, the invention relates to a rotation sensor that places a magneto-electric conversion element in a magnetic field of the magnetism generator and calculates a relative rotation angle of the magnetism generator using a signal output from the magneto-electric conversion element.

### BACKGROUND OF THE INVENTION

FIGS. 30A and 30B illustrate a rotation sensor according to a conventional technology (Patent Document 1). As shown in FIG. 30A, the rotation sensor includes a magnetic sensor 100 and a Hall element 101 on the surface of a printed circuit board 104. The magnetic sensor 100 is positioned opposite a rotational plane of the permanent magnet 107 so as to be able to detect a magnetic field 106. The magnetic field 106 is generated from the permanent magnet 107 parallel to the surface of the printed circuit board 104. The Hall element 101 is positioned outside the permanent magnet 107 so as to be able to detect a magnetic field 105. The magnetic field 105 is generated from the permanent magnet 107 perpendicularly to the surface of the printed circuit board 104. As shown in FIG. 30B, the Hall element 101 includes two horizontal Hall elements 102 and 103. The horizontal Hall elements 102 and 103 are located so as to form angle γ viewed from the magnetic sensor 100 in the planar direction.

When the permanent magnet 107 rotates one turn, the magnetic sensor 100 outputs a signal at the electric angle of 180° per wavelength, and the horizontal Hall elements 102 and 103 each output a signal at the electric angle of 360° per wavelength. A rotation angle α for the permanent magnet 107 is found within an angular range of up to 180° based on the output signal from the magnetic sensor 100. The magnitude relation of output values from the horizontal Hall elements 102 and 103 is used to determine whether the rotation angle α for the permanent magnet 107 belongs to the range 0°≦α≦90°, 90°≦α≦180°, 180°≦α≦270°, or 270°≦α≦360°. According to Patent Document 1, it is preferable to ensure a layout angle γ of 90° between the horizontal Hall elements 102 and 103 with reference to the magnetic sensor 100 in order to accurately determine the range for the rotation angle.

The conventional rotation sensor requires the horizontal Hall elements 102 and 103 to be positioned below and at the center of the permanent magnet 107 in order to ensure the layout angle γ of 90° between the horizontal Hall elements 102 and 103 with reference to the magnetic sensor 100.

When the horizontal Hall elements 102 and 103 are positioned below and at the center of the permanent magnet 107, however, the magnetic field 105 generated from the permanent magnet 107 is not vertically applied to the horizontal Hall elements 102 and 103. It is impossible to determine the range of the rotation angle for the permanent magnet 107 based on outputs from the horizontal Hall elements 102 and 103. An interval between the horizontal Hall elements 102 and 103 needs to be increased in order to ensure the angle γ of 90° within a layout range where the magnetic field 105 is vertically applied to the horizontal Hall elements. This makes the single chip configuration difficult. The printed circuit board 104 needs to be large. The rotation sensor becomes large-sized.

The conventional rotation sensor has been hardly miniaturized while improving the accuracy of detecting a rotation angle.

The conventional rotation sensor needs to always determine a range of the relative rotation angle α for the permanent magnet 107 while the permanent magnet 107 is rotating.

The conventional rotation sensor takes a long time to compute the relative rotation angle α for the permanent magnet 107.

Generally, the conventional rotation sensor uses a so-called tracking circuit as an arithmetic circuit to compute the relative rotation angle based on a signal from the magneto-electric conversion element. For example, Patent Document 2 discloses the tracking circuit that causes digital angle output (φ) from rotation detection signals sin θ·f(t) and cos θ·f(t) generated from a rotation detector (1). However, the conventional tracking circuit is unconcerned in phase shifting due to such structural errors in the sensing section as a shape error of the resolver and a layout error of the magnetism detection element. An angle error may result from the structural errors.
Patent Document 1: Japanese Published Unexamined Patent Application No. Hei 11-94512 (paragraphs 22 through 24, FIGS. 4 and 5)
Patent Document 2: Japanese Published Unexamined Patent Application No. 2000-353957

### SUMMARY OF THE INVENTION

The present invention has been made in consideration of the foregoing. It is therefore an object of the invention to provide a rotation sensor that can be miniaturized while improving the rotation angle detection accuracy. It is a more specific object of the invention to provide a rotation sensor that can shorten the time to compute a relative rotation angle of a magnetism generator. It is another object of the invention to provide a rotation sensor that can accurately compute a relative rotation angle by reflecting a phase difference due to a structural error.

According to a first aspect of the present disclosure, a rotation sensor includes: a magnetism generator that generates a magnetic field; a sensor chip having a magneto-resistance element region and a Hall element region, wherein the magneto-resistance element region includes a plurality of magneto-resistance elements, and the Hall element region includes a plurality of Hall elements; and a detection circuit that detects a relative rotation angle in relation to the magnetism generator according to output signals from each magneto-resistance element and each Hall element. Each magneto-resistance element provides a magneto-resistance effect with respect to the magnetic field. Each Hall element provides a Hall effect with respect to the magnetic field. The plurality of magneto-resistance elements are arranged in the magneto-resistance element region so as to cause a phase difference between output signals of the magneto-resistance elements. The plurality of Hall elements are arranged in the Hall element region so as to cause a phase difference between output signals of the Hall elements. The magneto-resistance element region and the Hall element region at least partially overlap with each other. The detection circuit includes a comparison section, an angle computing section, and an output section. The comparison section compares an output level from each Hall element with a predetermined threshold value level, and provides a comparison result for each Hall element. The angle computing section calculates a calculation angle corresponding to the relative rotation angle according to an output signal from each magneto-resistance element. The output section compares the calculation angle with a predetermined threshold value, and provides a comparison result for each magneto-resistance element. The output section outputs a signal corresponding to the relative rotation angle based on the comparison result of the output section and the comparison result of the comparison section.

The above-mentioned rotation sensor can be miniaturized because the magneto-resistance element region and the Hall element region at least partly overlap with each other. The rotation sensor outputs a signal corresponding to the relative rotation angle using not only a result of comparison between an output level from each Hall element and a threshold level, but also a result of comparison between an angle computed by the angle computing section and threshold angle. Accordingly, the detection accuracy of relative rotation angles can be improved. In other words, the result of comparison between a value computed by the angle computing section and a threshold value can compensate for an unstable factor in the result of comparison between an output level from each Hall element and a threshold level. Therefore, the detection accuracy of relative rotation angles can be improved.

According to a second aspect of the present disclosure, a rotation sensor includes: a rotatable magnetism generator; a plurality of magneto-electric conversion elements positioned in a magnetic field of the magnetism generator rotating relatively with the magneto-electric conversion elements, wherein each magneto-electric conversion element outputs a signal with a signal level changing at two cycles in accordance with an intensity of the magnetic field during one rotation of the magnetism generator, and wherein the magneto-electric conversion elements are positioned so as to cause a phase difference between signals of the magneto-electric conversion elements; a detection circuit that detects a relative rotation angle with reference to the magnetism generator according to a signal output from each magneto-electric conversion element; and a plurality of detection elements, wherein each detection element outputs a detection signal with a signal level changing at one cycle in accordance with an intensity of the magnetic field during one rotation of the magnetism generator, and wherein the detection elements are positioned so as to cause a phase difference between detection signals of the detection elements. The detection circuit includes an angle computing section, an initial value determination section, and an output section. The angle computing section calculates a calculation angle corresponding to a relative rotation angle according to a signal output from each magneto-electric conversion element. The angle computing section performs feedback control so that a difference between the relative rotation angle and the calculation angle converges on a predetermined value. The initial value determination section compares a signal level for each detection signal with a predetermined threshold value, and determines an angular range that includes an initial value for the relative rotation angle. The initial value determination section determines an initial value for the calculation angle so that an absolute value of a difference between the initial value for the calculation angle and the initial value for the relative rotation angle available in the determined angular range becomes smaller than 90°. The output section outputs a signal corresponding to the calculation angle at one cycle during one rotation of the magnetism generator. The initial value determination section determines an initial value for the calculation angle only before the magnetism generator starts relative rotation. The angle computing section starts the feedback control with using an initial value for the calculation angle, the initial value being determined by the initial value determination section.

In the above-mentioned rotation sensor, the initial value determination section determines an initial value for the computed angle only before the magnetism generator starts relative rotation. The rotation sensor can shorten the time to compute a relative rotation angle while the magnetism generator makes relative rotation. A conventional rotation sensor always needs to use signal levels for the detection signals from the detection elements during relative rotation of the magnetism generator to determine an angular range covering the relative rotation angle. On the other hand, the above-mentioned sensor uses signal levels of the detection signals from the detection elements only in order to determine an initial value for the computed angle before the magnetism generator starts relative rotation. During relative rotation of the magnetism generator, the sensor need not compare a signal level of each detection signal from each detection element with a threshold value. It is possible to shorten the time to compute a relative rotation angle.

According to a third aspect of the present disclosure, a rotation sensor includes: a rotatable magnetism generator; a plurality of magneto-electric conversion elements positioned in a magnetic field generated by the magnetism generator relatively rotating, wherein each magneto-electric conversion element outputs a signal with a signal level changing at two cycles in accordance with intensity of the magnetic field during one rotation of the magnetism generator, and wherein the magneto-electric conversion elements are positioned so as to cause a phase difference between signals; a detection circuit that detects a relative rotation angle with reference to the magnetism generator according to the signal output from each magneto-electric conversion element; and a plurality of detection elements, wherein each detection element outputs a detection signal with a signal level changing at one cycle in accordance with intensity of the magnetic field during one rotation of the magnetism generator, and wherein the detection elements are positioned so as to cause a phase difference between detection signals. The detection circuit includes an angle computing section, an initial value determination section and an output section. The angle computing section calculates a calculation angle corresponding to a relative rotation angle according to the signal output from each magneto-electric conversion element. The angle computing section performs feedback control so that a difference between the relative rotation angle and the calculation angle converges on a predetermined value. The initial value determination section compares a signal level for each detection signal with a predetermined threshold value, and determines an angular range that includes an initial value for the relative rotation angle, based on a result of the comparison. The initial value determination section determines an initial value for the calculation angle so that an absolute value for a difference between an initial value for the calculation angle and an initial value for the relative rotation angle available in the determined angular range becomes smaller than 90°. The output section outputs a signal corresponding to the calculation angle at one cycle during one rotation of the magnetism generator. The initial value determination section determines an initial value for the calculation angle before the magnetism generator starts relative rotation and at a predetermined time after the magnetism generator starts relative rotation. The angle computing section starts to execute the feedback control with using the initial value for the calculation angle determined by the initial value determination section.

In the above-mentioned rotation sensor, the initial value determination section determines an initial value for the computed angle before the magnetism generator starts relative rotation and at a specified time after the relative rotation starts. The rotation sensor can shorten the time to compute a relative rotation angle while the magnetism generator makes relative rotation. A conventional rotation sensor always needs to use signal levels for the detection signals from the detection elements during relative rotation of the magnetism generator to determine the angular range covering the relative rotation angle. On the other hand, the sensor according the second aspect uses signal levels of the detection signals from the detection elements only in order to determine an initial value for the computed angle before the magnetism generator starts relative rotation and at a predetermined time after the relative rotation starts. The sensor need not compare a signal level of each detection signal from each detection element with a threshold value each time the magnetism generator makes relative rotation. It is possible to shorten the time to compute a relative rotation angle.

According to a fourth aspect of the present disclosure, a rotation sensor includes: a rotatable magnetism generator; a plurality of magneto-electric conversion elements positioned in a magnetic field generated by the magnetism generator relatively rotating, wherein the plurality of magneto-electric conversion elements output a first signal and a second signal, each of which has a signal level changing at N cycles in accordance with intensity of the magnetic field during one rotation of the magnetism generator, wherein N is a natural number, and wherein the magneto-electric conversion elements are positioned so as to cause a phase difference between the first signal and the second signal; and a detection circuit that detects a relative rotation angle with reference to the magnetism generator according to the first signal and the second signal output from each magneto-electric conversion element. The detection circuit includes an angle computing section and an output section. The angle computing section calculates a calculation angle corresponding to the relative rotation angle with using the first signal and the second signal. The angle computing section performs feedback control so that a difference between the relative rotation angle defined as θ and the calculation angle defined as φ converges on a predetermined value. The output section outputs a signal corresponding to the calculation angle. The angle computing section generate a first cycle signal and a second cycle signal, each of which is modified by a predetermined shift amount, based on the first signal and the second signal output from the plurality of magneto-electric conversion elements. The angle computing section generates a difference of (Nθ−Nφ) by correcting the first cycle signal and the second cycle signal with using a correction value corresponding to the shift amount. The angle computing section performs feedback control so that the difference of (Nθ−Nφ) approaches the predetermined value.

The above-mentioned sensor can generate the first cycle signal and the second cycle signal reflecting the predetermined shift amount a based on the first and second signals that are output from the magneto-electric conversion elements and contains different phases. The sensor can generate a difference (Nθ−Nφ) by correcting the first cycle signal and the second cycle signal through use of a correction value reflecting the shift amount α and provide feedback control. The sensor can accurately compute a relative rotation angle θ by reflecting a phase difference due to a structural error.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a major configuration of a rotation sensor according to a first embodiment;

FIG. 2A is a vertical sectional view showing a sensor chip and a permanent magnet of the sensor shown in FIG. 1;

FIG. 2B is a plan view of the permanent magnet shown in FIG. 2A;

FIG. 3 is a vertical sectional view showing the permanent magnet shown in FIG. 2A rotated 180°;

FIG. 4A is a plan view showing a structure of the sensor chip;

FIG. 4B is a cross sectional view taken along the line IVB-IVB of FIG. 4A;

FIG. 5A is a plan view showing a magneto-resistance element region E1 and a Hall element area E2;

FIG. 5B shows a layout angle between Hall elements H1 and H2;

FIG. 6 is a plan view schematically showing a structure of an AMR sensor M1;

FIG. 7 is a plan view schematically showing a structure of an AMR sensor M2;

FIG. 8 shows an equivalent circuit for the AMR sensor M1;

FIG. 9 shows an equivalent circuit for the AMR sensor M2;

FIG. 10A schematically shows the AMR sensor M1;

FIG. 10B schematically shows the AMR sensor M2;

FIG. 10C schematically shows the Hall elements H1 and H2;

FIG. 10D shows an output signal from the AMR sensor M1;

FIG. 10E shows an output signal from the AMR sensor M2;

FIG. 10F shows an output signal from the Hall element H1;

FIG. 10G shows an output signal from the Hall element H2;

FIG. 11A is a plan view showing the Hall element H2 and its partial vicinity;

FIG. 11B is a cross sectional view taken along the line XIB-XIB of FIG. 11A;

FIG. 11C is a cross sectional view taken along the line XIC-XIC of FIG. 11A;

FIG. 12 is a block diagram showing a major electric configuration of the rotation sensor 1 and corresponds to FIG. 1;

FIG. 13A shows an output waveform from the Hall element H1;

FIG. 13B shows an output waveform from a comparison circuit 53a;

FIG. 13C shows an output waveform from the Hall element H2;

FIG. 13D shows an output waveform from a comparison circuit 53b;

FIG. 13E shows an output waveform from an angle computing section 60 to represent a computed angle;

FIG. 13F is a waveform diagram showing a result of comparison between a computed angle φ and a threshold angle φth shown in FIG. 13E;

FIG. 13G shows an output waveform from an output logic circuit 71;

FIG. 14A shows relation among signal levels for first and second pulse signals VH1 and VH2 output from the comparison circuits 53a and 53b, results of comparison between the computed angle φ and the threshold angle φth, and angular ranges for a relative rotation angle θ when the Hall elements H1 and H2 are shifted +45°;

FIG. 14B shows relation among signal levels for first and second pulse signals VH1 and VH2 output from the comparison circuits 53a and 53b, results of comparison between the computed angle φ and the threshold angle nth, and angular ranges for a relative rotation angle θ when the Hall elements H1 and H2 are shifted −45°;

FIG. 15A is a plan view schematically showing a structure of a sensor chip provided for a rotation sensor according to a second embodiment;

FIG. 15B is a cross sectional view taken along the line XVB-XVB of FIG. 15A;

FIG. 16 is a block diagram showing a major electric configuration of the rotation sensor 1 according to the second embodiment;

FIG. 17A shows an output waveform from the Hall element H1;

FIG. 17B shows an output waveform from a comparison circuit 53a;

FIG. 17C shows an output waveform from the Hall element H2;

FIG. 17D shows an output waveform from a comparison circuit 53b;

FIG. 17E shows an output waveform from the angle computing section 60 to represent a computed angle;

FIG. 17F is a waveform diagram showing a result of comparison between the computed angle φ and the threshold angle nth shown in FIG. 17E;

FIG. 17G shows an output waveform from the output logic circuit 71;

FIG. 18A schematically shows a structure of a sensor chip provided for a rotation sensor according to a third embodiment with the reference direction shifted +45° for relative rotation angle 0°;

FIG. 18B schematically shows the structure of the sensor chip provided for the rotation sensor according to the third embodiment with the reference direction shifted −45° for relative rotation angle 0°;

FIGS. 19A and 19B show layouts of Hall elements provided for a rotation sensor according to a fourth embodiment;

FIGS. 20A and 20B are vertical sectional views showing a sensor chip and a permanent magnet provided for a rotation sensor according to a fifth embodiment;

FIG. 21A is a plan view exemplifying the use of a sensor chip provided for a reception according to a sixth embodiment;

FIG. 21B is a cross sectional view taken along the line XXIB-XXIB of FIG. 21A;

FIGS. 22A and 22B are plan views showing a sensor chip and a rotating body provided for a rotation sensor according to a modification example of the sixth embodiment;

FIGS. 23A and 23B are cross sectional views exemplifying the use of a sensor chip provided for a rotation sensor according to a seventh embodiment;

FIG. 24A is a plan view schematically showing a structure of a sensor chip provided for a rotation sensor according to an eighth embodiment;

FIG. 24B is a cross sectional view taken along the line XXIVB-XXIVB of FIG. 24A;

FIG. 25 shows an equivalent circuit for an AMR sensor provided for a rotation sensor according to a ninth embodiment;

FIG. 26A is a plan view schematically showing a structure of a sensor chip provided for a rotation sensor according to a tenth embodiment;

FIG. 26B is a cross sectional view taken along the line XXVIB-XXVIB of FIG. 26A;

FIG. 27 is a block diagram showing part of a major electric configuration of a rotation sensor according to the tenth embodiment;

FIG. 28 is a block diagram showing a configuration of the angle computing section 60 provided for a rotation sensor according to an eleventh embodiment;

FIG. 29 is a block diagram showing a major electric configuration of a rotation sensor according to a twelfth embodiment;

FIGS. 30A and 30B are explanatory diagrams showing a conventional rotation sensor;

FIG. 31 is a block diagram showing a major configuration of a rotation sensor according to a thirteenth embodiment;

FIG. 32A is a vertical sectional view of the sensor chip and the permanent magnet and exemplifies the use of the sensor chip shown in FIG. 31;

FIG. 32B is a plan view of the permanent magnet shown in FIG. 32A;

FIG. 33 is a vertical sectional view showing the permanent magnet shown in FIG. 32A rotated 180°;

FIG. 34A is a plan view schematically showing a structure of the sensor chip;

FIG. 34B is a cross sectional view taken along the line XXXIVB-XXXIVB of FIG. 34A;

FIG. 35A is a plan view showing the magneto-resistance element region E1 and the Hall element area E2;

FIG. 35B shows a layout angle between the Hall elements H1 and H2;

FIG. 36 is a plan view schematically showing a structure of the AMR sensor M1;

FIG. 37 is a plan view schematically showing a structure of the AMR sensor M2;

FIG. 38A schematically shows the AMR sensor M1;

FIG. 38B schematically shows the AMR sensor M2;

FIG. 38C schematically shows the Hall elements H1 and H2;

FIG. 38D shows an output signal from the AMR sensor M1;

FIG. 38E shows an output signal from the AMR sensor M2;

FIG. 38F shows an output signal from the Hall element H1;

FIG. 38G shows an output signal from the Hall element H2;

FIG. 39A is a plan view showing the Hall element H2 and its partial vicinity;

FIG. 39B is a cross sectional view taken along the line XXXIXB-XXXIXB of FIG. 39A;

FIG. 39C is a cross sectional view taken along the line XXXIXC-XXXIXC of FIG. 39A;

FIG. 40 is a block diagram showing a major electric configuration of the rotation sensor 1 and corresponds to FIG. 31;

FIG. 41 shows signal flows between blocks in FIG. 40;

FIG. 42 shows a configuration of an initial value table 53d shown in FIG. 40;

FIG. 43A shows an output waveform from the Hall element H1;

FIG. 43B shows an output waveform from the comparison circuit 53a;

FIG. 43C shows an output waveform from the Hall element H2;

FIG. 43D shows an output waveform from the comparison circuit 53b;

FIG. 43E shows an output waveform from an output section 70;

FIGS. 44A through 44C show a process in which an initial value φ0 for the computed angle φ follows an initial value θ0 for a relative rotation angle θ;

FIGS. 45A through 45C show another process in which the initial value φ0 for the computed angle φ follows the initial value θ0 for the relative rotation angle θ;

FIGS. 46A through 46C show still another process in which the initial value φ0 for the computed angle follows the initial value θ0 for the relative rotation angle θ;

FIGS. 47A through 47C show yet another process in which the initial value φ0 for the computed angle φ follows the initial value θ0 for the relative rotation angle θ;

FIGS. 48A through 48C show still yet another process in which the initial value φ0 for the computed angle φ follows the initial value θ0 for the relative rotation angle θ;

FIGS. 49A through 49C show yet still another process in which the initial value φ0 for the computed angle φ follows the initial value θ0 for the relative rotation angle θ;

FIG. 50 shows a margin for the initial value θ0 corresponding to the initial value φ0;

FIG. 51 schematically shows a structure of a sensor chip provided for a rotation sensor according to a fourteenth embodiment;

FIGS. 52A through 52E show output signals from the AMR sensors M1 and M2 and the Hall elements H1 and H2;

FIG. 53 shows a configuration of the initial value table 53d;

FIG. 54 shows a margin for the initial value θ0 corresponding to the initial value φ0;

FIG. 55 schematically shows a structure of a sensor chip provided for a rotation sensor according to a fifteenth embodiment;

FIGS. 56A through 56G show output signals from the AMR sensors M1 and M2 and the Hall elements H1 through H3;

FIG. 57 shows a configuration of the initial value table 53d;

FIG. 58 shows a margin for the initial value θ0 corresponding to the initial value φ0;

FIG. 59 shows a configuration of the initial value table 53d according to a sixteenth embodiment;

FIG. 60 shows a margin for the initial value θ0 corresponding to the initial value φ0;

FIG. 61 shows signal flows between blocks in a rotation sensor according to an eighteenth embodiment; and

FIG. 62 shows signal flows between blocks in a rotation sensor according to a nineteenth embodiment.

### DETAILED DESCRIPTION

### First Embodiment

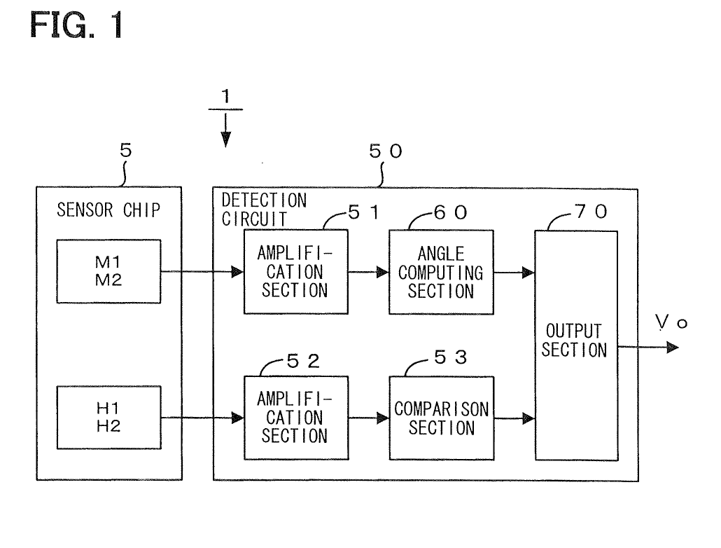

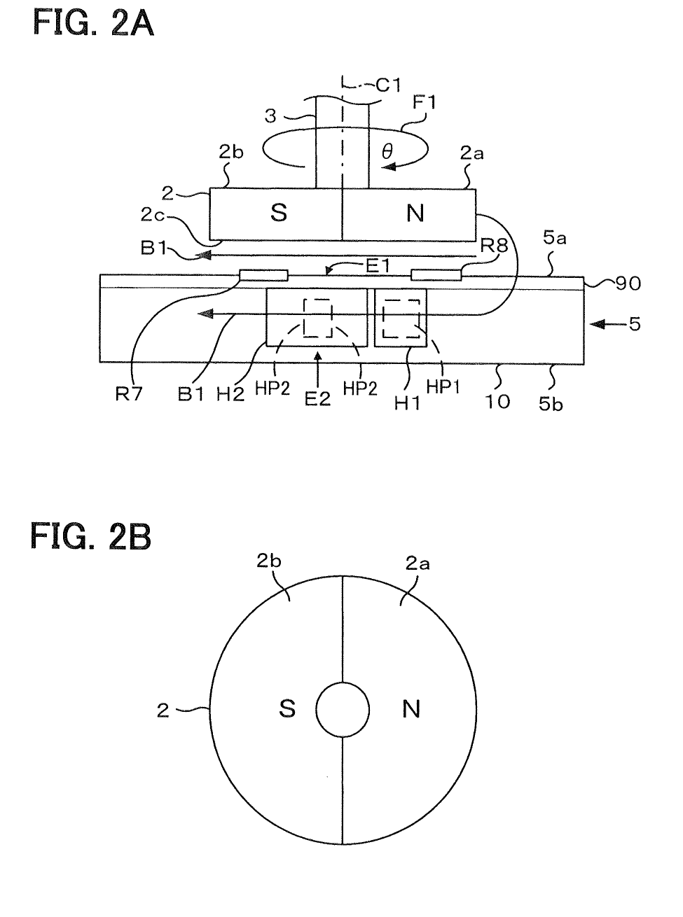

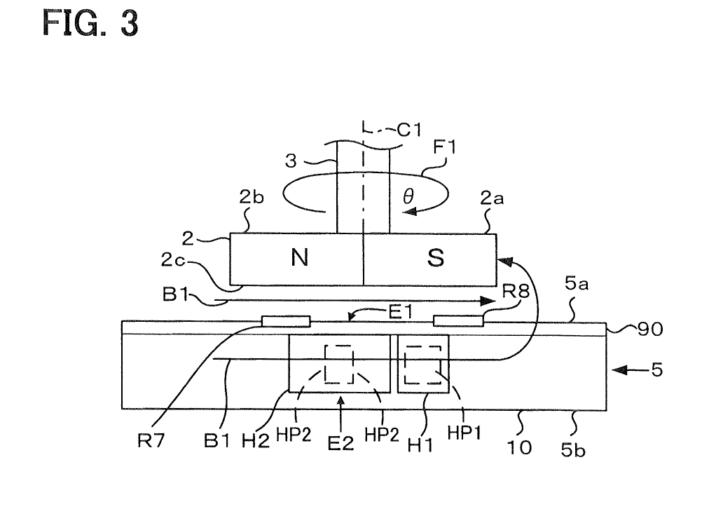

Embodiments of the present invention will be described with reference to the accompanying drawings. FIG. 1 is a block diagram showing a major configuration of a rotation sensor according to a first embodiment. FIG. 2A is an explanatory diagram exemplifying the use of a sensor chip shown in FIG. 1 and provides a vertical sectional view showing the sensor chip and a permanent magnet. FIG. 2B is a plan view of the permanent magnet shown in FIG. 2A. FIG. 3 is a vertical sectional view showing the permanent magnet shown in FIG. 2A rotated 180°.

### (Major Configuration)

The following describes a major configuration of the rotation sensor according to the embodiment. As shown in FIG. 1, the rotation sensor 1 according to the embodiment includes a sensor chip 5 and a detection circuit 50 electrically connected to the sensor chip 5. The sensor chip 5 includes: two anisotropic magneto-resistance (AMR) sensors M1 and M2 using magneto-resistance elements; and two Hall elements H1 and H2.

As shown in FIG. 2A, the sensor chip 5 is positioned opposite a relative rotational plane 2c along the diameter of a permanent magnet (magnetism generator) 2 to be detected. A supporting member (not shown) supports the sensor chip 5 to fix it so that the layout position is unchanged. As shown in FIG. 2B, the permanent magnet 2 is disk-shaped and has different magnetic poles divided in a radial direction of the relative rotational plane 2c. According to the embodiment, the permanent magnet 2 is divided into two equal sizes in the radial direction of the relative rotational plane 2c. One is an N-pole permanent magnet 2a. The other is an S-pole permanent magnet 2b. As shown in FIG. 2A, the permanent magnet 2 is attached to the tip of a rotary shaft 3 and rotates in the direction of an arrow F1.

The permanent magnet 2 generates magnetic fields from the N-pole permanent magnet 2a to the S-pole permanent magnet 2b. The generated magnetic fields include a magnetic field B1 parallel to a surface 5a of the sensor chip 5. According to the example of FIG. 2A, the magnetic field B1 penetrates from the Hall element H1 to the Hall element H2. FIG. 3 shows that the permanent magnet 2 rotates 180° from the state shown in FIG. 2A. In this case, the magnetic field B1 changes the direction 180°. According to the example of FIG. 3, the magnetic field B1 penetrates from the Hall element H2 to the Hall element H1.

As shown in FIG. 1, the detection circuit 50 includes amplification sections 51 and 52, an angle computing section 60, a comparison section 53, and an output section 70. The amplification section 51 amplifies signals output from the AMR sensors M1 and M2. The angle computing section 60 uses an amplified signal output from the amplification section 51 to compute a relative rotation angle (hereafter also referred to as an input angle) θ of the permanent magnet 2. The amplification section 52 amplifies a signal output from each of the Hall elements H1 and H2. The comparison section 53 compares an output level of the amplified Hall element signal output from the amplification section 52 with a threshold level (0 V). The comparison section 53 outputs a pulse signal corresponding to the comparison result to each of the Hall elements.

The output section 70 compares an angle (I) (hereafter referred to as a computed angle) computed by the angle computing section 60 with a threshold angle φth (corresponding to the threshold value). The output section 70 uses this comparison result and the comparison result from the comparison section 53 to determine to which quadrant the relative rotation angle θ belongs, while there are four quadrants 0≦θ≦90°, 90°≦θ≦180°, 180°≦θ≦270°, and 270°≦θ≦360°. The output section 70 uses the determination result and the computed angle φ (corresponding to the computed value) output from the angle computing section 60 to output a signal Vo that represents an output angle corresponding to the relative rotation angle θ ranging from 0° to 360°.

(Sensor Chip Structure)

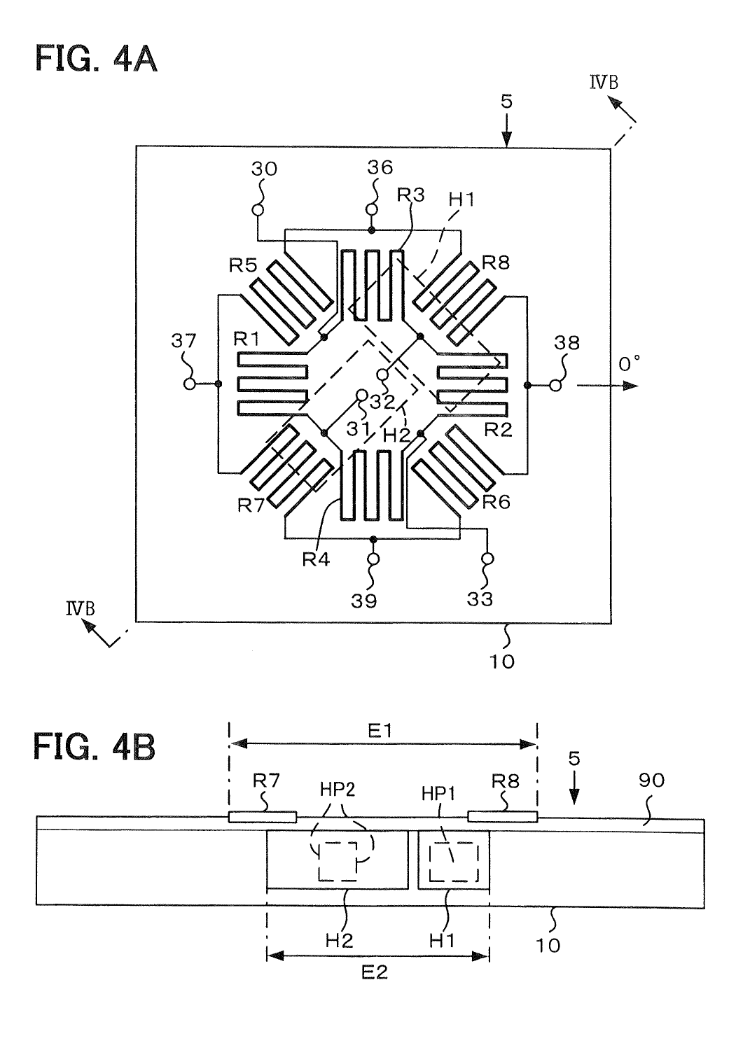

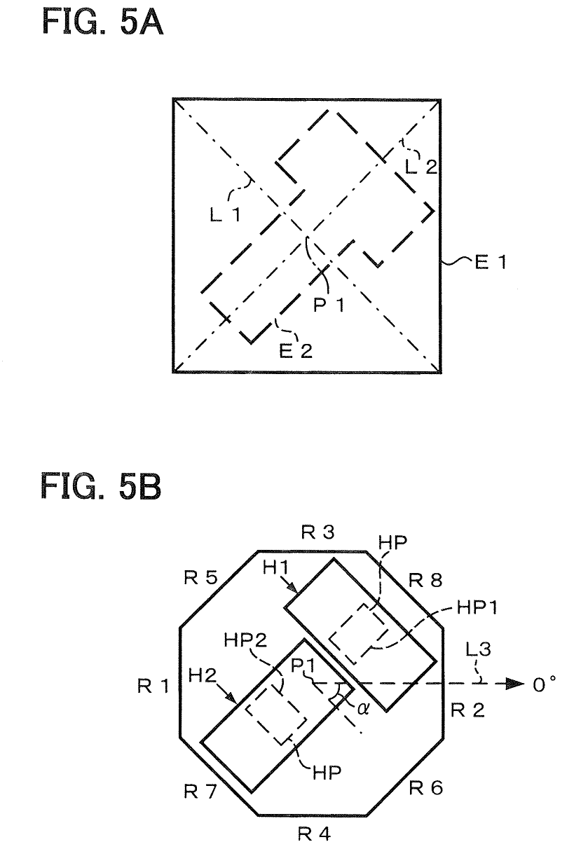

The structure of the sensor chip 5 will be described. FIG. 4A is a plan view schematically showing a structure of the sensor chip. FIG. 4B is a cross sectional view taken along the line IVB-IVB of FIG. 4A. In FIGS. 4A and 4B, magneto-resistance elements R1 through R4 configure an AMR sensor M1. Magnetoresistance elements R5 through R8 configure an AMR sensor M2. FIG. 5A is a plan view showing a magneto-resistance element region E1 and a Hall element area E2. FIG. 5B shows a layout angle between the Hall elements H1 and H2. The sensor chip 5 also includes a magnetism detection section HP. In the drawings, the Hall elements H1 and H2 are illustrated larger than actual sizes in order to clearly represent the layout of the Hall elements H1 and H2. The magneto-resistance elements are also illustrated larger than actual sizes in order to clearly represent the element growth direction.

As shown in FIGS. 4A and 4B, the sensor chip 5 includes a silicon substrate 10, an insulating film 90, the AMR sensors M1 and M2, and the Hall elements H1 and H2. The insulating film 90 is formed on the surface of the silicon substrate 10. The AMR sensors M1 and M2 are formed on the surface of the insulating film 90. The Hall elements H1 and H2 are formed in the silicon substrate 10. The AMR sensor M1 includes the magneto-resistance elements R1 to R4. The AMR sensor M2 includes the magneto-resistance elements R5 to R8. The Hall elements H1 and H2 are positioned below the magneto-resistance elements R1 to R8 so as to overlap with each other through the insulating film 90.

As shown in FIG. 5B, the Hall elements H1 and H2 are positioned so as to form an angle of 90° between magnetism detection planes HP1 and HP2 of the magnetism detection sections HP. Namely, the Hall elements H1 and H2 are positioned so as to cause a phase difference of 90° between output signals. A line is horizontally extended from a relative rotation center P1 of the sensor chip 5 toward the magneto-resistance element R2 and is defined as a reference line L3. The position of the reference line L3 is defined as a reference angle 0°. The Hall element H1 is positioned so that its magnetism detection plane HP1 and the reference line L3 form an angle α of 45°.

The Hall element H2 is also positioned so that its magnetism detection plane HP2 and the reference line L3 form an angle of 45°. Each of the magnetism detection planes HP1 and HP2 of the Hall elements H1 and H2 forms an angle of 45° against an easy axis of magnetization for the magneto-resistance element R2 positioned at the reference angle of 0°. Namely, the Hall element H1 outputs a sin(θ+45°) signal that advances a phase of 45° with reference to the relative rotation angle θ. The Hall element H2 outputs a cos(θ+45°) signal that differs from the Hall element H1 in a phase of 90°.

The magneto-resistance elements R1 through R8 are defined to be positioned in the magneto-resistance element region E1. The Hall elements H1 and H2 are defined to be positioned in the Hall element area E2. FIG. 5A is illustrated based on FIG. 4A. The magneto-resistance element region E1 is quadrangular and has an area approximately equal to the minimum area needed to place the magneto-resistance elements R1 through R8. The magneto-resistance element region E2 is T-shaped and has an area approximately equal to the minimum area needed to place the Hall elements H1 and H2.

As shown in the drawings, the Hall element region E2 is completely placed below the magneto-resistance element region E1. No part of the Hall element region E2 is exposed from the magneto-resistance element region E1.

The intersection of diagonal lines L1 and L2 of the magneto-resistance element region E1 corresponds to the relative rotation center P1 of the sensor chip 5. The diagonal line L2 halves the Hall element region E2 in a longer direction of the T-shape.

In other words, the relative rotation center P1 of the sensor chip 5 is positioned on an extension of a relative rotation axis C1 (FIG. 2A). The relative rotation center P1 of the sensor chip 5 and the relative rotation center of the permanent magnet 2 exist on the same axis. A relative rotation angle of the sensor chip 5 can be detected with reference to the permanent magnet 2 even when the permanent magnet 2 does not rotate and the sensor chip 5 relatively rotates around the relative rotation center P1.

The sensor chip 5 is structured as mentioned above and therefore can reduce its substrate size (width) compared to a conventional rotation sensor that places AMR sensors and Hall elements on the surface of the semiconductor substrate.

The magneto-resistance element region E1 and the Hall element region E2 overlap with each other in a direction corresponding to the relative rotation axis C1 (FIG. 2A) of the permanent magnet 2.

The sensor chip 5 can be reduced toward the rotational center of the permanent magnet 2. It is possible to effectively use the space opposite a rotational plane 2c of the permanent magnet 2.

The area of the sensor chip 5 depends on the magneto-resistance element region E1. Therefore, the area of the sensor chip 5 can be determined based on the area of the magneto-resistance element region E1.

(AMR Sensor Structures)

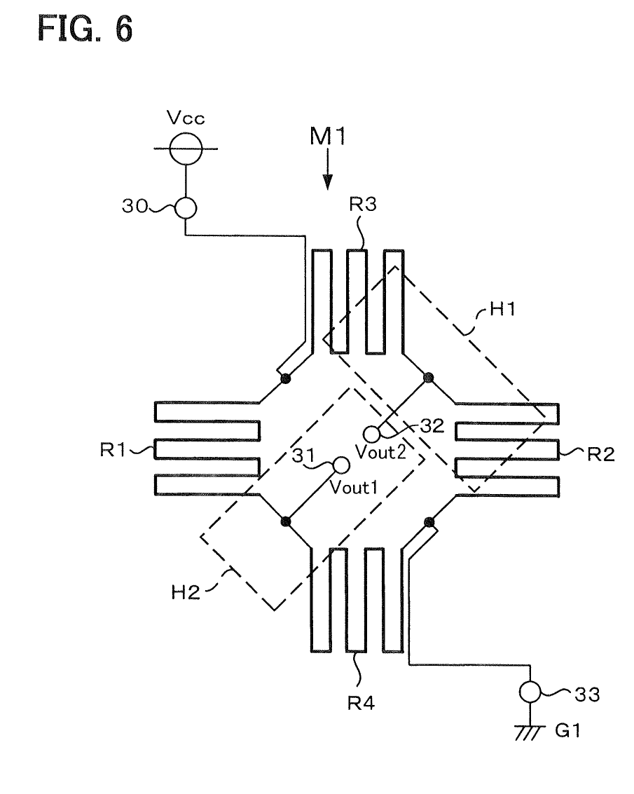

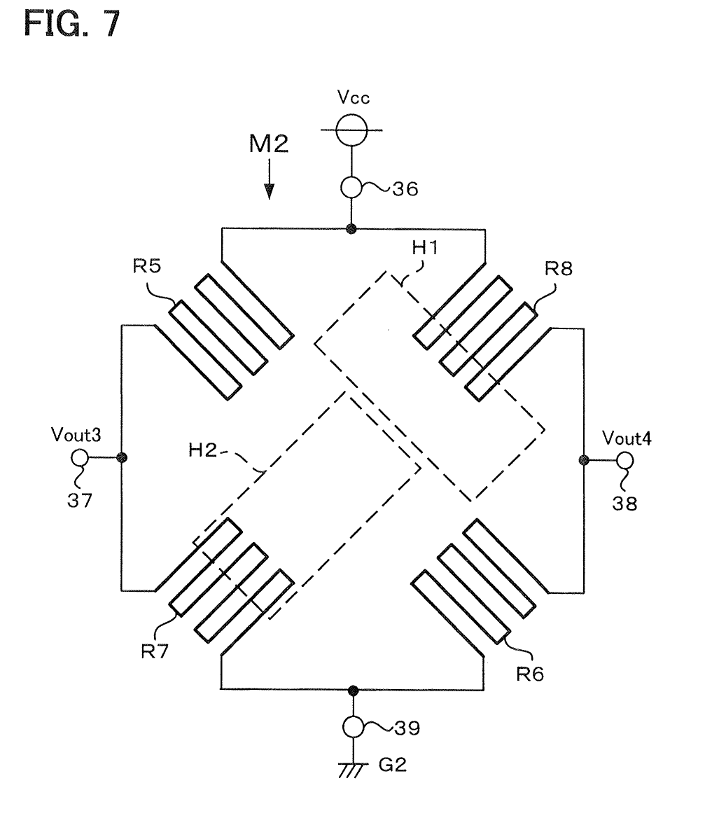

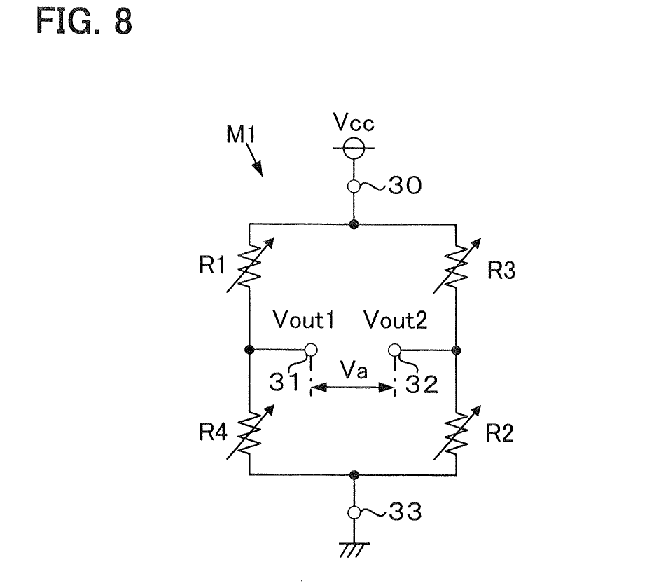

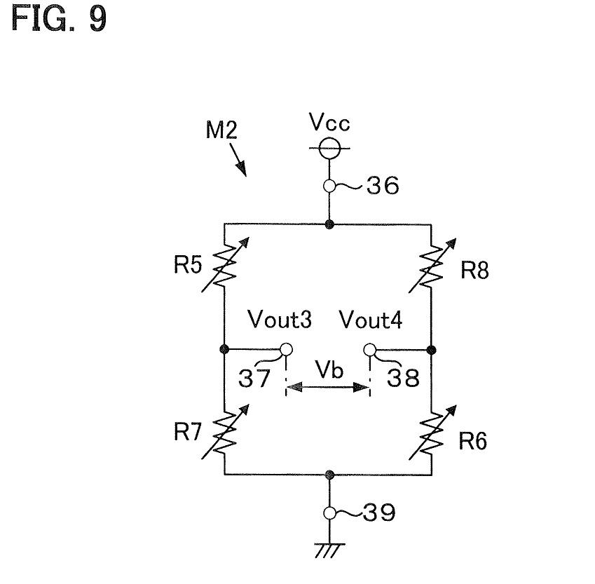

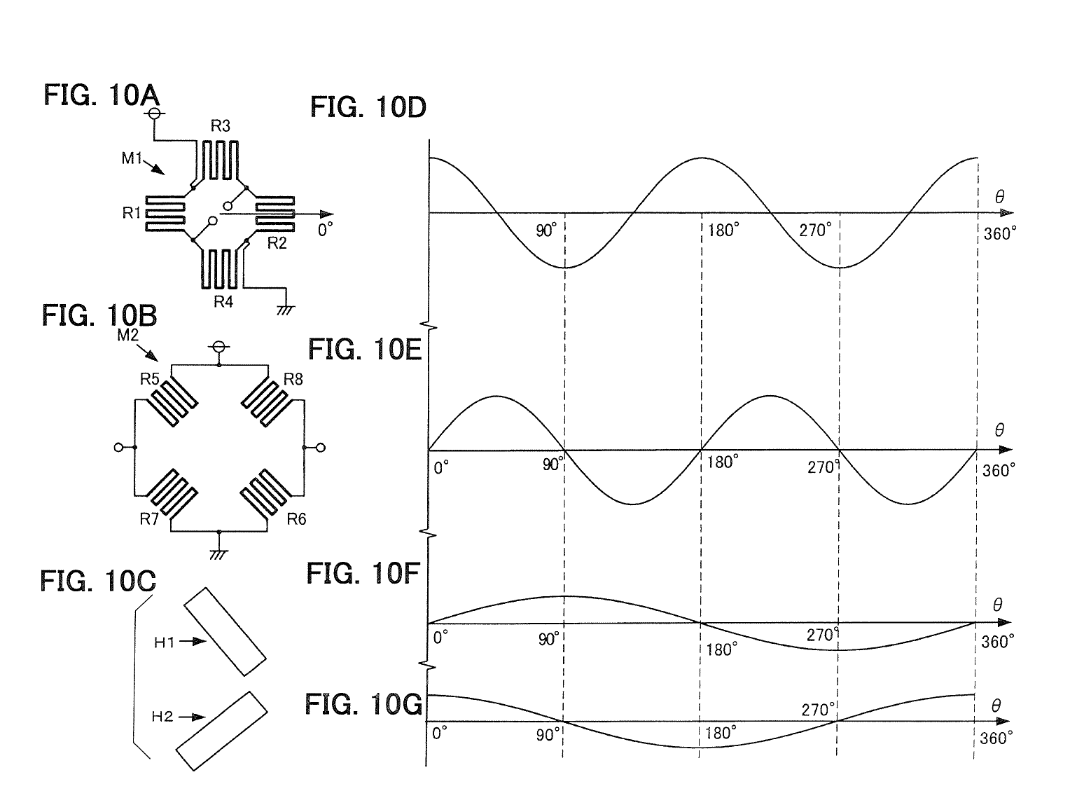

Structures of the AMR sensors M1 and M2 will be described. FIG. 6 is a plan view schematically showing the structure of the AMR sensor M1. Reference symbols R1 through R4 denote magneto-resistance elements. Reference symbols H1 and H2 denote Hall elements. FIG. 7 is a plan view schematically showing the structure of the AMR sensor M2. Reference symbols R5 through R8 denote magneto-resistance elements. Reference symbols H1 and H2 denote Hall elements. FIG. 8 shows an equivalent circuit for the AMR sensor M1. FIG. 9 shows an equivalent circuit for the AMR sensor M2. FIGS. 10D through 10G are explanatory diagrams showing output signals from the AMR sensors M1 and M2 and the Hall elements H1 and H2. In FIG. 8, R1 and R2 output (R0−ΔR cos 2θ). R3 and R4 output (R0+ΔR cos 2θ). In FIG. 9, R5 and R6 output (R0+ΔR sin 2θ). R7 and R8 output (R0−ΔR sin 2θ). The magneto-resistance elements R1 through R8 are formed by bending a strip-shaped region more than once so as to meander. The magneto-resistance elements R1 through R8 each output a signal having the level corresponding to a resistance value that mainly varies with the intensity and the direction of a magnetic field parallel to the surface of the silicon substrate 10. The magneto-resistance elements R1 through R8 generate the anisotropic magneto-resistance effect.

According to the embodiment, the magneto-resistance elements R1 through R8 are made of a ferromagnetic metal thin film. Available ferromagnetic materials include NiFe (permalloy) and NiCo. A sputtering technique and a deposition technique can be used to form the ferromagnetic metal thin film.

As shown in FIG. 6, the AMR sensor M1 includes four magneto-resistance elements R1 through R4. The magneto-resistance elements R1 through R4 are positioned so as to form a 90° angle between extended lines from the adjacent strip-shaped magneto-resistance elements. In other words, the magneto-resistance elements R1 through R4 are positioned so as to form a 90° angle between current directions (easy axes of magnetization) of the adjacent magneto-resistance elements. A set of magneto-resistance elements R1 and R4 and a set of magneto-resistance elements R2 and R3 are positioned so as to cause a phase difference of 90° between signals output from the sets.

As shown in FIG. 8, the magneto-resistance elements R1 and R4 are electrically series-connected to configure a half-bridge circuit. An output terminal 31 is electrically connected to a midpoint of the half-bridge circuit in order to pick up a midpoint output Vout1. The magneto-resistance elements R2 and R3 are also electrically series-connected to configure a half-bridge circuit. An output terminal 32 is electrically connected to a midpoint of the half-bridge circuit in order to pick up a midpoint output Vout2.

Both half-bridge circuits are parallel connected to configure a full-bridge circuit that outputs a cos 2θsignal. The full-bridge circuit electrically connects with a power supply terminal 30 for supplying power Vcc and a terminal 33 for electrically connecting with ground G1. In the full-bridge circuit, the opposing magneto-resistance elements R1 and R2 output an (R0−ΔR cos 2ΔR cos 2θ) signal. The magneto-resistance elements R3 and R4 output an (R0+ΔR cos 2ΔR cos 2θ) signal. In these signals, R0 denotes a resistance value for the magneto-resistance element in no magnetic field and ΔR denotes a resistance variation.

The midpoint outputs Vout1 and Vout2 each oscillate around Vcc/2 and are capable of suppressing an output waveform offset due to a change in the environmental temperature.

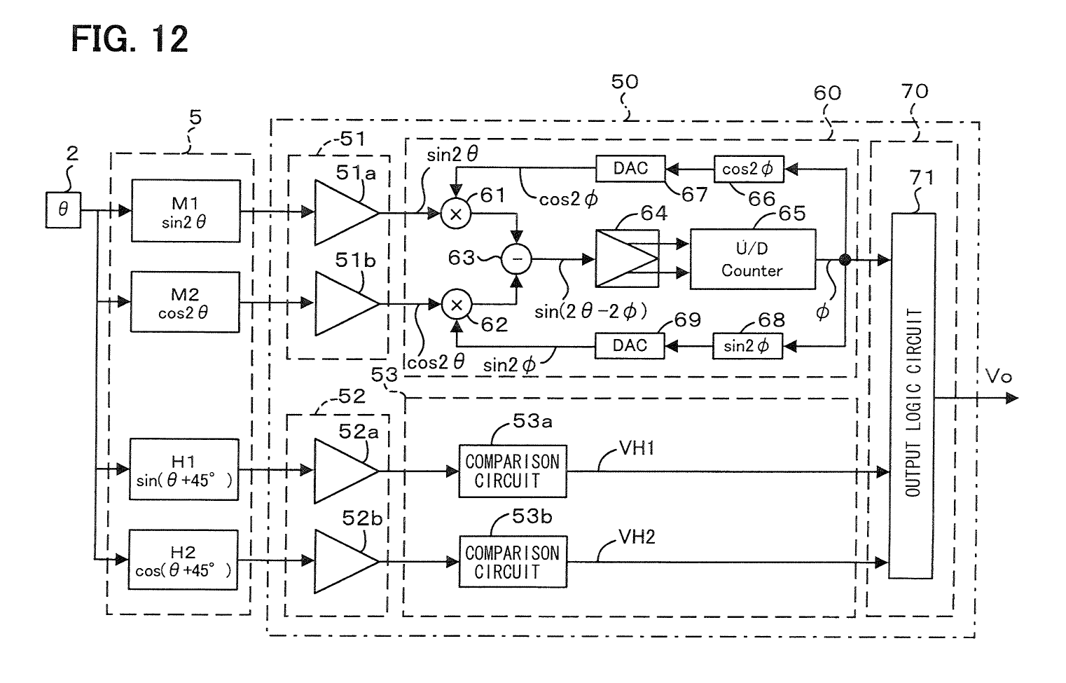

The output terminals 31 and 32 are connected to a differential amplifier circuit (reference numeral 51a in FIG. 12) to differentially amplify the midpoint outputs Vout1 and Vout2. The AMR sensor M1 according to the embodiment can provide twice as large output amplitude as that of the AMR sensor M1 that uses a single half-bridge circuit. The magnetism detection sensitivity can be improved.

As shown in FIG. 7, the AMR sensor M2 includes four magneto-resistance elements R5 through R8. The magneto-resistance elements R5 through R8 are positioned so as to form a 90° angle between extended lines from the adjacent strip-shaped magneto-resistance elements. In other words, the magneto-resistance elements R5 through R8 are positioned so as to form a 90° angle between current directions (easy axes of magnetization) of the adjacent magneto-resistance elements. A set of magneto-resistance elements R5 and R7 and a set of magneto-resistance elements R8 and R6 are positioned so as to cause a phase difference of 90° between signals output from the sets.

As shown in FIG. 9, the magneto-resistance elements R5 and R7 are electrically series-connected to configure a half-bridge circuit. An output terminal 37 is electrically connected to a midpoint of the half-bridge circuit in order to pick up a midpoint output Vout3. The magneto-resistance elements R8 and R6 are also electrically series-connected to configure a half-bridge circuit. An output terminal 38 is electrically connected to a midpoint of the half-bridge circuit in order to pick up a midpoint output Vout4.

Both half-bridge circuits are parallel connected to configure a full-bridge circuit that outputs a sin 2θ signal. The full-bridge circuit electrically connects with a power supply terminal 36 for supplying power Vcc and a terminal 39 for electrically connecting with ground G2. In the full-bridge circuit, the opposing magneto-resistance elements R5 and R6 output an (R0+ΔR sin 2θ) signal. The magneto-resistance elements R7 and R8 output an (R0−ΔR sin 2θ) signal.

The midpoint outputs Vout3 and Vout4 each oscillate around Vcc/2 and are capable of suppressing an output waveform offset due to a change in the environmental temperature.

The output terminals 37 and 38 are connected to a differential amplifier circuit (reference numeral 51b in FIG. 12) to differentially amplify the midpoint outputs Vout3 and Vout4. The AMR sensor M2 according to the embodiment can provide twice as large output amplitude as that of the AMR sensor M2 that uses a single half-bridge circuit. The magnetism detection sensitivity can be improved.

As shown in FIG. 4A, the magneto-resistance elements of the AMR sensors M1 and M2 are positioned concentrically and alternately. Each of the magneto-resistance elements R1 through R4 of the AMR sensor M1 adjoins each of the magneto-resistance elements R5 through R8 of the AMR sensor M2 so as to form a 45° angle between current directions (easy axes of magnetization). A variation ΔR in the electric resistance of the anisotropic magneto-resistance element is maximized when the angle of 90° or 270° is formed between the direction (easy axis of magnetization) of a current flowing through the magnetic thin film and the direction of the magnetic field. The variation ΔR is minimized when the angle of 0° or 180° is formed between the directions.

As shown in FIGS. 10A through 10G, the AMR sensor M1 outputs a cos signal that oscillates at electric angle 180° per wavelength. The AMR sensor M2 outputs a sin signal that oscillates at electric angle 180° per wavelength and causes a phase difference of 45° from the AMR sensor M1.

As shown in FIG. 4B, the magneto-resistance elements R1 to R8 configuring the AMR sensors M1 and M2 are placed on the surface of the silicon substrate 10 through the insulating film 90. The AMR sensors M1 and M2 mainly detect a change in the magnetic flux density of the magnetic field B1 parallel to the magneto-resistance element region E1 or the silicon substrate 10. The Hall elements H1 and H2 are embedded in the silicon substrate 10 and are positioned below the magneto-resistance elements R1 to R8 through the insulating film 90. The embodiment uses the vertical Hall elements H1 and H2 based on the CMOS (Complementary Metal Oxide Semiconductor) structure. The insulating film 90 is equivalent to a silicon dioxide film.

The Hall elements H1 an H2 are positioned so as to cause a phase difference of 90° between output signals. When the permanent magnet 2 rotates 360° as shown in FIGS. 10F and 10G, the Hall element H1 outputs a sin signal oscillating at electric angle 360° per wavelength. The Hall element H2 outputs a cos signal oscillating at electric angle 360° per wavelength.

(Hall Element Structure)

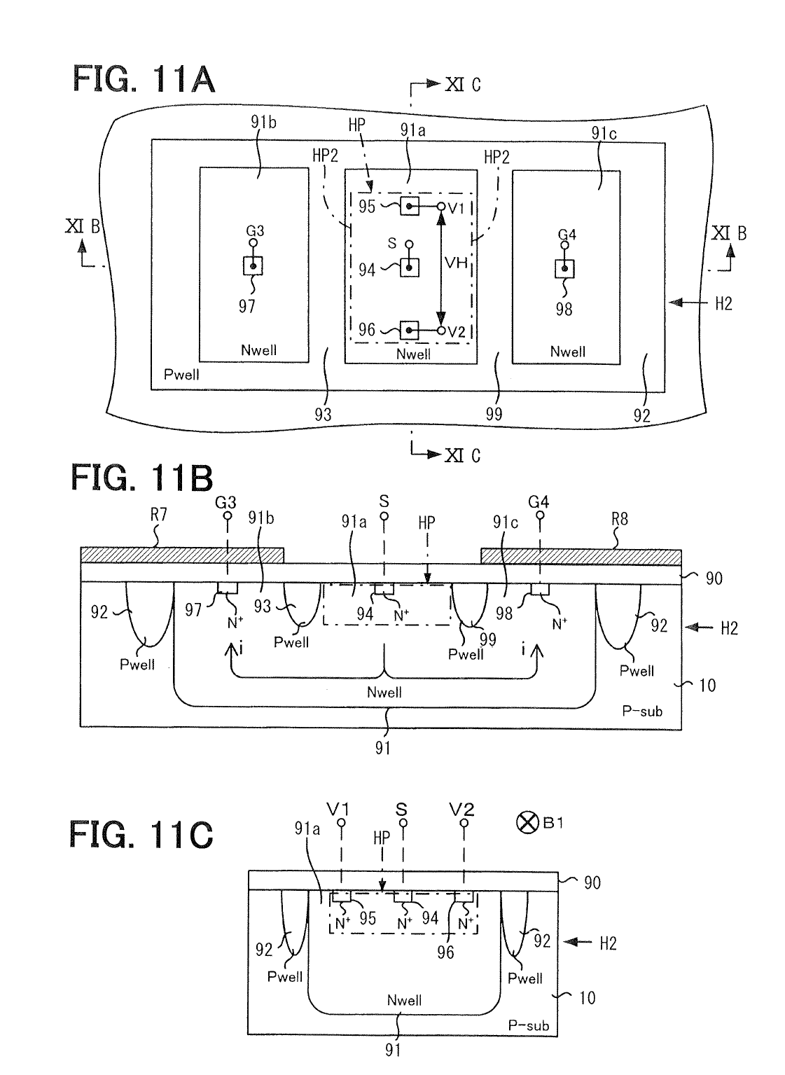

The structure of the Hall elements H1 and H2 will be described. The Hall elements H1 and H2 have the same structure. The Hall element H2 will be described as an example. FIG. 11A is a plan view showing the Hall element H2 and its partial vicinity. FIG. 11B is a cross sectional view taken along the line XIB-XIB of FIG. 11A. FIG. 11C is a cross sectional view taken along the line XIC-XIC of FIG. 11A.

The Hall element H2 is structured as a high-voltage CMOS (HVCMOS) transistor. The Hall element H2 includes a P-type (first conductive type) silicon substrate (P-sub) 10, an N-type (second conductive type) semiconductor region (Nwell) 91, a P-type (first conductive type) diffusion layer (Pwell) 92, P-type (first conductive type) diffusion layers (Pwell) 93 and 99, and contact regions (N+ diffusion layers or impurity diffusion layers) 94 through 98. The semiconductor region 91 is formed from the surface of the silicon substrate 10 in the depth direction. The diffusion layer 92 encloses the entire periphery of the semiconductor region 91. The diffusion layers 93 and 99 are formed from the surface of the silicon substrate 10 in the depth direction and divide the semiconductor region 91 into three semiconductor regions 91a, 91b, and 91c from the surface to a specified depth. The contact regions 94 through 98 are formed on the surface of the semiconductor regions 91a, 91b, and 91c.

The contact regions 94 through 98 are electrically wired to terminals S, V1, V2, G3, and G4. The terminals S, G3, and G4 supply drive currents. The terminals V1 and V2 pick up Hall voltage signals. The pair of contact regions 97 and 98 supply currents. The pair of contact regions 95 and 96 output voltages. The Hall elements H1 and H2 shown in FIG. 4A are positioned so as to be perpendicular to a line connecting the current supply pair. The Hall elements H1 and H2 are positioned so as to be perpendicular to a line connecting the voltage output pair.

As shown in FIG. 11C, a region sandwiched between the contact regions 95 and 96 is provided as a magnetism detection section (Hall plate) HP. The magnetism detection section HP includes magnetism detection planes HP2 that correspond to both planes parallel to the line connecting the contact regions 95 and 96. The Hall element H2 outputs Hall voltage signals from the terminals V1 and V2. The Hall voltage signal corresponds to a magnetic field applied to the magnetism detection section HP from the magnetism detection plane HP2.

FIG. 11B shows that a specified drive current i is supplied from the terminal S to the terminals G3 and G4. The drive current i passes through the contact region 94, the magnetism detection section HP, and the semiconductor region 91 below the diffusion layers 93 and 99, and then reaches the contact regions 97 and 98.

The magnetism detection section HP is supplied with the drive current containing a component perpendicular to the substrate surface (sensor chip surface). Let us suppose that the drive current is applied and the magnetism detection section HP is supplied with a magnetic field (as indicated by a symbol B1 in FIG. 11C, for example) containing a component parallel to the substrate surface (sensor chip surface). In this case, the Hall effect generates a Hall voltage VH corresponding to the magnetic field between the terminals V1 and V2. The Hall voltage VH varies with an angle between directions of the magnetism detection plane HP2 and the magnetic field, i.e., an incidence angle of the magnetic field against the magnetism detection plane HP2.

As shown in FIGS. 2A and 3, the Hall elements H1 and H2 are positioned so that the magnetism detection planes HP1 and HP2 are perpendicular to the surface of the silicon substrate 10. The permanent magnet 2 generates the magnetic field B1 parallel to the surface of the silicon substrate 10. The magnetic field B1 vertically penetrates the magnetism detection planes HP1 and HP2. According to the drawing, the magnetic field B1 vertically penetrates the magnetism detection plane HP2 of the Hall element H2. When the permanent magnet 2 rotates 90° from the illustrated position, the magnetic field B1 vertically penetrates the magnetism detection plane HP1 of the Hall element H1. Namely, the Hall elements H1 and H2 mainly detect a variation in the magnetic flux density of the magnetic field B1 parallel to the surface of the silicon substrate 10.

The N-type semiconductor region 91 is formed deeper than an N-type semiconductor region for the low-voltage CMOS transistor structure. The P-type diffusion layers 92, 93, and 98 are also formed deeper than a P-type diffusion layer for the low-voltage CMOS transistor structure. According to the embodiment, the P-type diffusion layers 92, 93, and 98 are formed approximately half as deep as the N-type semiconductor region 91.

The carrier mobility is improved because the N-type semiconductor region 91 is formed deep in the Hall element H1. Consequently, the Hall effect can be enhanced. The Hall voltage VH can be increased. The magnetic field detection sensitivity can be improved.

The Hall element H1 is manufactured based on the CMOS process and is more cost-effective than vertical Hall elements that are manufactured based on the bipolar process.

(Electric Configuration)

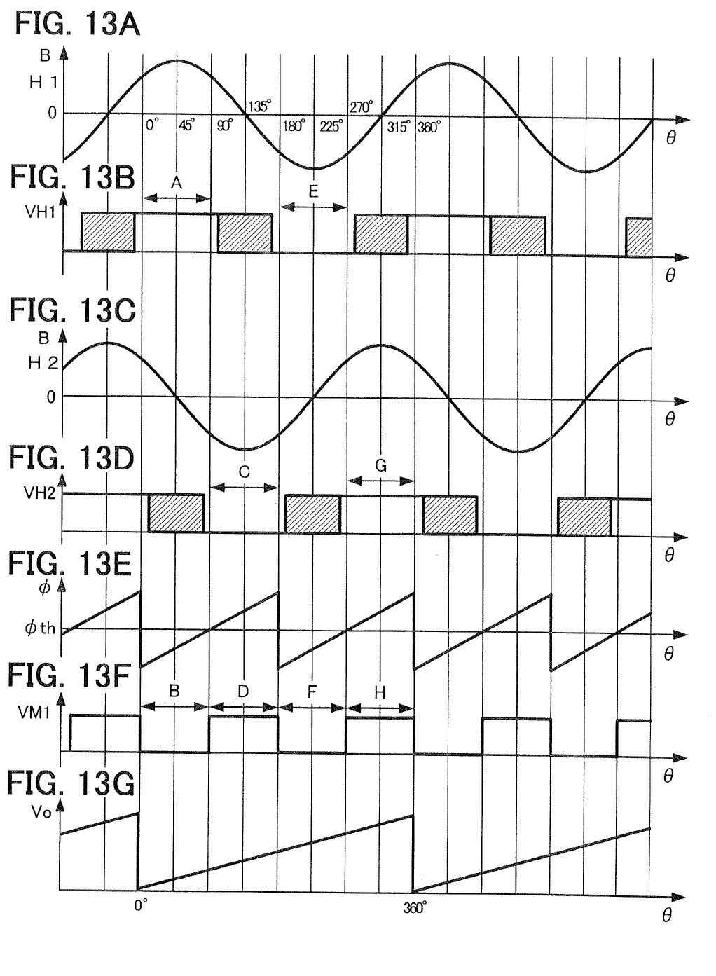

The major electric configuration of the rotation sensor 1 will be described. FIG. 12 is a block diagram showing major electric configuration of the rotation sensor 1 and corresponds to FIG. 1. FIG. 13A shows an output waveform from the Hall element H1. FIG. 13B shows an output waveform from a comparison circuit 53a. FIG. 13C shows an output waveform from the Hall element H2. FIG. 13D shows an output waveform from a comparison circuit 53b. FIG. 13E shows an output waveform from the angle computing section 60 to represent a computed angle. FIG. 13F is a waveform diagram showing a result of comparison between a computed angle φ and a threshold angle nth shown in FIG. 13E. FIG. 13G shows an output waveform from an output logic circuit 71.

(Amplification Section 51 and Angle Computing Section 60)

The amplification section 51 includes differential amplifier circuits 51a and 51b. The differential amplifier circuit 51a differentially amplifies an output signal sin 2θ from the AMR sensor M1. The differential amplifier circuit 51b differentially amplifies an output signal cos 2θ from the AMR sensor M2. The angle computing section 60 represents a tracking loop type digital angle converter. The angle computing section 60 includes multiplication circuits 61 and 62, a subtraction circuit 63, a window comparator 64, an up-down counter 65, a cos 2φ output circuit 66, a D/A converter (DAC) 67, a sin 2φ output circuit 68, and a D/A converter (DAC) 69.

The cos 2φ output circuit 66 outputs data cos 2φ corresponding to a digital computed angle φ output from the up-down counter 65. For example, the cos 2φ output circuit 66 includes ROM that stores a table of correspondence between the computed angle φ and the data cos 2φ. The cos 2φ output circuit 66 reads the data cos 2φ corresponding to the computed angle φ from the ROM and outputs the data cos 2φ. The D/A converter 67 converts the data cos 2φ output from the cos 2φ output circuit 66 into an analog signal cos 2φ.

The sin 2φ output circuit 68 outputs data sin 2φ corresponding to the digital computed angle φ output from the up-down counter 65. For example, the sin 2φ output circuit 68 includes ROM that stores a table of correspondence between the computed angle φ and the data sin 2φ. The sin 2φ output circuit 68 reads the data sin 2φ corresponding to the computed angle φ from the ROM and outputs the data sin 2φ. The D/A converter 69 converts the data sin 2φ output from the sin 2φ output circuit 68 into an analog signal sin 2φ.

The multiplication circuit 61 multiplies a signal sin 2θ output from the differential amplifier circuit 51a by a signal cos 2φ output from the cos 2φ output circuit 66 and outputs a signal sin 2θ cos 2φ. The multiplication circuit 62 multiplies a signal cos 2θ output from the differential amplifier circuit 51b by a signal sin 2φ output from the sin 2φ output circuit 68 and outputs a signal cos 2θ sin 2φ.

The subtraction circuit 63 subtracts the signal cos 2θ sin 2φ output from the multiplication circuit 62 from the signal sin 2θ cos 2φ output from the multiplication circuit 61 and computes sin(2θ−2φ). That is, the cos 2φ output circuit 66, the D/A converter 67, the sin 2φ output circuit 68, the D/A converter 69, the multiplication circuits 61 and 62, and the subtraction circuit 63 compute sin 2θ cos 2φ−cos 2θ sin 2φ=sin(2θ−2φ) to find control deviation ε=sin(2θ−2φ).

The window comparator 64 compares sin(2θ−2φ) output from the subtraction circuit 63 with two differently sized threshold values. When sin(2θ−2φ) is larger than a larger threshold value, the window comparator 64 outputs an up-signal (e.g., a positive pulse signal) that increments the subsequent up-down counter 65. When sin(2θ−2φ) is smaller than a smaller threshold value, the window comparator 64 outputs a down-signal (e.g., a negative pulse signal) that decrements the up-down counter 65.

The up-down counter 65 increments the count value by one each time an up-signal is input from the window comparator 64 or the number of positive pulses is counted. The up-down counter 65 decrements the count value by one each time a down-signal is input from the window comparator 64 or the number of negative pulses is counted. The up-down counter 65 outputs the count value as the computed angle φ to the cos 2φ output circuit 66 and the sin 2φ output circuit 68.

The output logic circuit 71 latches the count value output from the up-down counter 65. The angle computing section 60 repeatedly computes the control deviation ε by feeding back the computed angle φ until an absolute value of control deviation ε=sin(2θ−2φ) becomes smaller than or equal to the threshold value or is set to ε=0, for example.

(Amplification Section 52 and Comparison Section 53)

The amplification section 52 includes amplifier circuits 52a and 52b. The amplifier circuit 52a amplifies a signal sin(θ+45°) output from the Hall element H1. The amplifier circuit 52b amplifies a signal cos(θ+45°) output from the Hall element H2. The comparison section 53 includes comparison circuits 53a and 53b. The comparison circuit 53a compares a signal level output from the amplifier circuit 52a with a threshold value and outputs a first pulse signal corresponding to the comparison result. The comparison circuit 53b compares a signal level output from the amplifier circuit 52b with a threshold value and outputs a second pulse signal corresponding to the comparison result. The comparison circuits 53a and 53b can be defined as pulse generation circuits.

The embodiment defines 0 V as a threshold level. The comparison circuits each output a high-level (H) signal corresponding to a positive input signal and output a low-level (L) signal corresponding to a negative input signal. As shown in FIG. 13B, the comparison circuit 53a outputs a first pulse signal VH1 that maintains the high level at the relative rotation angle θ between 0° and 180° and maintains the low level at the relative rotation angle θ between 180° and 360°. As shown in FIG. 13D, the comparison circuit 53b outputs a second pulse signal VH2 that maintains the high level at the relative rotation angle θ between 90° and 270° and maintains the low level at the relative rotation angle θ between 270° and 90°. The first and second pulse signals VH1 and VH2 output from the comparison circuits 53a and 53b are output to an output logic circuit 71.

(Output Section)

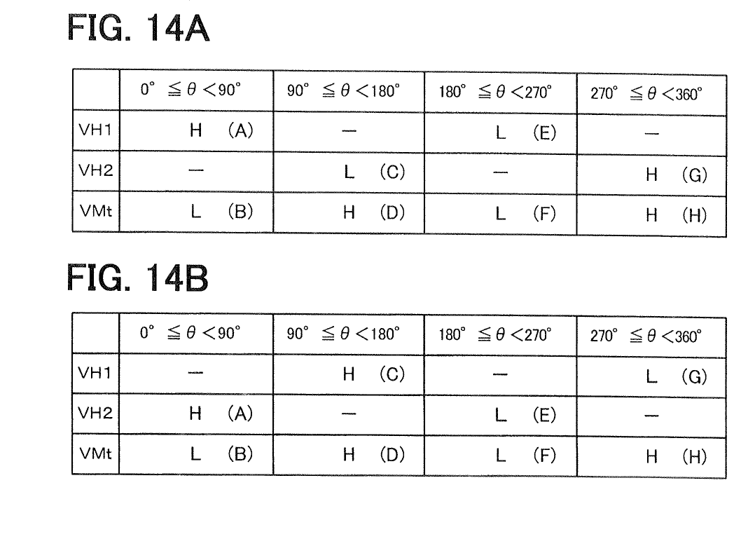

The output section 70 includes the output logic circuit 71. FIG. 14A is an explanatory diagram showing relation among signal levels (high level (H) and low level (L)) for the first and second pulse signals VH1 and VH2 output from the comparison circuits 53a and 53b, results of comparison (high level (H) and low level (L)) between the computed angle φ and the threshold angle φth, and angular ranges for a relative rotation angle θ. Reference symbols (A) through (H) in FIG. 14A correspond to the reference symbols A through H in FIG. 13. In FIG. 14A, the Hall elements H1 and H2 are shifted +45°.

The output logic circuit 71 outputs the computed angle φ equivalent to a count value latched when the control deviation ε becomes smaller than or equal to the threshold value. The computed angle φ is represented as a sawtooth signal in FIG. 13E. The signal oscillates at an electric angle of 180° per wavelength and maximizes the level at the relative rotation angles θ of 0° and 180°.

The output logic circuit 71 digitally compares the computed angle as a digital value with the threshold angle φth as a digital value and outputs a comparison result. According to the embodiment, the threshold angle nth is set to half the maximum value for the computed angle φ. The output logic circuit 71 generates a pulse signal VM1 as a comparison result. As shown in FIG. 13F, the pulse signal VM1 goes to the high level (H) when the computed angle φ is larger than or equal to the threshold angle φth. The pulse signal VM1 goes to the low level (L) when the computed angle φ is smaller than the threshold angle nth.

The output logic circuit 71 determines signal levels for the first and second pulse signals VH1 and VH2 and the pulse signal VM1. The output logic circuit 71 uses signal level determination results about the first and second pulse signals VH1 and VH2 and a signal level determination result VMt about the pulse signal VM1 to determine to which of four quadrants (angular ranges) the relative rotation angle θ belongs. The four quadrants result from dividing the relative rotation angle θ ranging from 0° to 360° by 90°.

An output signal from the Hall element H1 or H2 may be affected by a voltage offset or a random noise and cause an unstable voltage near the point where the phase changes 180°. Unstable regions are shaded in FIG. 13. To improve the detection accuracy, the unstable regions are preferably excluded from the determination to which of the angular ranges the relative rotation angle belongs when the angular ranges result from dividing the relative rotation angle ranging from 0° to 360° by 90°. The embodiment assumes the unstable regions equivalent to a 45° range at both points (a 90° range in total) where the phase of the first and second pulse signals changes 180°. By contrast, the pulse signal VM1 is generated based on the computed angle φ as a digital value. The pulse signal VM1 is therefore unaffected by a voltage offset or a random noise and is stable.

The embodiment is configured to provide a phase difference of 45° between the pulse signal VM1 and each of the first and second pulse signals VH1 and VH2. The pulse signal VM1 can compensate for the above-mentioned unstable regions. As shown in FIG. 13, a range of 45° for the unstable regions in the first and second pulse signals corresponds to the pulse width of the first and second pulse signals. The signal level for the pulse signal VM1 can be used for determination of the unstable regions.

As shown in FIGS. 14A and 14B, the output logic circuit 71 determines that the relative rotation angle θ belongs to the quadrant (angular range) of 0°≦θ≦90° when VH1 is set to the high level (H) and VMt is set to the low level (L). The output logic circuit 71 determines that the relative rotation angle θ belongs to the quadrant of 90°≦θ≦180° when VH2 is set to the low level (L) and VMt is set to the high level (H). The output logic circuit 71 determines that the relative rotation angle θ belongs to the quadrant of 180°≦θ≦270° when VH1 is set to the low level (L) and VMt is also set to the low level (L). The output logic circuit 71 determines that the relative rotation angle θ belongs to the quadrant of 270°≦θ≦360° when VH2 is set to the high level (H) and VMt is also set to the high level (H).

All the quadrants correspond to different combinations of VH1, VH2, and VMt as the determination results. Accordingly, it is possible to accurately determine the quadrant (angular range) containing the relative rotation angle θ. Especially, the MRE is highly sensitive and its output signal is used to generate the computed angle as a digital value. The quadrant can be highly accurately determined in the range of one LSB.

The signals VH1 and VH2 exclude a determination result that may become unstable. It is possible to more accurately determine the quadrant (angular range) containing the relative rotation angle θ even when a voltage offset or a random noise occurs.

As shown in FIG. 13E, the voltage VM becomes 0 V when the relative rotation angle θ is set to 0° and 180°. The relative rotation angle θ can be accurately determined to be 0° or 180° with reference to the above-mentioned combinations of determination results.

The relative rotation angle θ is determined to be 0° when VH1 is set to the high level (H) and VMt is set to the low level (L). The relative rotation angle θ is determined to be 180° when VH1 is set to the low level (L) and VMt is also set to the low level (L). Even when the permanent magnet 2 starts rotating from a position that causes the voltage VM to be 0 V, it is possible to determine the relative rotation angle θ to be 0° or 180° at which the rotation started.

The output logic circuit 71 can output an accurate computed angle φ corresponding to the relative rotation angle θ. The output logic circuit 71 converts the computed angle φ into an analog signal at a 360° cycle. As shown in FIG. 13G, the output logic circuit 71 can output an angular signal at the 360° cycle that linearly increases a voltage Vo in accordance with a change in the relative rotation angle θ from 0° to 360°.

The magneto-resistance element is larger than the Hall element in terms of the magnetic field sensitivity. The highly accurate rotation sensor can be configured by using a signal from the magneto-resistance element as a linear output signal. The permanent magnet intensity (magnetic field magnitude) can be small. This can reduce permanent magnet costs.

### Second Embodiment

The second embodiment of the invention will be described with reference to the accompanying drawings.

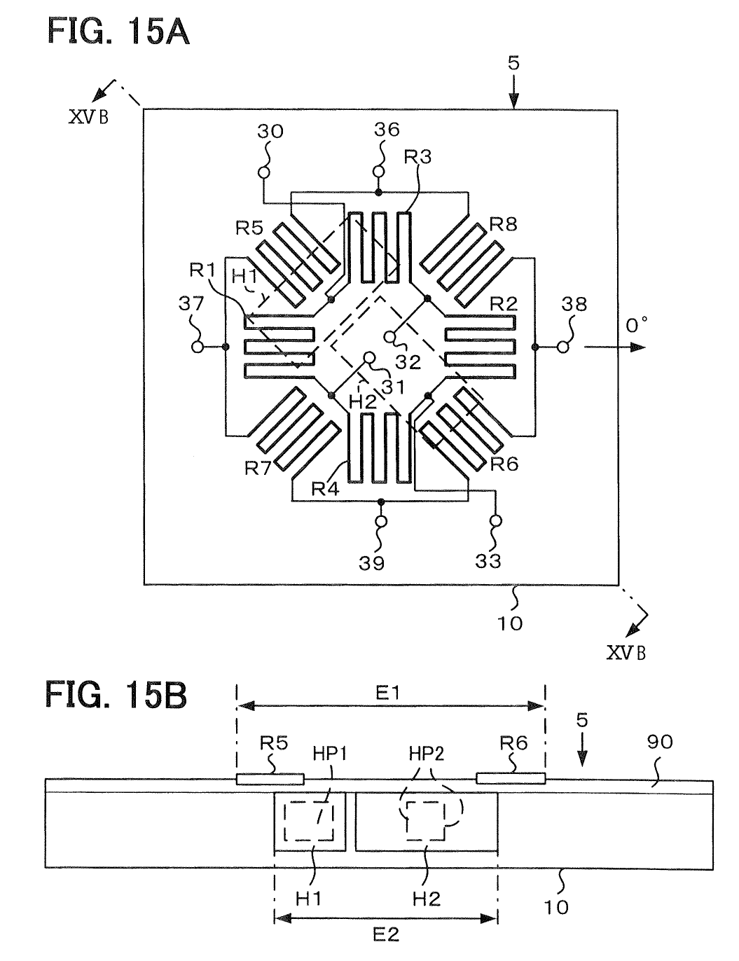

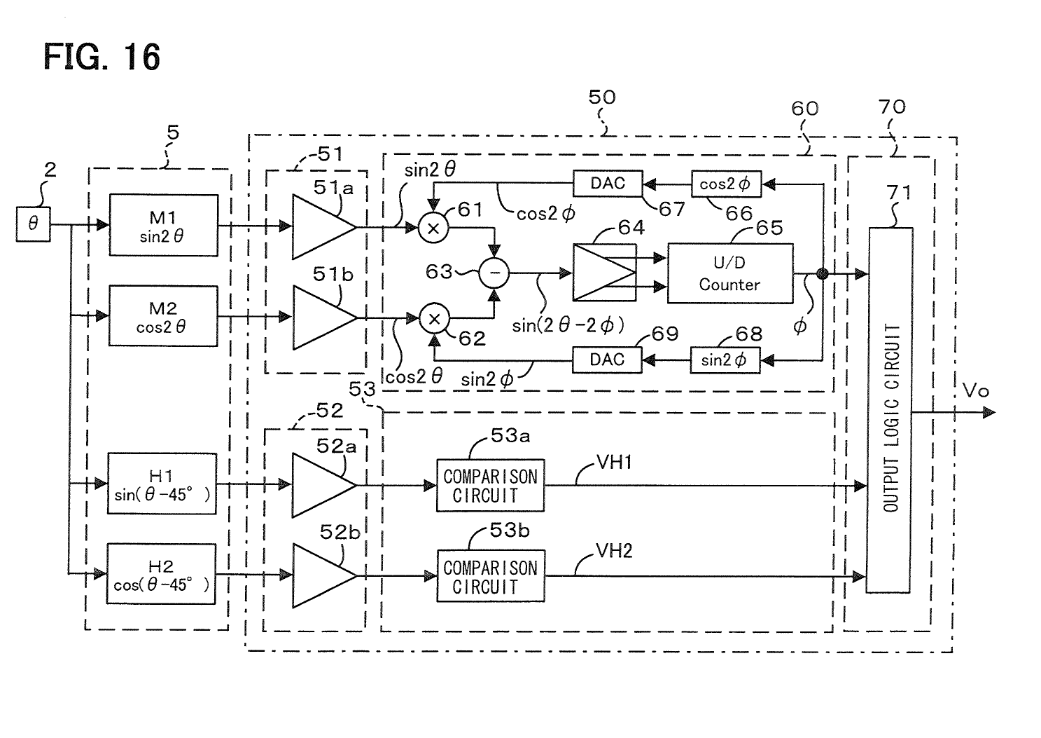

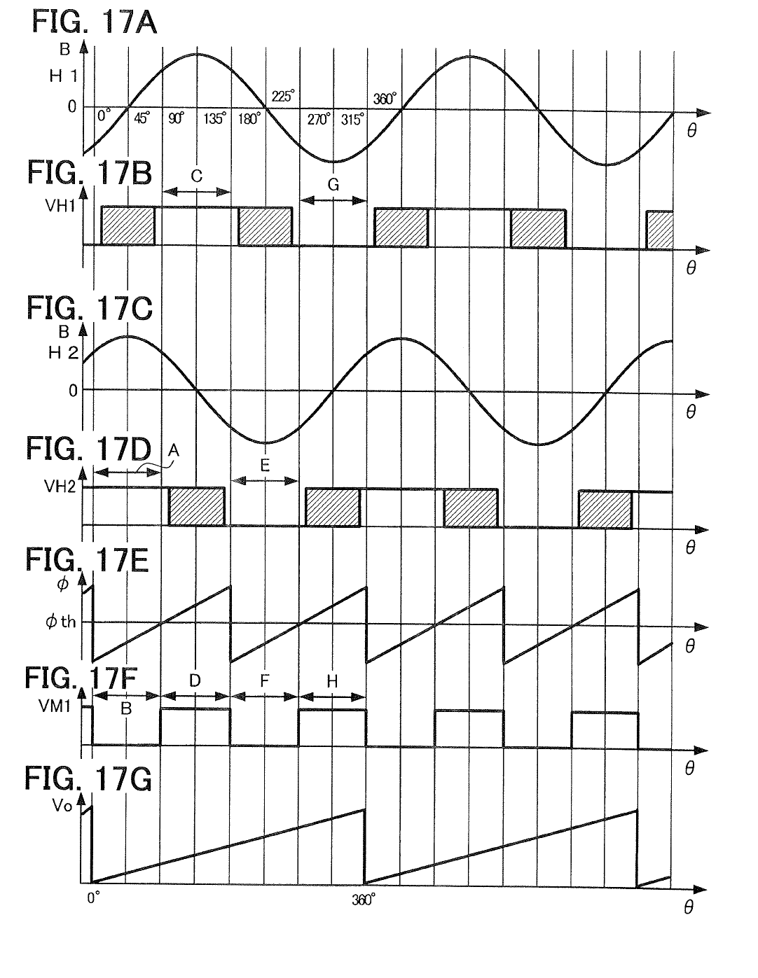

FIG. 15A is a plan view schematically showing a structure of a sensor chip provided for a rotation sensor according to the second embodiment. FIG. 15B is a cross sectional view taken along the line XVB-XVB of FIG. 15A. Reference symbols R1 through R4 denote the AMR sensor M1. Reference symbols R5 through R8 denote the AMR sensor M2. Reference symbols H1 and H2 denote Hall elements. FIG. 16 is a block diagram showing a major electric configuration of the rotation sensor 1 according to the second embodiment. FIGS. 17A through 17G are explanatory diagrams showing output waveforms from the Hall elements and the other components according to the embodiment and correspond to FIGS. 13A through 13G. The rotation sensor according to the second embodiment has the same configuration as the rotation sensor according to the first embodiment except positioning of the Hall elements H1 and H2. Therefore, the same parts or components are depicted by the same reference numerals and a detailed description is omitted for simplicity.

As shown in FIGS. 15A and 15B, the Hall elements H1 and H2 are positioned to be rotated 90° counterclockwise from the Hall elements provided for the rotation sensor 1 according to the first embodiment. The Hall elements H1 and H2 are positioned so as to cause a phase of 90° later than an output signal from the Hall elements according to the first embodiment.

As a result, the Hall element H1 outputs a sin(θ−45°) signal causing a phase delay of 45° with reference to the relative rotation angle θ. The Hall element H2 outputs a cos(θ−45°) signal causing a phase difference of 90° with reference to the Hall element H1.

As shown in FIG. 16, the rotation sensor has basically the same electric configuration as that of the first embodiment shown in FIG. 12 except output signals from the Hall elements H1 and H2.

FIG. 14B is equivalent to FIG. 14A according to the first embodiment. FIGS. 14A and 14B are equal to each other except the signal level combinations of the first and second pulse signals VH1 and VH2.

As mentioned above, the rotation sensor according to the second embodiment is configured equally to the rotation sensor 1 according to the first embodiment except that output signals from the Hall elements H1 and H2 cause a phase difference of 45° with reference to the relative rotation angle θ. The rotation sensor according to the second embodiment can provided the same effect as the first embodiment.

### Third Embodiment

The third embodiment of the invention will be described with reference to the accompanying drawings.

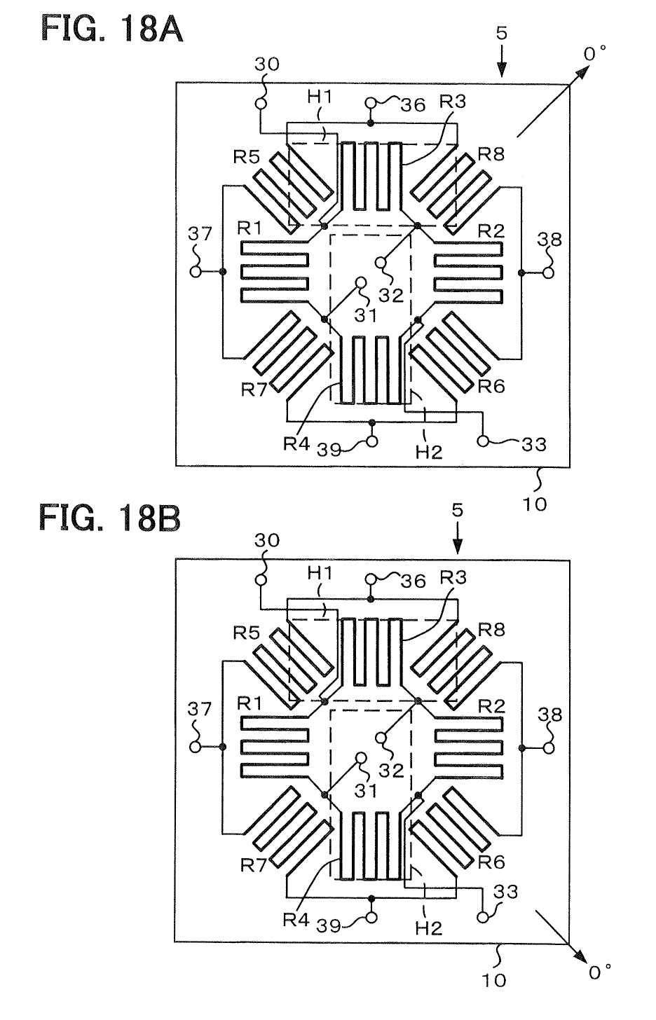

As shown in FIG. 18A, the Hall elements H1 and H2 are rotated 45° counterclockwise from the position of the first embodiment. The reference angle 0° can be rotated 45° counterclockwise from the position of the first embodiment. This configuration can provide the same effect as the first embodiment because the Hall elements H1 and H2 respectively output signals) sin(θ+45°) and cos(θ+45°) similarly to the first embodiment.

As shown in FIG. 18B, the Hall elements H1 and H2 are rotated 45° counterclockwise from the position of the first embodiment. The reference angle 0° can be rotated 45° clockwise from the position of the first embodiment. This configuration can provide the same effect as the second embodiment because the Hall elements H1 and H2 respectively output signals sin(θ−45°) and cos(θ−45°) similarly to the second embodiment.

Output signals from the Hall elements H1 and H2 just need to cause a phase difference of +45° with reference to the relative rotation angle θ. For this purpose, positions of the Hall elements H1 and H2 may be configured as described in the first and second embodiments. The position of the reference angle 0° may be electrically configured as described in the third embodiment.

### Fourth Embodiment

The fourth embodiment of the invention will be described with reference to the accompanying drawings.

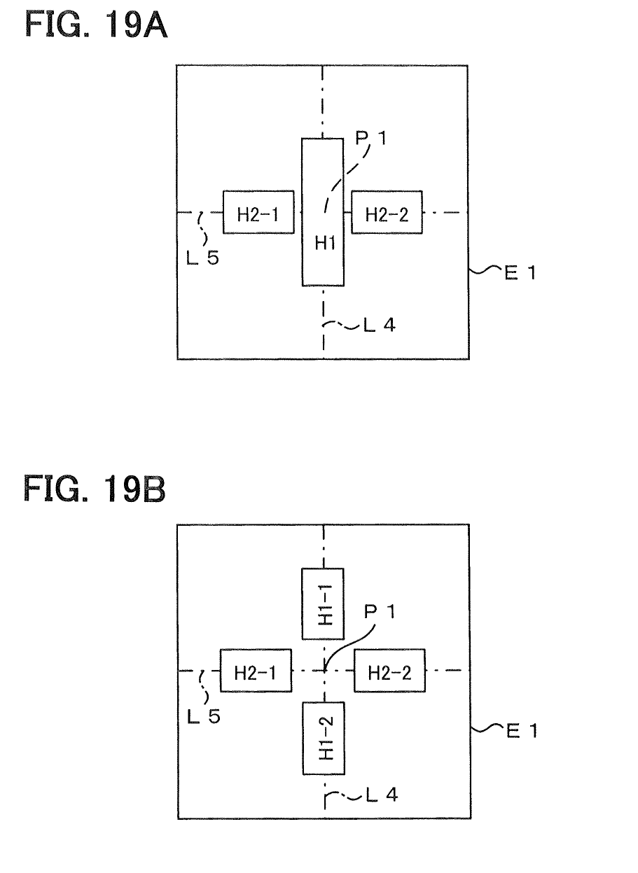

As shown in FIG. 19A, the center of the Hall element H1 corresponds to the relative rotation center P1 of the sensor chip 5. The other Hall elements include Hall elements H2-1 and H2-2 and are positioned at both sides of the Hall element H1. The Hall elements H2-1 and H2-2 are formed to ensure the same size and shape. The Hall elements H2-1 and H2-2 each generate the same Hall voltage when supplied with an equally intensified magnetic field at the same incidence angle. Reference symbol E1 denotes a magneto-resistance element region.

The Hall elements H2-1 and H2-2 are positioned so that a line L5 passes through the center of the Hall elements H2-1 and H2-2. The line L5 is perpendicular to a line L4 that passes through the relative rotation center. The Hall elements H2-1 and H2-2 are separated from the relative rotation center P1 with the same distance. An angle of 90° is formed between the magnetism detection plane for the Hall element H1 and each magnetism detection plane for the Hall elements H2-1 and H2-2.

Output signals from the Hall elements H2-1 and H2-2 are added to each other and are transformed into one output signal. This output signal is then input to the comparison circuit 53b (FIG. 12). Adding the output signals allows the center of the region formed by the Hall elements H2-1 and H2-2 to artificially coincide with the relative rotation center P1.

As mentioned above, the center of each Hall element can coincide with the relative rotation center P1. The magnetic field B1 is generated from the permanent magnet 2 without bias regardless of Hall element positions. Each Hall element can output an appropriately shaped signal in accordance with a variation of the relative rotation angle θ. It is possible to highly accurately determine the quadrant for the relative rotation angle θ.

As shown in FIG. 19B, the Hall elements H1-1 and H1-2 and the Hall elements H2-1 and H2-2 are formed to ensure the same size and shape, respectively. The Hall elements each generate the same Hall voltage when supplied with an equally intensified magnetic field at the same incidence angle. The Hall elements H1-1 and H1-2 are positioned on the line L4 that passes through the relative rotation center P1. The Hall elements H2-1 and H2-2 are positioned on the line L5 that passes through the relative rotation center P1 and is perpendicular to the line L4. The Hall elements H1-1 and H1-2 are positioned so that the line L4 centers on themselves. The Hall elements H2-1 and H2-2 are positioned so that the line L5 centers on themselves. Reference symbol E1 denotes a magneto-resistance element region.

The Hall elements H1-1 and H1-2 are separated from the relative rotation center P1 with the same distance. The Hall elements H2-1 and H2-2 are also separated from the relative rotation center P1 with the same distance. The same distance is maintained from the relative rotation center P1 to the four Hall elements. An angle of 90° is formed between each magnetism detection plane of the Hall elements H1-1 and H1-2 and each magnetism detection plane of the Hall elements H2-1 and H2-2.

Output signals from the Hall elements H1-1 and H1-2 are added to each other and are transformed into one output signal. This output signal is then input to the comparison circuit 53a (FIG. 12). Adding the output signals allows the center of the region formed by the Hall elements H1-1 and H1-2 to artificially coincide with the relative rotation center P1. Output signals from the Hall elements H2-1 and H2-2 are added to each other and are transformed into one output signal. This output signal is then input to the comparison circuit 53b (FIG. 12). Adding the output signals allows the center of the region formed by the Hall elements H2-1 and H2-2 to artificially coincide with the relative rotation center P1.

As mentioned above, the center of each Hall element can coincide with the relative rotation center P1. The magnetic field B1 is generated from the permanent magnet 2 without bias regardless of Hall element positions. Each Hall element can output an appropriately shaped signal in accordance with a variation of the relative rotation angle θ. It is possible to highly accurately determine the quadrant for the relative rotation angle θ.

### Fifth Embodiment

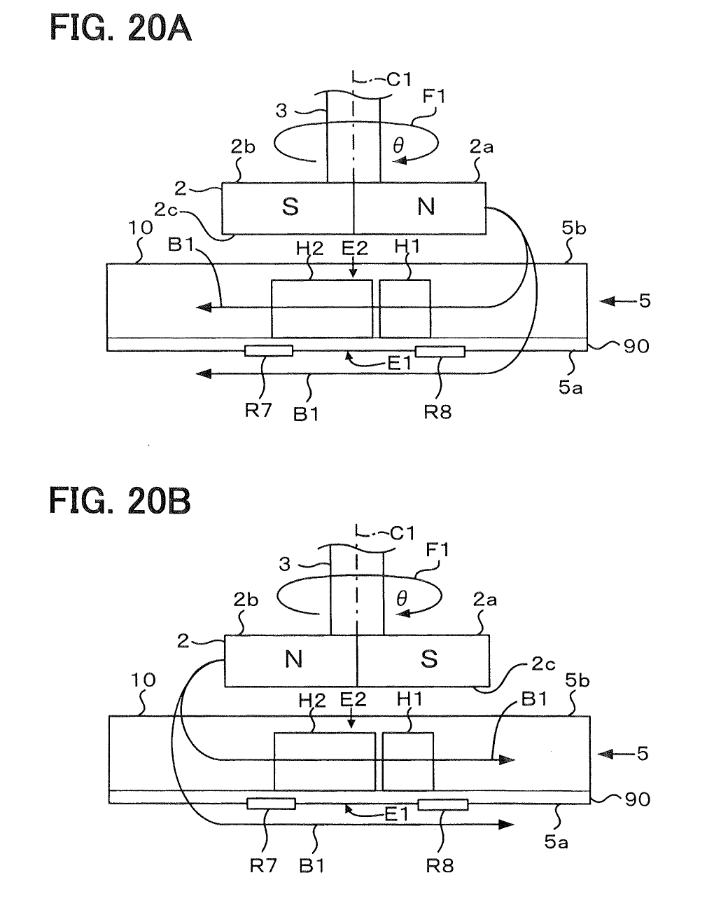

The fifth embodiment of the invention will be described. FIGS. 20A and 20B are vertical sectional views showing a sensor chip and a permanent magnet provided for a rotation sensor according to this embodiment.

The sensor chip 5 provided for the rotation sensor is equivalent to that of the first embodiment but the top and bottom sides are reversed. That is, the Hall element region E2 faces the relative rotational plane 2c of the permanent magnet 2. The magneto-resistance element region E1 is positioned below the Hall element region E2. As shown in FIGS. 20A and 20B, the permanent magnet 2 generates the magnetic field B1 parallel to the surface 5a of the sensor chip 5. The magnetic field B1 is applied to the Hall elements H1 and H2 and the AMR sensors M1 and M2. Therefore, the sensor chip 5 having this structure can also detect the relative rotation angle θ of the permanent magnet 2.

### Sixth Embodiment

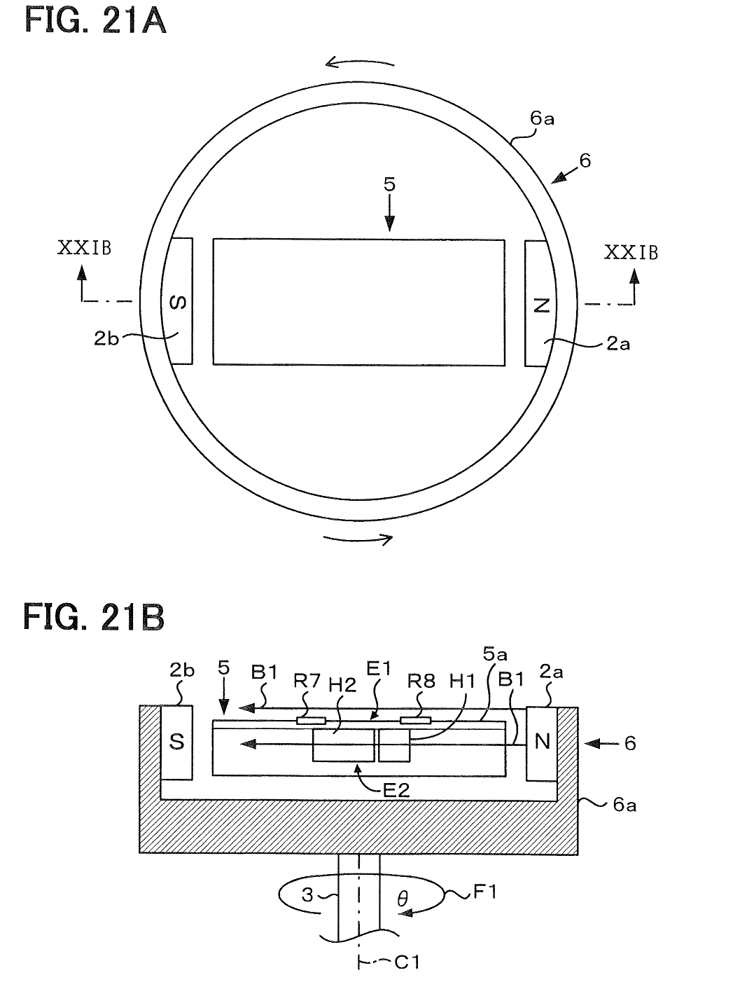

The sixth embodiment of the invention will be described. FIG. 21A is a plan view exemplifying the use of a sensor chip provided for a reception according to this embodiment. FIG. 21B is a cross sectional view taken along the line XXIB-XXIB of FIG. 21A.

A magnet rotor 6 has a rotor body 6a. According to the embodiment, the rotor body 6a is shaped into a cylinder having a base. An external wall is vertically provided in the circumferential direction of the rotor body 6a. An inner wall surface of the external wall is provided with an N-pole permanent magnet 2a and an S-pole permanent magnet 2b opposite to each other. The tip of the rotary shaft 3 is attached to the center of the bottom of the rotor body 6. When the rotary shaft 3 rotates around the relative rotation axis C1, the rotor body 6 also rotates around the relative rotation axis C1 in the same direction as the rotary shaft 3.

The sensor chip 5 is positioned at the relative rotation center of the rotor body 6a between the opposing permanent magnets 2a and 2b apart from them. The sensor chip 5 is positioned so that the magnetic field B1 is generated parallel to the surface 5a of the sensor chip 5 between the permanent magnets 2a and 2b. That is, the sensor chip 5 is positioned so that the direction of the magnetic field B1 is parallel to the AMR sensors M1 and M2 and is perpendicular to the magnetism detection planes HP1 and HP2 of the Hall elements H1 and H2. A supporting member (not shown) supports and fastens the sensor chip 5 in order to keep its position unchanged.

The sensor chip 5 positioned as mentioned above can detect a change in the magnetic flux density of the magnetic field B1 parallel to the surface of the sensor chip 5 and therefore can detect the relative rotation angle θ of the rotor body 6a. The sensor chip 5 is structured by overlapping the magneto-resistance element region E1 and the Hall element region E2 with each other and can be miniaturized in the planar direction. Accordingly, the diameter of the rotor body 6a can be reduced. As shown in FIGS. 20A and 20B, the sensor chip 5 can be positioned with its top and bottom reversed.

### Modification Example

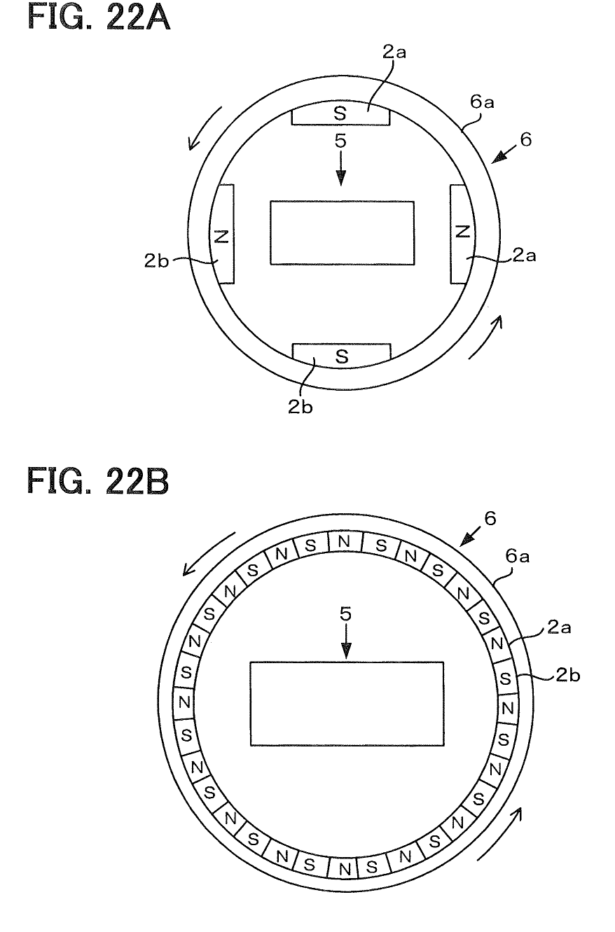

A modification example of the sixth embodiment will be described. FIGS. 22A and 22B are plan views showing a sensor chip and a rotating body provided for a rotation sensor according to the modification example of the sixth embodiment. In FIGS. 22A and 22B, a cross-section structure of the sensor chip 5 is the same as that shown in FIG. 2A. As shown in FIGS. 20A and 20B, the sensor chip 5 can be positioned with its top and bottom reversed.

As shown in FIG. 22A, the inner wall surface of the rotor body 6a is provided with two pairs of permanent magnets each including the N-pole permanent magnet 2a and the S-pole permanent magnet 2b. The sensor chip 5 is positioned at the relative rotation center of the rotor body 6a. In such cases as using two pairs of the N-pole and the S-pole, the sensor chip 5 can also detect the relative rotation angle θ of the rotor body 6a when the sensor chip 5 is positioned so that the magnetic field parallels the magneto-resistance element region E1.

As shown in FIG. 22B, the inner wall surface of the rotor body 6a is provided with three or more pairs of permanent magnets each including the N-pole permanent magnet 2a and the S-pole permanent magnet 2b. That is, a multipole permanent magnet is used. In such cases as using three or more pairs of the N-pole and the S-pole, the sensor chip 5 can also detect the relative rotation angle θ of the rotor body 6a when the sensor chip 5 is positioned so that the magnetic field parallels the magneto-resistance element region E1.

### Seventh Embodiment

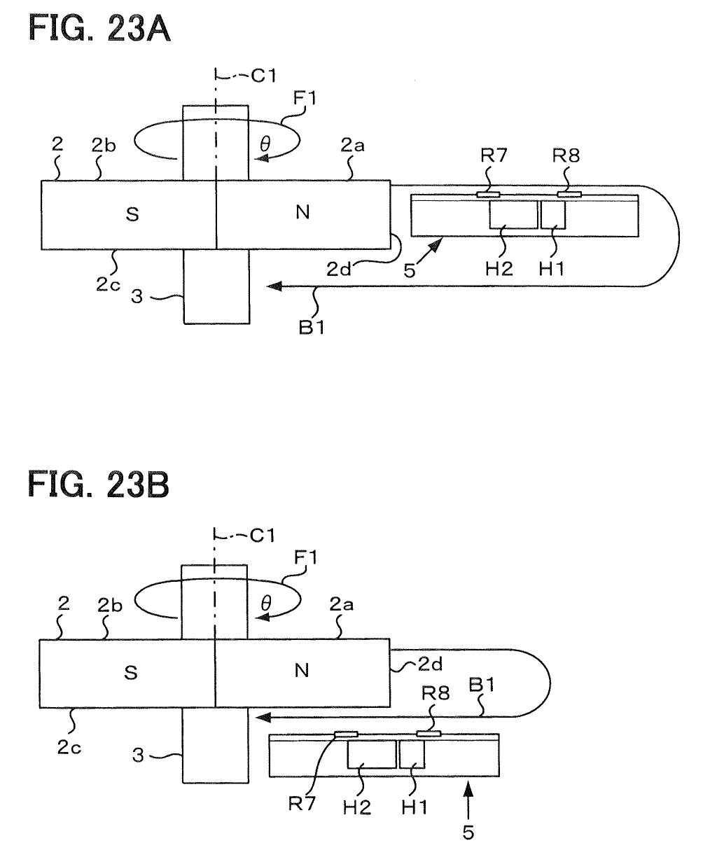

The seventh embodiment of the invention will be described. FIGS. 23A and 23B are cross sectional views exemplifying a sensor chip provided for a rotation sensor according to the seventh embodiment. In FIGS. 23A and 23B, a cross-section structure of the sensor chip 5 is the same as that shown in FIG. 2A. As shown in FIGS. 20A and 20B, the sensor chip 5 can be positioned with its top and bottom reversed. The permanent magnet 2 is structured and shaped equally to the permanent magnet shown in FIGS. 2A and 2B.

FIG. 23A shows that the sensor chip 5 is positioned beside a peripheral surface 2d of the permanent magnet 2. In this positioning, the sensor chip 5 can also detect the magnetic field B1 generated from the permanent magnet 2 parallel to the magneto-resistance element region E1 of the sensor chip 5. The sensor chip 5 can also detect the relative rotation angle θ of the permanent magnet 2. As shown in FIG. 23A, the sensor chip 5 can be positioned beside the peripheral surface 2d of the permanent magnet 2. Accordingly, the sensor chip 5 can detect the relative rotation angle θ of the permanent magnet 2 even when the sensor chip 5 cannot be positioned in the space facing the relative rotational plane 2c of the permanent magnet 2.

FIG. 23B shows that the sensor chip 5 is positioned beside the rotary shaft 3 so as to face the relative rotational plane 2c of the permanent magnet 2. In this positioning, the sensor chip 5 can also detect the magnetic field B1 generated from the permanent magnet 2 parallel to the magneto-resistance element region E1 of the sensor chip 5. The sensor chip 5 can also detect the relative rotation angle θ of the permanent magnet 2. As shown in FIG. 23B, the sensor chip 5 can be positioned beside the rotary shaft 3 so as to face the relative rotational plane 2c. Accordingly, the sensor chip 5 can detect the relative rotation angle θ of the permanent magnet 2 even when the sensor chip 5 cannot be positioned beside the peripheral surface 2d of the permanent magnet 2.

### Eighth Embodiment

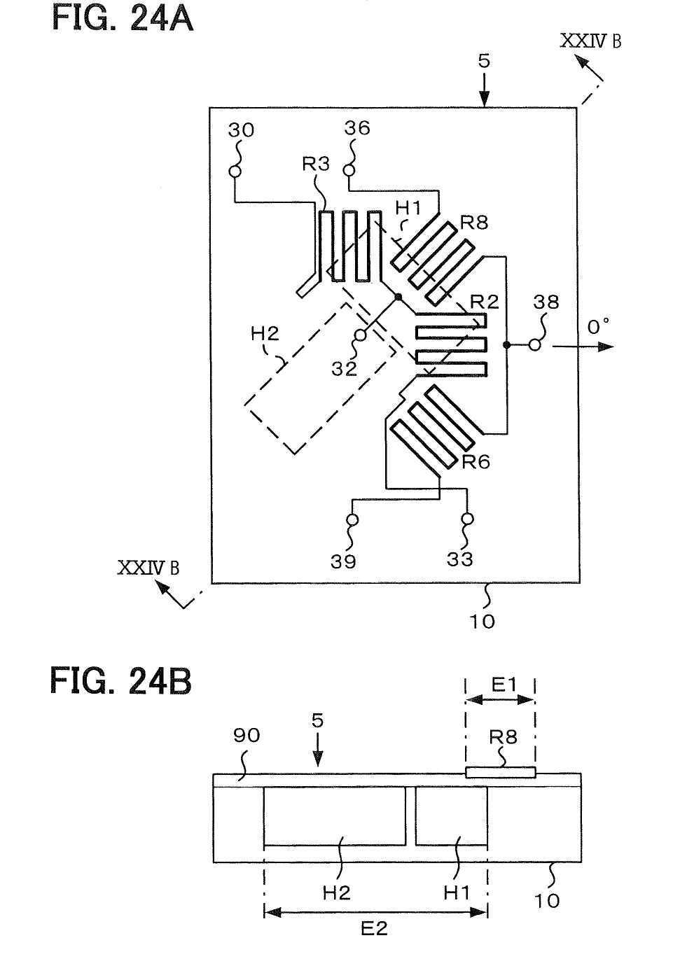

The eighth embodiment of the invention will be described. FIG. 24A is a plan view schematically showing a structure of a sensor chip provided for a rotation sensor according to this embodiment. FIG. 24B is a cross sectional view taken along the line XXIVB-XXIVB of FIG. 24A. Reference symbols R2 and R3 denote the AMR sensor M1. Reference symbols R6 and R8 denote the AMR sensor M2. Reference symbols H1 and H2 denote Hall elements.

The AMR sensor M1 includes a half-bridge circuit using the series-connected magneto-resistance elements R2 and R3. The AMR sensor M2 includes a half-bridge circuit using the series-connected magneto-resistance elements R6 and R8. The magneto-resistance elements R2 and R3 are positioned so that an output signal from the magneto-resistance element causes a phase difference of 90°. The magneto-resistance elements R6 and R8 are also positioned so that an output signal from the magneto-resistance element causes a phase difference of 90°. The magneto-resistance elements R2, R3, R6, and R8 are alternately positioned so as to cause a phase difference of 45° between an output signal from the output terminal 32 of the AMR sensor M1 and an output signal from the output terminal 38 of the AMR sensor M2.

The area of the magneto-resistance element region E1 can be reduced because the AMR sensors M1 and M2 are configured as half-bridge circuits. Consequently, the sensor chip 5 can be miniaturized.

### Ninth Embodiment

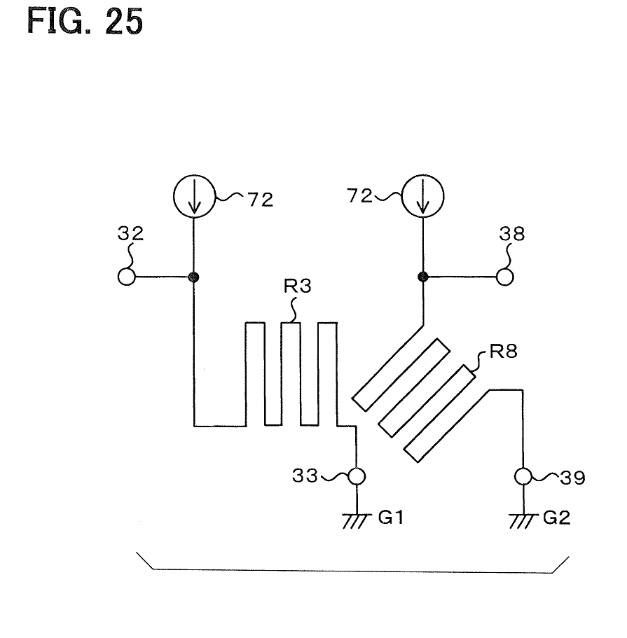

The ninth embodiment of the invention will be described. FIG. 25 shows an equivalent circuit for an AMR sensor provided for a rotation sensor according to this embodiment.

Only the magneto-resistance element R3 configures the AMR sensor M1. Only the magneto-resistance element R8 configures the AMR sensor M2. The magneto-resistance elements R3 and R8 are positioned so as to cause a phase difference of 45° between output signals from the magneto-resistance elements. A constant current source 72 is connected to the magneto-resistance elements R3 and R8.

The area of the magneto-resistance element region E1 can be reduced because only one magneto-resistance element configures the AMR sensors M1 and M2. Consequently, the sensor chip 5 can be miniaturized.

### Tenth Embodiment

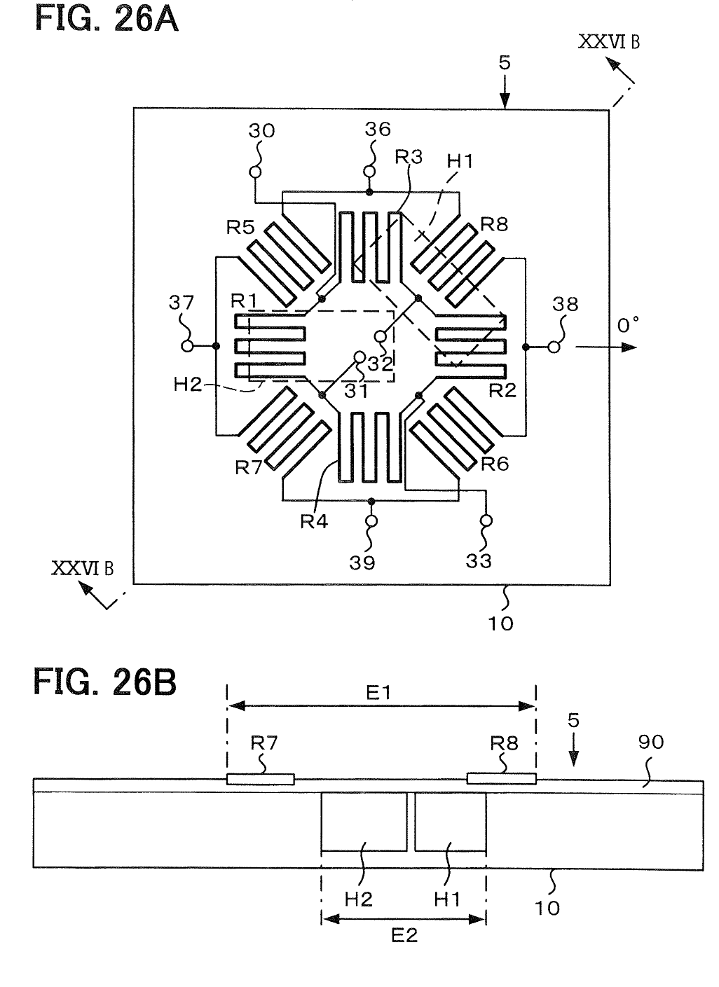

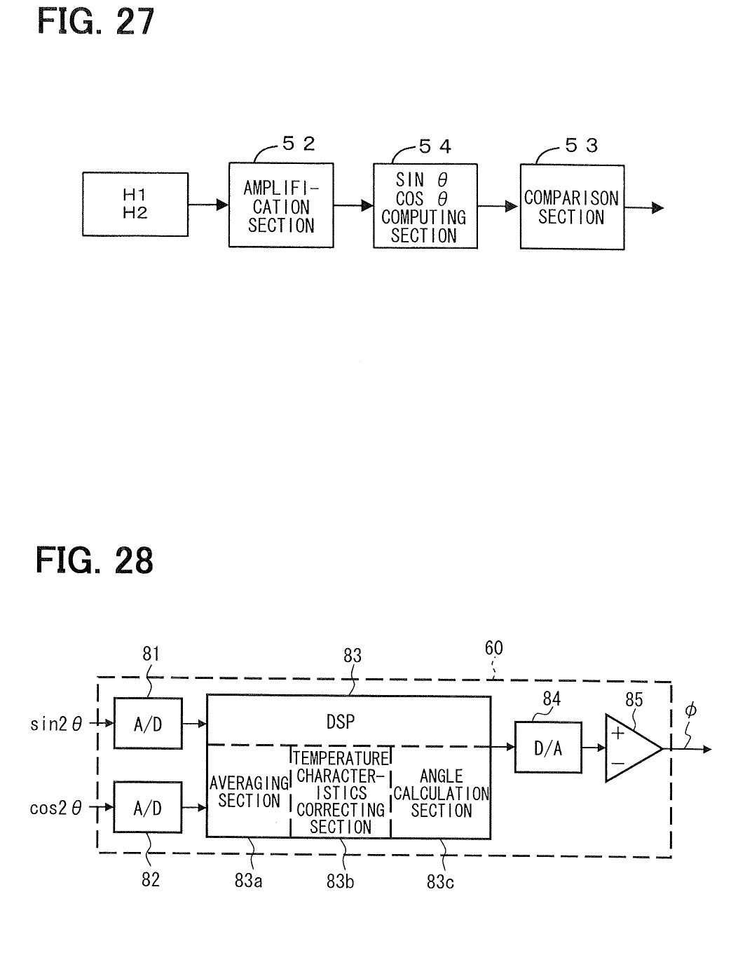

The tenth embodiment of the invention will be described. FIG. 26A is a plan view schematically showing a structure of a sensor chip provided for a rotation sensor according to this embodiment. FIG. 26B is a cross sectional view taken along the line XXVIB-XXvIB of FIG. 26A. Reference symbols R1 through R4 denote the AMR sensor M1. Reference symbols R5 through R8 denote the AMR sensor M2. Reference symbols H1 and H2 denote Hall elements. FIG. 27 is a block diagram showing part of a major electric configuration of the rotation sensor.

As shown in FIG. 26A, the Hall elements H1 and H2 are positioned so as to cause a phase difference of 45° between output signals from the Hall elements. The Hall element H1 outputs a sine signal at electric angle 360° per wavelength with reference to the relative rotation angle θ. The Hall element H2 outputs a signal having a phase difference of 45° with reference to an output signal from the Hall element H1 or outputs a sin(45°+θ) signal at electric angle 360° per wavelength.

As shown in FIG. 27, a sin θ cos θ computing section 54 is electrically connected between the amplification section 52 and the comparison section 53. The sin θ cos θ computing section 54 picks up a sin θ signal and a cos θ signal using the sine signal and the sin(45°+θ) signal output from the amplification section 52. The sin θ cos θ computing section 54 converts the sin(45°+θ) output from the amplification section 52 into a (sin θ+cos θ)/2^{1/2} signal. The sin θ cos θ computing section 54 then uses this signal and the sine signal to pick up the sine signal and the cos θ signal.

### Eleventh Embodiment

The eleventh embodiment of the invention will be described. FIG. 28 is a block diagram showing a configuration of the angle computing section 60 provided for a rotation sensor according to this embodiment.

The angle computing section 60 performs an arc tangent operation on sin 2θ and cos 2θ based on a sin 2θ signal output from the AMR sensor M1 and a cos 2θ signal output from the AMR sensor sensor M2 and finds computed angle φ=tan⁻¹(sin 2θ/cos 2θ). The angle computing section 60 includes A/D converters 81 and 82, a DSP (Digital Signal Processor) 83, a D/A converter 84, and an amplifier circuit 85. The DSP 83 includes an averaging section 83a, a temperature characteristics correcting section 83b, and an angle calculation section 83c.

The A/D converter 81 converts a sin 2θ signal output from the AMR sensor M1 into a digital value at a specified sampling interval. The A/D converter 82 converts a cos 2θ signal output from the AMR sensor M2 into a digital value at a specified sampling interval. The sampling interval is determined by a sampling frequency generated based on the clock frequency of a clock signal that is supplied from a CPU (not shown) to the angle computing section 60.

The averaging section 83a of the DSP 83 calculates an average value of digital values converted by the A/D converter 81 during the specified sampling period. The averaging section 83a also calculates an average value of digital values converted by the A/D converter 82 during the specified sampling period. A change in the ambient temperature varies characteristics of the permanent magnet 2 and the rotation sensor 1. As a result, an error occurs in the computed angle. To solve this problem, the temperature characteristics correcting section 83b corrects average values calculated by the averaging section 83a based on temperature characteristics of the permanent magnet 2 and the rotation sensor 1 and decreases an error in the computed angle.

The angle calculation section 83c performs an arc tangent operation on sin 2θ and cos 2θ using sin 2θ and cos 2θ for the digital values corrected by the temperature characteristics correcting section 83b and calculates the computed angle φ. The D/A converter 84 converts the computed angle φ output from the angle calculation section 83c into an analog signal. The amplifier circuit 85 amplifies the analog signal that is then output as a signal representing the computed angle φ.

### Twelfth Embodiment

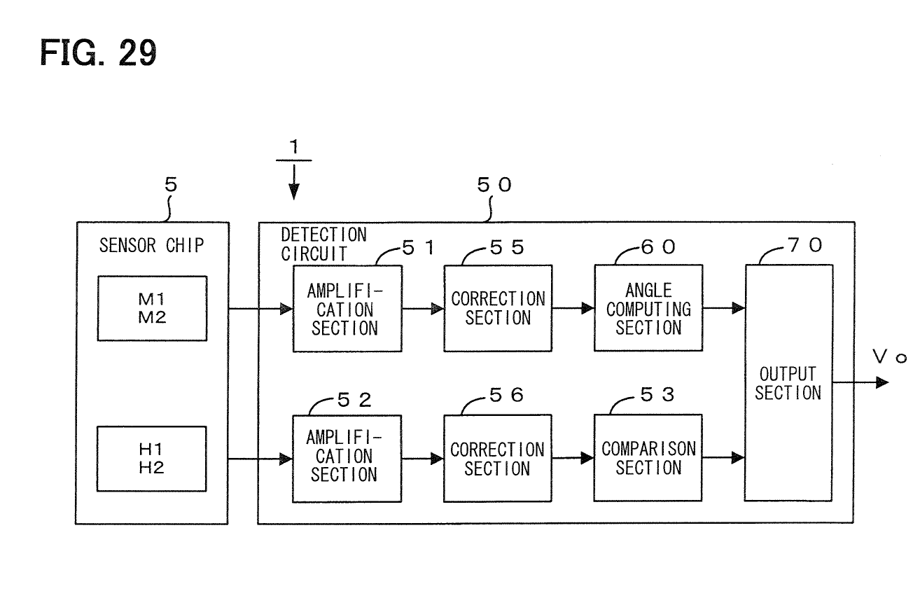

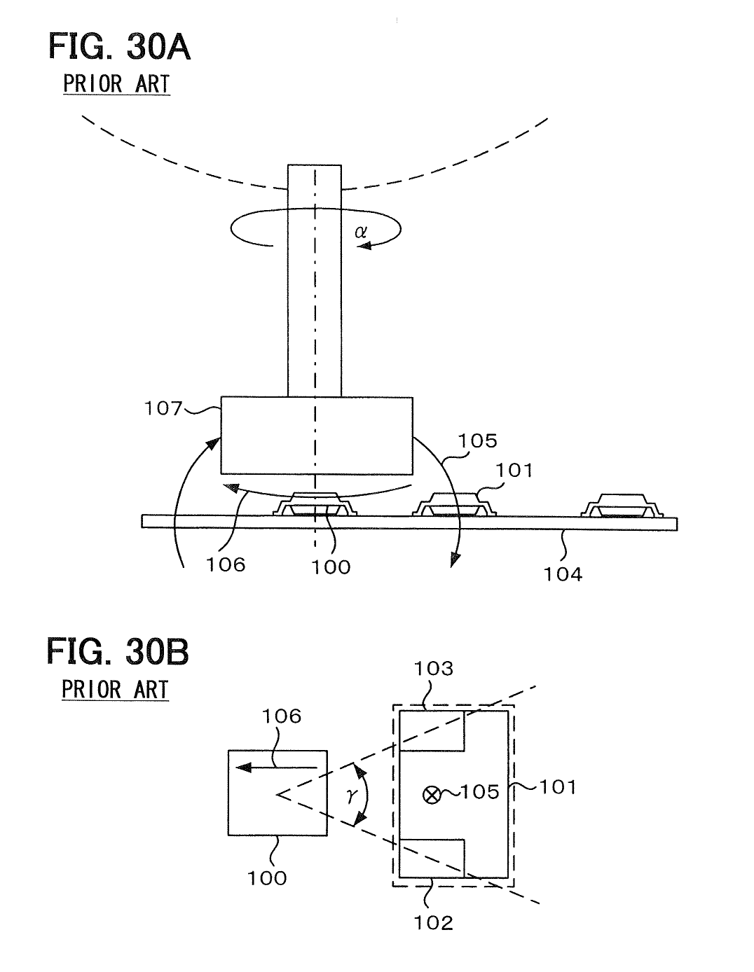

The twelfth embodiment of the invention will be described. FIG. 29 is a block diagram showing a major electric configuration of a rotation sensor according to this embodiment.

The detection circuit 50 includes correction sections 55 and 56. The correction section 55 corrects an amplitude difference, an offset, and an initial phase error in sin 2θ and cos 2θ signals output from the amplification section 51.

The correction section 56 corrects an amplitude difference, an offset, and an initial phase error in sin θ and cos θ signals output from the amplification section 52.

The rotation sensor according to the embodiment can correct an amplitude difference, an offset, and an initial phase error in signals output from the AMR sensors M1 and M2 and the Hall elements H1 and H2. The rotation sensor can improve the accuracy of detecting the relative rotation angle θ.

### Other Examples

(1) In the first embodiment, the output logic circuit 71 can be provided for a portion (e.g., a vehicle-mounted ECU) that uses outputs from the output logic circuit 71, instead of being provided on the same substrate that contains the angle computing section 60.

(2) The detection circuit 50 can be formed on the silicon substrate 10 so as to be integrated with the sensor chip 5.

(3) Pulses output from the Hall element H1 or H2 can be counted to detect multiple rotations (360° or more).

(4) The silicon substrate 10 can be replaced by a substrate made of compound semiconductor materials such as GaAs, InAs, and InSb.

(5) The permanent magnet can be replaced by a member coated with magnetic ink. It is also possible to use a conductive member whose surface is magnetized.

(6) The horizontal Hall element can overlap with the magneto-resistance element region so that the magnetism detection plane is perpendicular to the magneto-resistance element.

(7) The output logic circuit 71 may output a digital value indicating an output angle corresponding to the relative rotation angle θ ranging from 0° to 360°

(8) It may be preferable to perform A/D conversion on outputs from the comparison circuits 53a and 53b, compare the converted digital value with a digital threshold value, and output a comparison result.

(9) It may be preferable to compare computed angle φ output from the up-down counter 65 with a digital threshold value and output a comparison result. This configuration eliminates the need to generate the pulse signal VM1.

The rotation sensor 1 is available to anything that causes relative rotation. For example, the rotation sensor 1 is applicable to: a crank angle sensor that detects crank angles of a crank shaft provided for an internal-combustion engine; a cam angle sensor that detects cam angles of a cam shaft; a steering angle sensor that detects steering angles of a steering apparatus provided for a vehicle; and a sensor that detects rotation angles of various motors provided for a vehicle. The rotation sensor 1 is also applicable to a sensor that detects angles of joints used for a robot.

### Thirteenth Embodiment

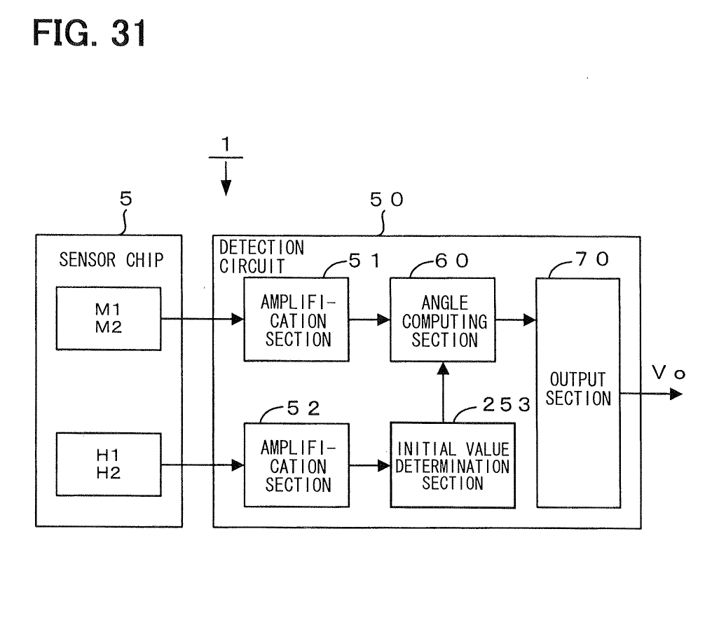

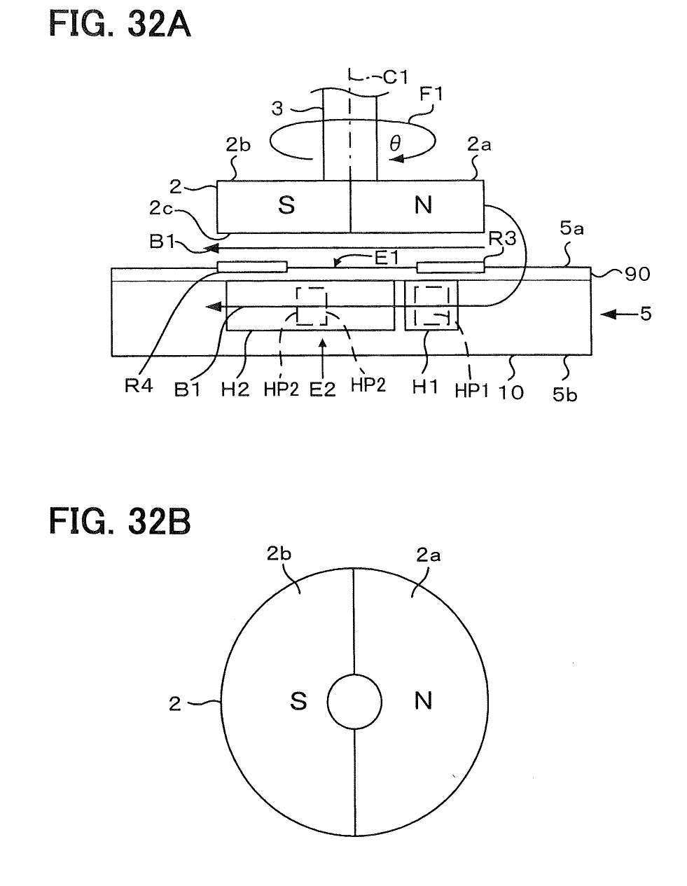

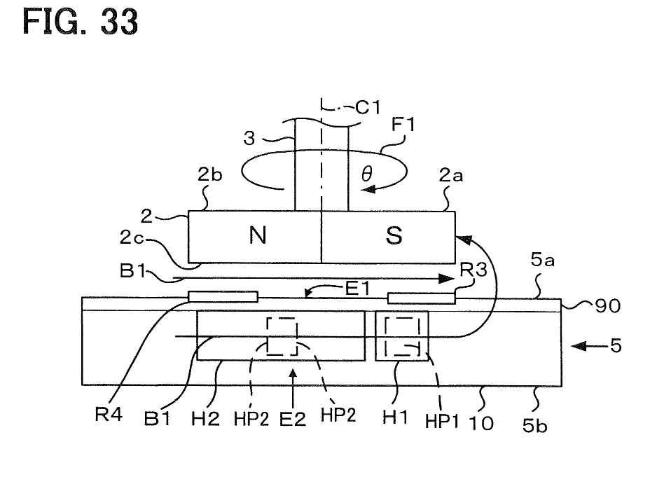

The thirteenth embodiment of the invention will be described with reference to the accompanying drawings. FIG. 31 is a block diagram showing a major configuration of a rotation sensor according to this embodiment. FIG. 32A is a vertical sectional view of the sensor chip and the permanent magnet and exemplifies the use of the sensor chip shown in FIG. 31. FIG. 32B is a plan view of the permanent magnet shown in FIG. 32A. FIG. 33 is a vertical sectional view showing the permanent magnet shown in FIG. 32A rotated 180°.

As shown in FIG. 31, the detection circuit 50 includes the amplification sections 51 and 52, an initial value determination section 253, the angle computing section 60, and the output section 70. The amplification section 51 amplifies output signals from the AMR sensors M1 and M2. The angle computing section 60 uses the amplified signal output from the amplification section 51 and calculates the relative rotation angle θ of the permanent magnet 2.

The amplification section 52 amplifies output signals from the Hall elements H1 and H2. The initial value determination section 253 compares each amplified signal output from the amplification section 52 with a threshold value. Based on a comparison result, the initial value determination section 253 determines which angular range of degrees covers an initial value 0θ for the relative rotation angle θ of the permanent magnet 2. The initial value determination section 253 settles an initial value φ0 for the computed angle φ corresponding to the determined angular range.

The output section 70 is supplied with the computed angle φ computed by the angle computing section 60. The output section 70 outputs a linear signal with voltage Vo corresponding to the computed angle φ at one cycle while the permanent magnet 2 rotates one turn.

(Sensor Chip Structure)

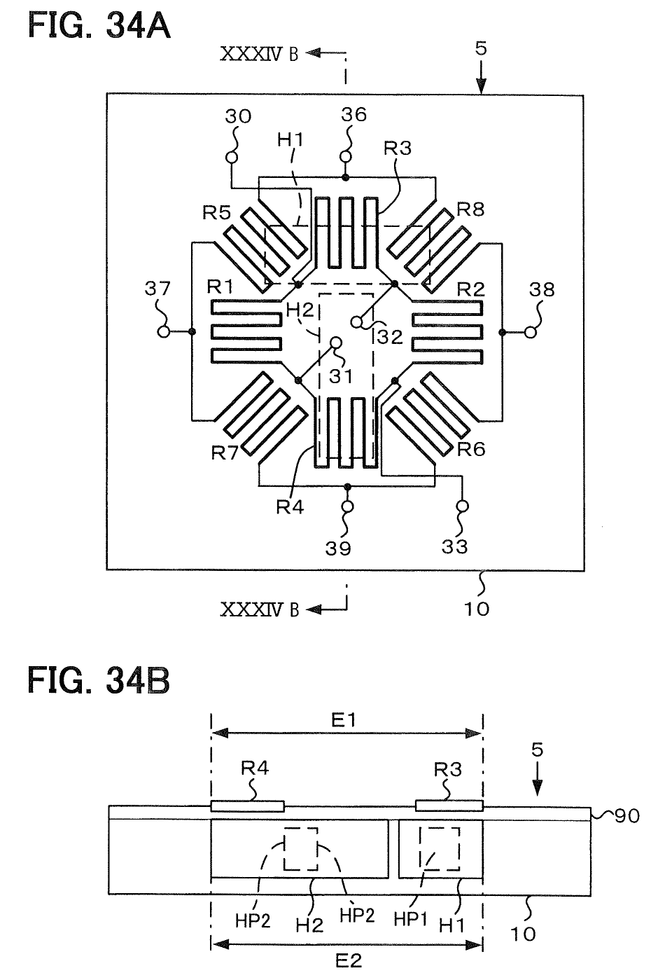

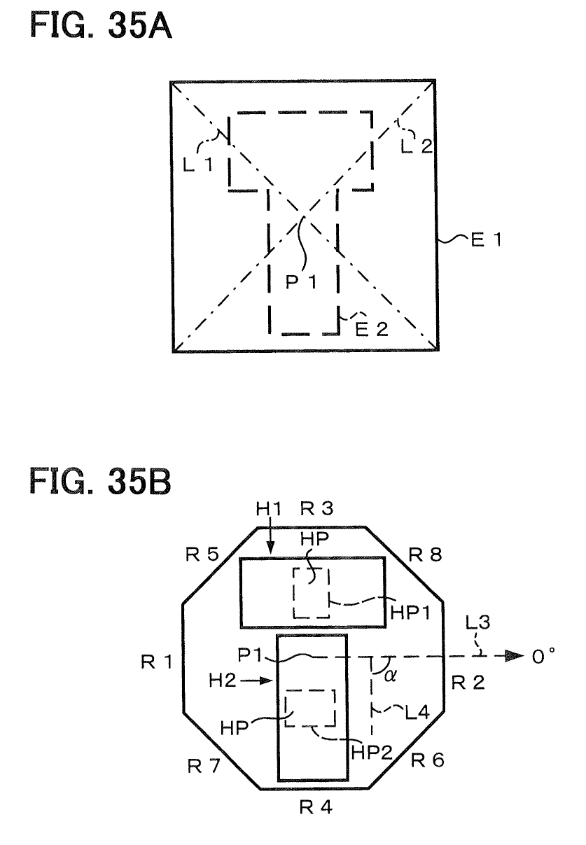

The structure of the sensor chip 5 will be described. FIG. 34A is a plan view schematically showing the structure of the sensor chip. FIG. 34B is a cross sectional view taken along the line XXXIVB-XXXIVB of FIG. 34A. Reference symbols R1 through R4 denote the AMR sensor M1. Reference symbols R5 through R8 denote the AMR sensor M2. Reference symbols H1 and H2 denote Hall elements. FIG. 35A is a plan view showing the magneto-resistance element region E1 and the Hall element area E2. FIG. 35B shows a layout angle between the Hall elements H1 and H2. Reference symbol HP denotes the magnetism detection section. In the drawings, the Hall elements H1 and H2 are illustrated larger than actual sizes in order to clearly represent the layout of the Hall elements H1 and H2. The magneto-resistance elements are also illustrated larger than actual sizes in order to clearly represent the element growth direction.

As shown in FIGS. 34A and 34B, the sensor chip 5 includes the silicon substrate 10, the insulating film 90, the AMR sensors M1 and M2 (magneto-electric conversion elements), and the Hall elements H1 and H2 (detection elements). The insulating film 90 is formed on the surface of the silicon substrate 10. The AMR sensors M1 and M2 are formed on the surface of the insulating film 90. The Hall elements H1 and H2 are formed in the silicon substrate 10. The AMR sensor M1 includes the magneto-resistance elements R1 to R4. The AMR sensor M2 includes the magneto-resistance elements R5 to R8. The Hall elements H1 and H2 are positioned below the magneto-resistance elements R1 to R8 so as to overlap with each other through the insulating film 90.

As shown in FIG. 35B, the Hall elements H1 and H2 are positioned so as to form an angle of 90° between magnetism detection planes HP1 and HP2 of the magnetism detection sections HP. Namely, the Hall elements H1 and H2 are positioned so as to cause a phase difference of 90° between output signals. A line is horizontally extended from a relative rotation center P1 of the sensor chip 5 toward the magneto-resistance element R2 and is defined as the reference line L3. A line parallel to the magnetism detection plane HP1 of the Hall element H1 is defined as L4. The position of the reference line L3 is defined as a reference angle 0°. The Hall element H1 is positioned so that its magnetism detection plane HP1 and the reference line L3 form the angle α of 90°.

The Hall element H2 is positioned so that its magnetism detection plane HP2 parallels the reference line L3. An angle of 90° is formed between the magnetism detection plane HP1 of the Hall element H1 and the easy axis of magnetization of the magneto-resistance element R2 positioned at reference angle 0°. That is, the Hall element H1 outputs a sinθ signal with the same phase as the relative rotation angle θ. The Hall element H2 outputs a cos θ signal with a phase difference of 90° with reference to the Hall element H1. The sin signal and the cos signal change the signal levels at two cycles in accordance with the magnetic field intensity while the permanent magnet 2 rotates one turn.

(AMR Sensor Structures)

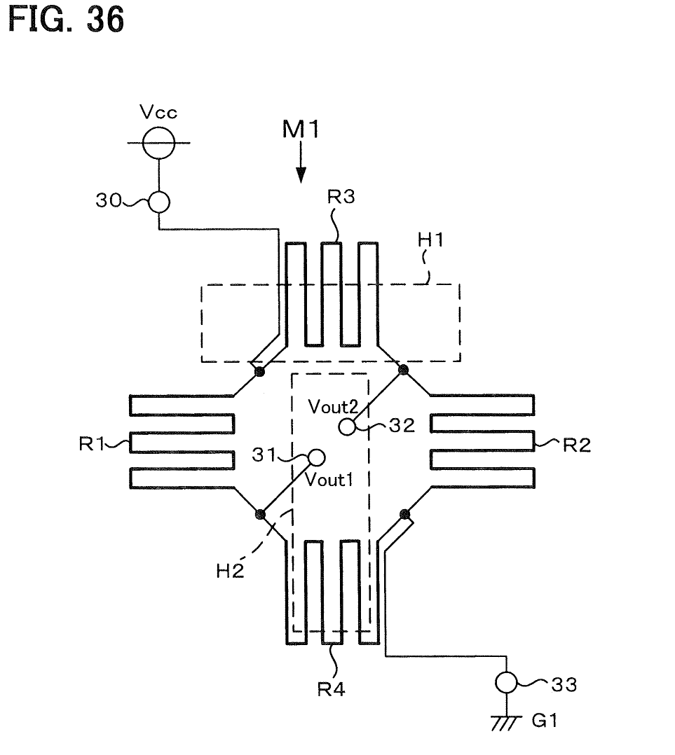

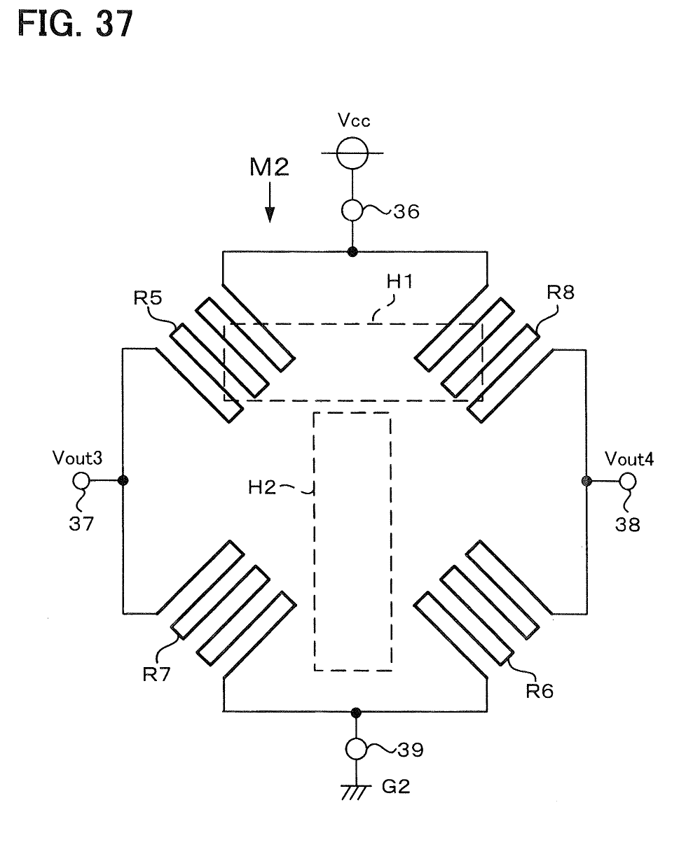

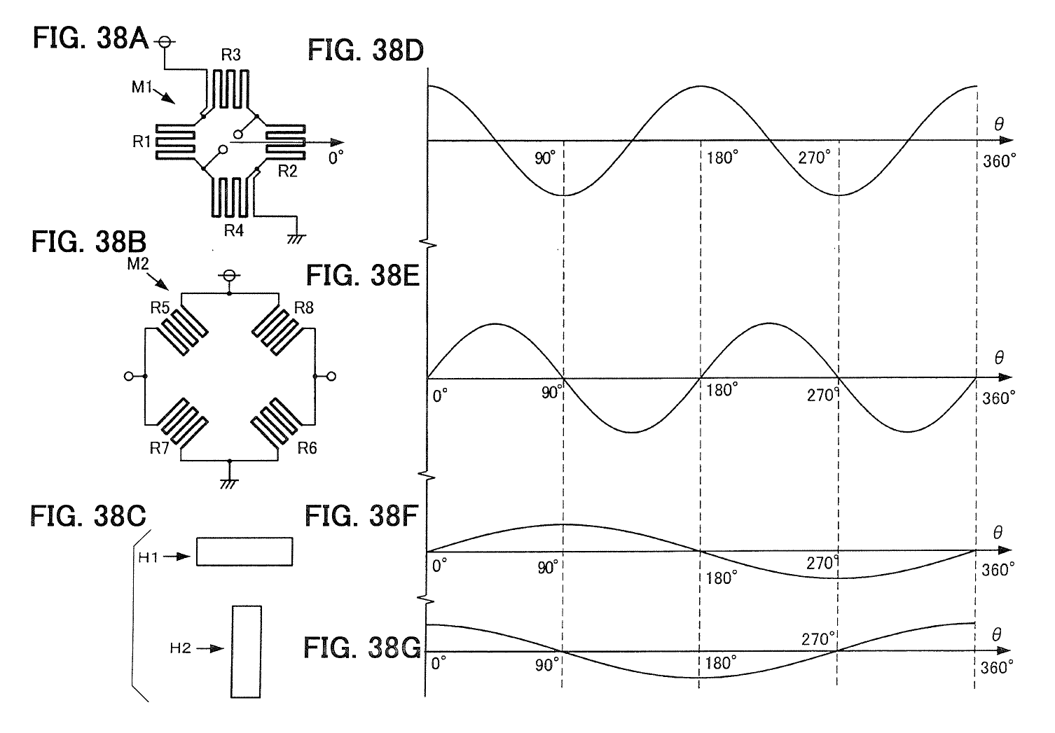

Structures of the AMR sensors M1 and M2 will be described. FIG. 36 is a plan view schematically showing a structure of the AMR sensor M1. Reference symbols R1 through R4 denote magneto-resistance elements. Reference symbols H1 and H2 denote Hall elements. FIG. 37 is a plan view schematically showing a structure of the AMR sensor M2. Reference symbols R5 through R8 denote magneto-resistance elements. Reference symbols H1 and H2 denote Hall elements. An equivalent circuit for the AMR sensor M1 is equal to that shown in FIG. 8. An equivalent circuit for the AMR sensor M2 is equal to that shown in FIG. 9. FIGS. 38A through 38G show output signals from the AMR sensor M1 and M2 and the Hall elements H1 and H2.

As shown in FIG. 10, the AMR sensor M1 outputs a sin signal at electric angle 180° per wavelength. The AMR sensor M2 outputs a cos signal at electric angle 180° per wavelength with a phase difference of 45° from the AMR sensor M1.

The Hall elements H1 and H2 are positioned so as to cause a phase difference of 90° between output signals. When the permanent magnet 2 rotates 360° as shown in FIG. 9, the Hall element H1 outputs a sin signal oscillating at electric angle 360° per wavelength. The Hall element H2 outputs a cos signal oscillating at electric angle 360° per wavelength. When the permanent magnet 2 rotates two or more turns, a sequence of 360° and 0° is assumed to be successive.

(Hall Element Structure)

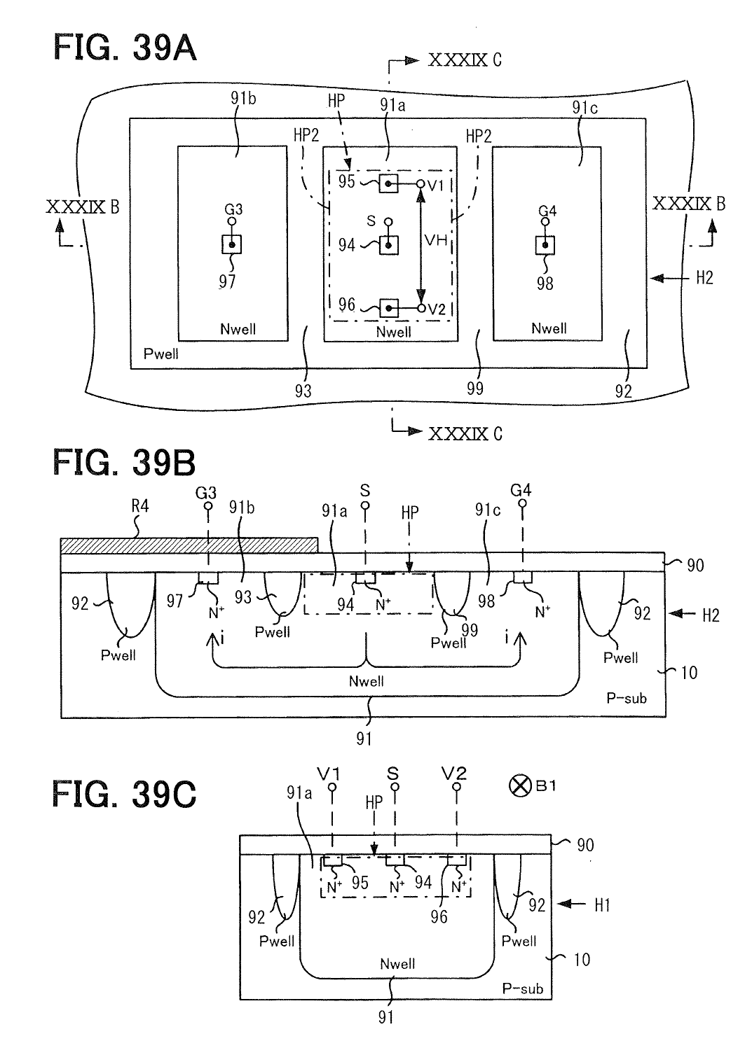

The structure of the Hall elements H1 and H2 will be described. The Hall elements H1 and H2 have the same structure. The Hall element H2 will be described as an example. FIG. 39A is a plan view showing the Hall element H2 and its partial vicinity. FIG. 39B is a cross sectional view taken along the line XXXIXB-XXXIXB of FIG. 39A. FIG. 39C is a cross sectional view taken along the line XXXIXC-XXXIXC of FIG. 39A.

(Electric Configuration)

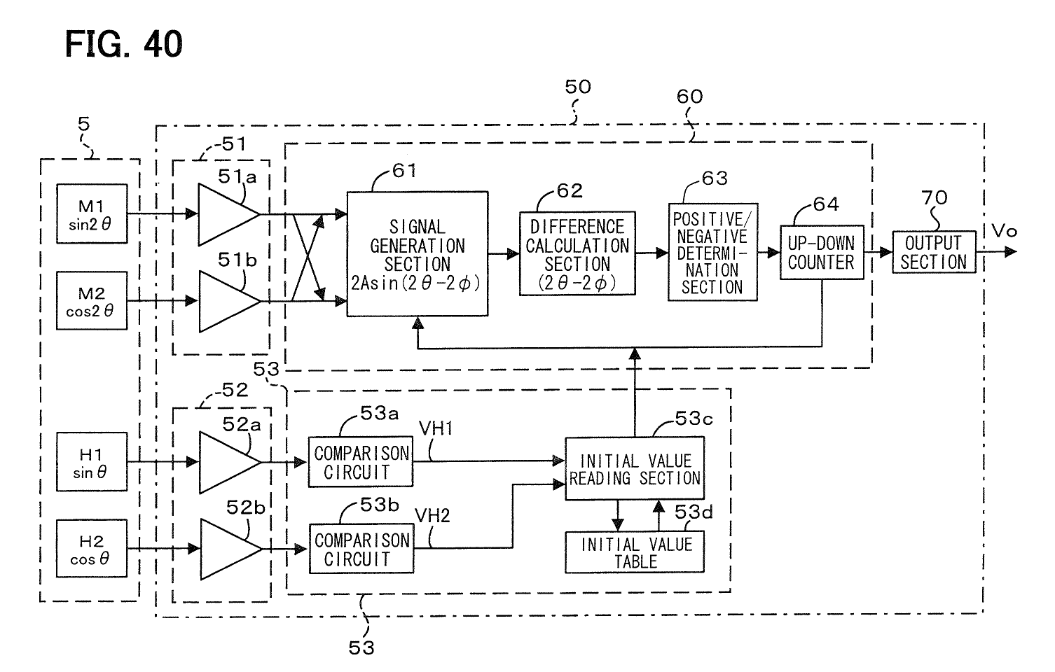

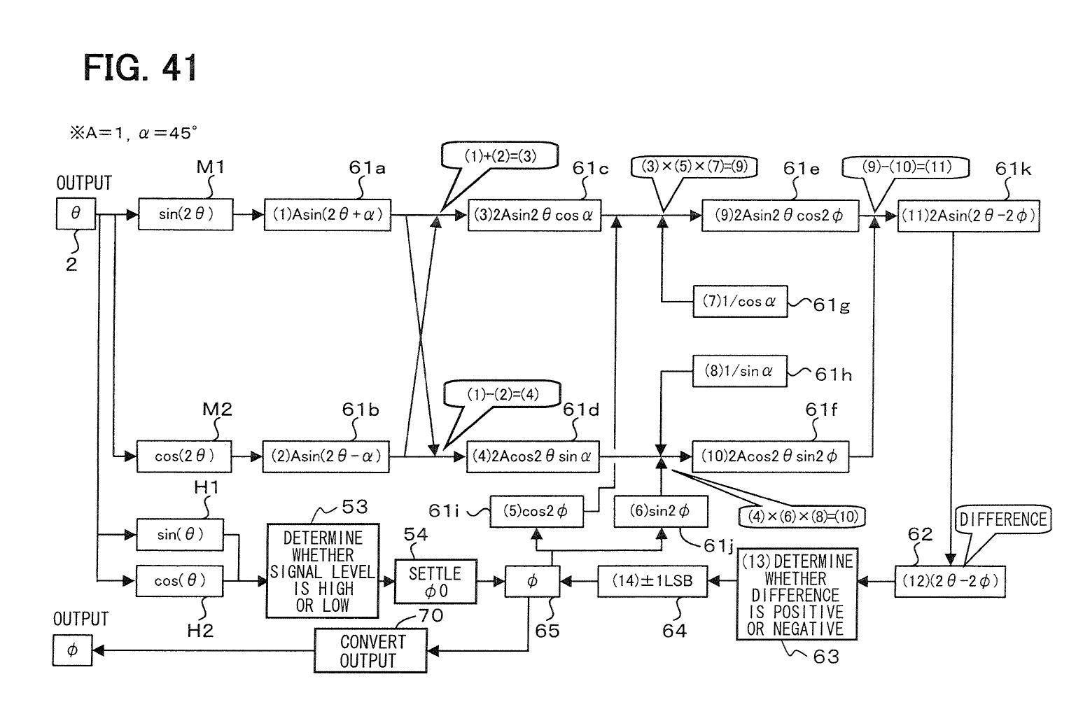

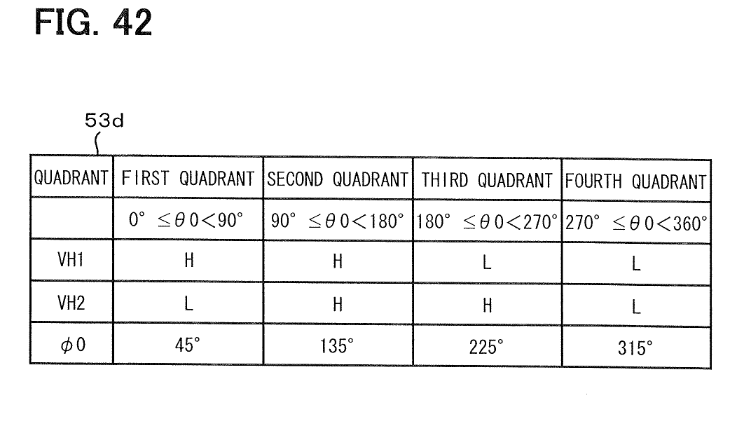

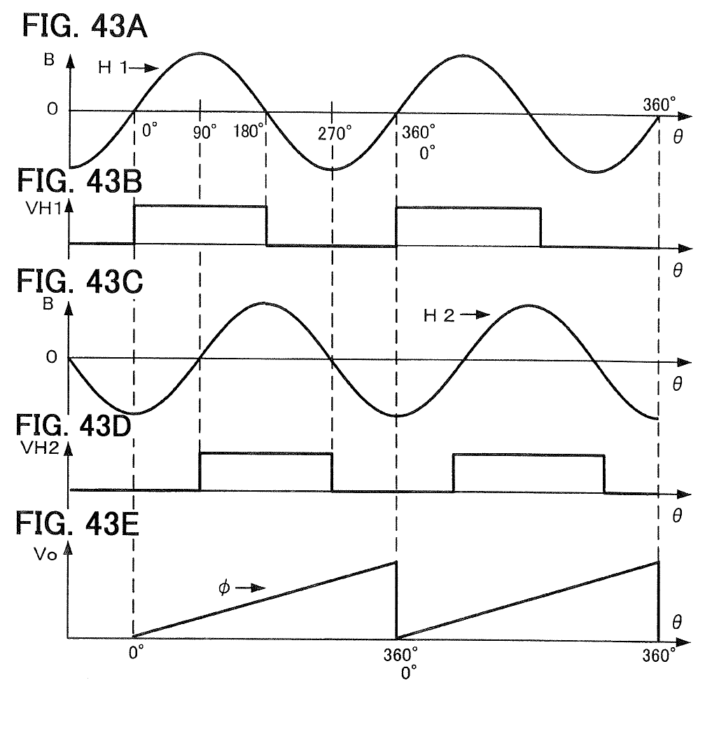

The major electric configuration of the rotation sensor 1 will be described. FIG. 40 is a block diagram showing a major electric configuration of the rotation sensor 1 and corresponds to FIG. 31. FIG. 41 shows signal flows between blocks in FIG. 40. FIG. 42 shows a configuration of an initial value table 53d shown in FIG. 40. FIG. 43A shows an output waveform from the Hall element H1. FIG. 43B shows an output waveform from the comparison circuit 53a. FIG. 43C shows an output waveform from the Hall element H2. FIG. 43D shows an output waveform from the comparison circuit 53b. FIG. 43E shows an output waveform from an output section 70.

Amplification Section 52 and Initial Value Determination Section 253

An amplification section 52 includes amplifier circuits 52a and 52b. The amplifier circuit 52a amplifies a detection signal sine output from the Hall element H1. The amplifier circuit 52b amplifies a detection signal cos θ output from the Hall element H2. The initial value determination section 253 includes comparison circuits 53a and 53b, an initial value reading section 53c, and the initial value table 53d.

The comparison circuit 53a compares a signal level VH1 of a detection signal (FIG. 43A) output from the amplifier circuit 52a with a threshold level (0 V). The comparison circuit 53a outputs a pulse signal (FIG. 43B) corresponding to the comparison result. The comparison circuit 53b compares a signal level VH2 of a detection signal (FIG. 43C) output from the amplifier circuit 52b with a threshold level (0 V). The comparison circuit 53b outputs a pulse signal (FIG. 43D) corresponding to the comparison result.

The initial value determination section 253 uses results of comparison between the threshold value (0 V) and the signal levels VH1 and VH2 of the detection signals output from the Hall elements H1 and H2, i.e., outputs from the comparison circuits 53a and 53b, to determine which angular range covers an initial value θ0 for the relative rotation angle θ. The initial value determination section 253 then uses the initial value table 53d to settle an initial value φ0 for the computed angle φ so that the initial value φ0 satisfies the condition of |θ0−φ0|<90°. This means an absolute value for the difference between θ0 and φ0 is smaller than 90°, where θ0 denotes the initial value for the relative rotation angle θ that may occur in the determined angular range, and φ0 denotes the initial value for the computed angle φ.

As shown in FIG. 43B, the comparison circuit 53a outputs a pulse signal that keeps the high level (H) at the input angle θ between 0° and 180° and keeps the low level (L) at the input angle θ between 180° and 360°. As shown in FIG. 43D, the comparison circuit 53b outputs a pulse signal that keeps the high level (H) at the input angle θ between 90° and 270° and keeps the low level (L) at the input angle θ between 270° and 90°.

Let us suppose the following at an initial state where the permanent magnet 2 does not rotate. The comparison circuit 53a may output a pulse signal whose signal level is set to H. The comparison circuit 53b may output a pulse signal whose signal level is set to L. In this case, it is possible to determine that the initial value θ0 for the relative rotation angle θ of the permanent magnet 2 belongs to the first quadrant (0°≦θ<90°). The comparison circuit 53a may output a pulse signal whose signal level is set to H. The comparison circuit 53b may output a pulse signal whose signal level is also set to H. In this case, it is possible to determine that the initial value θ0 for the relative rotation angle θ of the permanent magnet 2 belongs to the second quadrant (90°≦θ<180°).

The comparison circuit 53a may output a pulse signal whose signal level is set to L. The comparison circuit 53b may output a pulse signal whose signal level is set to H. In this case, it is possible to determine that the initial value θ0 for the relative rotation angle θ of the permanent magnet 2 belongs to the third quadrant (180°≦θ<270°). The comparison circuit 53a may output a pulse signal whose signal level is set to L. The comparison circuit 53b may output a pulse signal whose signal level is also set to L. In this case, it is possible to determine that the initial value θ0 for the relative rotation angle θ of the permanent magnet 2 belongs to the fourth quadrant (270°≦θ<360°).

The comparison circuits 53a and 53b output the pulse signals whose signal levels vary as mentioned above. The signal levels can be combined to determine the quadrant (angular range) that covers the initial value θ0 for the relative rotation angle θ of the permanent magnet 2.

The embodiment assumes four angular ranges by dividing the relative rotation angle θ ranging from 0° to 360° by the phase difference 90° between output signals from the Hall elements H1 and H2. As shown in FIG. 14, four quadrants as the angular ranges include the first quadrant (0°≦θ0<90°), the second quadrant (90°≦θ0<180°), the third quadrant (180°≦θ0<270°), and the fourth quadrant (270°≦θ0<360°).

As shown in FIG. 42, the initial value table 53d shows the correspondence among the signal level VH1 (H or L) of a pulse signal output from the comparison circuit 53a, the signal level VH2 (H or L) of a pulse signal output from the comparison circuit 53b, and the initial value φ0 for the computed angle φ. According to the embodiment, the combination of H and L as the signal levels VH1 and VH2, respectively, corresponds to the initial value 45°. The combination of H and H as the signal levels VH1 and VH2, respectively, corresponds to the initial value 135°. The combination of L and H as the signal levels VH1 and VH2, respectively, corresponds to the initial value 225°. The combination of L and L as the signal levels VH1 and VH2, respectively, corresponds to the initial value 315°. Each quadrant represents a unique combination of the signal levels VH1 and VH2.

Each initial value represents a digital angle and is equivalent to a count value generated from an up-down counter 64 (to be described) included in the angle computing section 60. The initial value table 53d stores the count value as an initial value. The initial value table 53d may be stored in storage media such as ROM and flash ROM.

The initial value reading section 53c (FIG. 40) references the initial value table 53d and reads the initial value φ0 associated with a combination of signal levels VH1 and VH2 of pulse signals output from the comparison circuits 53a and 53b. For example, let us suppose that the comparison circuits 53a and 53b output pulse signals whose signal levels VH1 and VH2 are set to H and L, respectively. In this case, the initial value reading section 53c reads 45° as the initial value φ0 from the initial value table 53d.

(Amplification Section 51 and Angle Computing Section 60)

The amplification section 51 includes the differential amplifier circuits 51a and 51b. The differential amplifier circuit 51a differentially amplifies an output signal sin 2θ from the AMR sensor M1. The differential amplifier circuit 51b differentially amplifies an output signal cos 2θ from the AMR sensor M2. The angle computing section 60 functions as a tracking loop type digital angle converter. The angle computing section 60 includes a signal generation section 61, a difference calculation section 62, a positive/negative determination section 63, and an up-down counter (U/D counter) 64.

The angle computing section 60 computes the relative rotation angle θ using signals output from the AMR sensor M1 and M2. In this case, the angle computing section 60 performs feedback control so that a difference between the relative rotation angle θ for the permanent magnet 2 and the computed angle φ converges on a specified value. The angle computing section 60 uses the initial value φ0 settled by the initial value determination section 253 as the initial value φ0 for the computed angle to start computing the relative rotation angle θ.

The signal generation section 61 generates a signal 2A sin(2θ−2φ) using a signal A sin(2θ+α) output from the differential amplifier circuit 51a and a signal A cos(2θ−α) output from the differential amplifier circuit 51b. In these signals, A denotes the amplitude and a denotes the phase difference. The embodiment uses the amplitude A set to 1 and the phase difference α set to 45°. The difference calculation section 62 calculates a difference (2θ−2φ) using the signal 2A sin(2θ−2φ) output from the signal generation section 61. The positive/negative determination section 63 determines whether the difference (2θ−2φ) calculated by the difference calculation section 62 is a positive value or a negative value. The up-down counter 64 adds (increments) or subtracts (decrements) the count value in accordance with a determination result from the positive/negative determination section 63.

(Processes of the Signal Generation Section 61)

With reference to FIG. 41, the following describes processes performed by the signal generation section 61. Blocks 61a through 61k in FIG. 41 represent a process performed by the signal generation section 61 and a signal or data generated by the process.

The signal generation section 61 adds a signal A sin(2θ+α) and a signal A cos(2θ−α) to generate a signal 2A sin 2θcos α (61c). A known adder circuit can be used for the addition. The signal generation section 61 subtracts the signal A cos(2θ−α) from the signal A sin(2θ+α) to generate a signal 2A cos 2θ sin α (61d). A known subtraction circuit can be used for the subtraction.

The signal generation section 61 multiplies a signal A sin 2θcos α by a signal cos 2φ and (1/cos α) to generate a signal 2A sin 2θcos 2φ (61c, 61i, and 61g). The signal generation section 61 multiplies the signal 2A cos 2θ sin α by a signal sin 2φ and (1/sin α) to generate a signal 2A cos 2θsin 2φ (61d, 61j, and 61h). A known multiplication circuit can be used for the multiplication.

In the multiplication, (1/cos α) and (1/sin α) are unchanged coefficients. In cos 2φ (61i) and sin 2φ (61j), φ is a variable that varies with a count value from the up-down counter 64. The initial value reading section 53c uses the initial value φ0 read from the initial value table 53d as the computed angle φ before the permanent magnet 2 starts rotating, i.e., before the rotation sensor 1 detects the relative rotation angle θ.

The signal generation section 61 subtracts the signal 2A cos 2θ sin 2φ from the signal 2A sin 2θcos 2φ to generate the signal 2A sin(2θ−2φ), i.e., a sin signal using the difference (2θ−2φ) as a variable. A known subtraction circuit can be used for the subtraction.

The difference calculation section 62 performs an arcsine operation on the signal 2A sin(2θ−2φ) generated from the signal generation section 61 to find the difference (2θ−2φ) (62). The positive/negative determination section 63 determines whether the difference (2θ−2φ) found by the difference calculation section 62 is a positive value or a negative value. According to a technique, the difference (2θ−2φ) can be assumed to be positive when the signal 2A sin(2θ−2φ) is larger than 0. The difference (2θ−2φ) can be assumed to be negative when the signal 2A sin(2θ−2φ) is smaller than 0. When this technique is used, it is needless to perform an arcsine operation on the signal 2A sin(2θ−2φ).

The up-down counter 64 increments the count value by adding 1 to the least significant bit (LSB) of the counter when the positive/negative determination section 63 determines the value to be positive. The up-down counter 64 decrements the count value by subtracting 1 from the least significant bit (LSB) of the counter when the positive/negative determination section 63 determines the value to be negative. The count value from the up-down counter 64 provides a digital angle, i.e., the computed angle φ (65).

The signal generation section 61 uses the computed angle φ (count value) output from the up-down counter 64 to generate the signals cos 2φ and sin 2φ (61i and 61j). To generate these signals, the signal generation section 61 uses a table that maintains correspondence between the computed angle φ (count value) and data cos 2φ and sin 2φ. The signal generation section 61 reads data cos 2φ and sin 2φ corresponding to the computed angle φ and converts the read data into an analog signal.

The signal generation section 61 again multiplies the signal 2A sin 2θcos α by the signal cos 2φ and (1/cos α) to generate the signal 2A sin 2θcos 2φ. The signal generation section 61 again multiplies the signal 2A cos 2θsin α by the signal sin 2φ and (1/sin α) to generate the signal 2A cos 2θsin 2φ. That is, the difference (2θ−2φ) is fed back to the signals cos 2φ and sin 2φ to vary the signal 2A sin(2θ−2φ). This feedback is repeated until the difference (2θ−2φ) converges on 0.

(Output Section 70)

The output section 70 outputs an analog signal. This signal is equivalent to an analog value converted from the computed angle φ output from the up-down counter 64. In more detail, the output section 70 latches the computed angle φ output from the up-down counter 64. The computed angle φ may be latched when the difference (2θ−2φ) becomes 0. The output section 70 converts that computed angle φ into an analog voltage Vo. The output section 70 generates and outputs an angular signal (FIG. 43E) whose voltage (Vo) linearly increases in accordance with the computed angle φ ranging from 0° to 360°.

(Problem of Not Settling the Initial Value φ0)

The embodiment uses the initial value φ0 for the computed angle φ determined based on the angular range that covers the initial value φ0 for a relative rotation angle. On the other hand, the following describes, with reference to the drawings, a problem of using 0° as the initial value φ0 without settling the initial value φ0 for the computed angle φ.

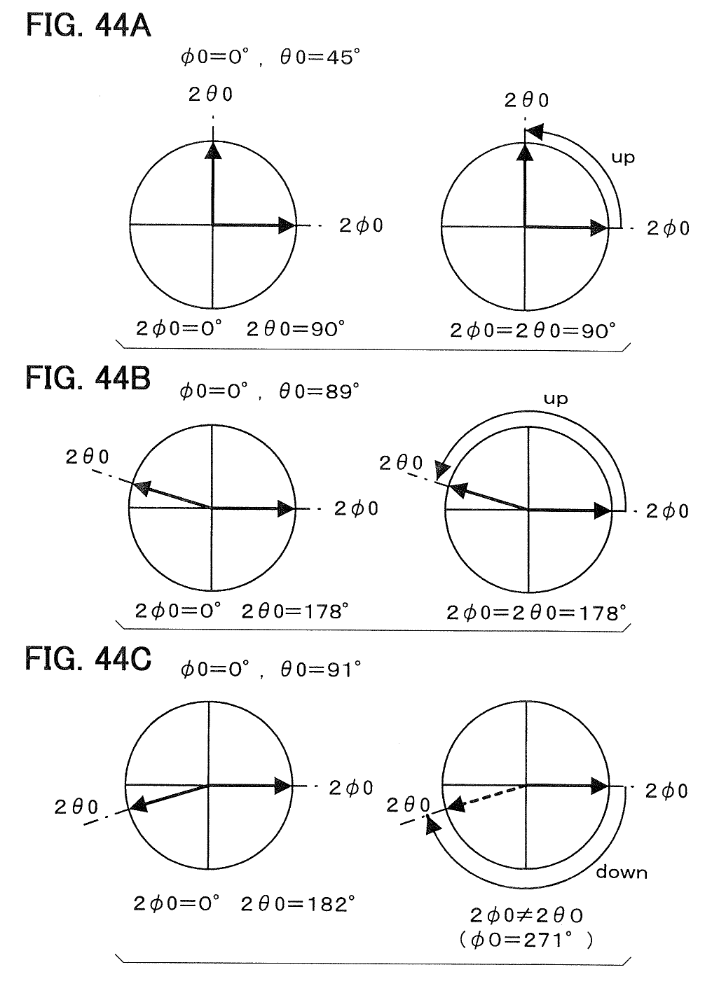

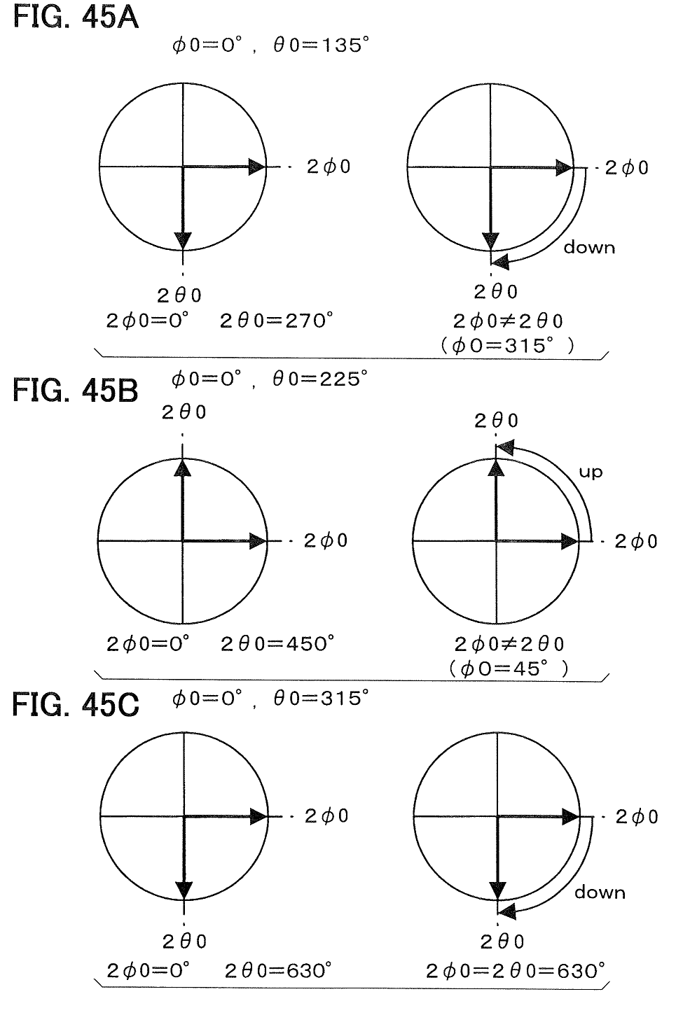

FIGS. 44A through 44C and 45A through 45C show a process in which the initial value θ0 for the computed angle φ follows the initial value θ0 for the relative rotation angle θ. In FIGS. 44A through 44C and 45A through 45C, the arrow marked “up” indicates that the up-down counter 64 adds (increments) the value. The arrow marked “down” indicates that the up-down counter 64 subtracts (decrements) the value. In the drawings, the initial value φ0 for the computed angle φ is assumed to be 0°. The drawings represent differences in terms of angles, not the count value, for ease of understanding.

### Example 1

When the initial value 00 for the relative rotation angle θ is set to 45° (FIG. 44A), the initial value for the difference (2θ−2φ) is calculated as (2θ0−2φ0)=(2×45°−2×0°)=90°. Whether the difference (2θ−2φ) is positive or negative determines whether the computed angle φ is incremented or decremented in response to the relative rotation angle θ. The computed angle φ is incremented when the difference is positive. The computed angle φ is decremented when the difference is negative.

The example assumes the difference (2θ0−2φ0) for the initial value to be 90°, resulting in 2 sin(2θ0−2φ0)=2 and therefore sin(2θ0−2φ0)=1. An arcsine operation is performed to cause the difference (2θ0−2φ0) for the initial value to be 90°. Since the difference is 90°>0, the computed angle φ is incremented. The computed angle φ is incremented by 1° from the initial value 0°. The difference (2θ−2φ) is decremented by 2φ(=2×1°) each time the computed angle φ is incremented by 1°. That is, the computed angle φ is incremented from 0° to 1°, . . . , 44°, and 45°. The difference (2θ−2φ) is decremented from 90° to 88°, . . . , 2°, and 0°. When the difference converges on 0°, the computed angle φ becomes 45° and equals the initial value 0θ=45° for the relative rotation angle θ. The computed angle φ correctly follows the relative rotation angle θ.

### Example 2

When the initial value θ0 for the relative rotation angle θ is set to 89°(FIG. 44B), the initial value for the difference (2θ−2φ) is calculated as (2θ0−2φ0)=(2×89°−2×0°=178°. The calculation results in 2 sin(2θ0−2φ0)=0.07 and therefore sin(2θ0−2φ0)=0.035. An arcsine operation is performed to cause the difference (2θ0−2φ0) for the initial value to be 2°. Since the difference is 2°>0, the computed angle φ is incremented.

The computed angle φ is incremented by 1° from the initial value 0°. The difference (2θ−2φ) is decremented by 2φ(=2×1°) each time the computed angle φ is incremented by 1°. That is, the computed angle φ is incremented from 0° to 1°, . . . , 88°, and 89°. The difference (2θ−2φ) is decremented from 178° to 176°, . . . , 2°, and 0°. When the difference converges on 0°, the computed angle φ becomes 89° and equals the initial value θ0=89° for the relative rotation angle θ. The computed angle φ correctly follows the relative rotation angle θ.

### Example 3

When the initial value θ0 for the relative rotation angle θ is 91° (FIG. 44C), the initial value for the difference (2θ−2φ) is calculated as (2θ0−2φ0)=(2×91°−2×0°)=182°. The calculation results in 2 sin(2θ0−2φ0)≈−0.07 and therefore sin(2θ0−2φ0)=−0.035. An arcsine operation is performed to cause the difference (2θ0−2φ0) for the initial value to be −2°. Since the difference is −2°<0, the computed angle φ is decremented.

The computed angle φ is decremented by 1° from the initial value 0° (360°). The difference (2θ−2φ) is decremented by 2φ(=2×1°) each time the computed angle φ is decremented by 1°. That is, the computed angle φ is decremented from 0° (360°) to 359°, . . . , 272°, and 271°. The difference (2θ−2φ) is decremented from −178° to −176°, . . . , −2°, and 0°. When the difference converges on 0°, the computed angle φ becomes 271° and chooses to follow in the direction of 271° approximate to the initial value φ0=0°. Therefore, a difference between the computed angle φ and the relative rotation angle θ is always 180°(=271°−91°). The computed angle φ does not correctly follow the relative rotation angle θ.

### Example 4

When the initial value θ0 for the relative rotation angle θ is 135° (FIG. 45A), the initial value for the difference (2θ−2φ) is calculated as (2θ0−2φ0)=(2×135°−2×0°=270°). The calculation results in 2 sin(2θ0−2φ0)=−2 and therefore sin(2θ0−2φ0)=−1. An arcsine operation is performed to cause the difference (2θ0−2φ0) for the initial value to be −90°. Since the difference is −90°<0, the computed angle φ is decremented.

The computed angle φ is decremented by 1° from the initial value 0° (360°). The difference (2θ−2φ) is decremented by 2φ(=2×1°) each time the computed angle φ is decremented by 1°. That is, the computed angle φ is decremented from 0° (360°) to 359°, . . . , 316°, and 315°. The difference (2θ−2φ) is decremented from −90° to −88°, . . . , −2°, and 0°. When the difference converges on 0°, the computed angle φ becomes 315° and chooses to follow in the direction of 315° approximate to the initial value φ0=0°. Therefore, a difference between the computed angle φ and the relative rotation angle θ is always 180°(=315°−135°). The computed angle φ does not correctly follow the relative rotation angle θ.

### Example 5

When the initial value θ0 for the relative rotation angle θ is 225° (FIG. 45B), the initial value for the difference (2θ−2φ) is calculated as (2θ0−2φ0)=(2×225°−2×0°)=450°. The calculation results in 2 sin(2θ0−2φ0)=2 and therefore sin(2θ0−2φ0)=1. An arcsine operation is performed to cause the difference (2θ0−2φ0) for the initial value to be 90°. Since the difference is 90°>0, the computed angle φ is incremented.

The computed angle φ is incremented by 1° from the initial value 0° (360°). The difference (2θ−2φ) is incremented by 2φ(=)2×1°) each time the computed angle φ is incremented by 1°. That is, the computed angle φ is incremented from 0° to 1°, . . . , 44°, and 45°. The difference (2θ−2φ) is decremented from 90° to 88°, . . . , 2°, and 0°. When the difference converges on 0°, the computed angle φ becomes 45° and chooses to follow in the direction of 45° approximate to the initial value φ0=0°. Therefore, a difference between the computed angle φ and the relative rotation angle θ is always 180° (=225°−45°). The computed angle φ does not correctly follow the relative rotation angle θ.

### Example 6

When the initial value θ0 for the relative rotation angle θ is 315° (FIG. 45C), the initial value for the difference (2θ−2φ) is calculated as (2θ0−2φ0)=(2×315°−2×0°)=630°. The calculation results in 2 sin(2θ0−2φ0)=−2 and therefore sin(2θ0−2φ0)=−1. An arcsine operation is performed to cause the difference (2θ0−2φ0) for the initial value to be −90°. Since the difference is −90°<0, the computed angle φ is decremented.

The computed angle φ is decremented by 1° from the initial value 0° (360°). The difference (2θ−2φ) is decremented by 2φ(=2×1°) each time the computed angle φ is decremented by 1°. That is, the computed angle φ is decremented from 0° (360°) to 359°, . . . , 316°, and 315°. The difference (2θ−2φ) is decremented from −90° to −88°, . . . , −2°, and 0°. When the difference converges on 0°, the computed angle φ becomes 315° and equals the initial value θ0=315° for the relative rotation angle θ. The computed angle φ correctly follows the relative rotation angle θ.

When the initial value φ0 for the computed angle φ is set to 0° as mentioned above, the computed angle φ may not correctly follow the relative rotation angle θ depending on initial values φ0 for the relative rotation angle θ. This is because the difference (2θ−2φ) as a 2× value is used to find the computed angle φ as a 1× value and two candidates (X and X+180°) for the computed angle φ result. That is, the relative rotation angle θ may not be correctly detected when 0° is used as the initial value φ0 without settling the initial value φ0 for the computed angle φ.

(Effect of Settling the Initial Value φ0)

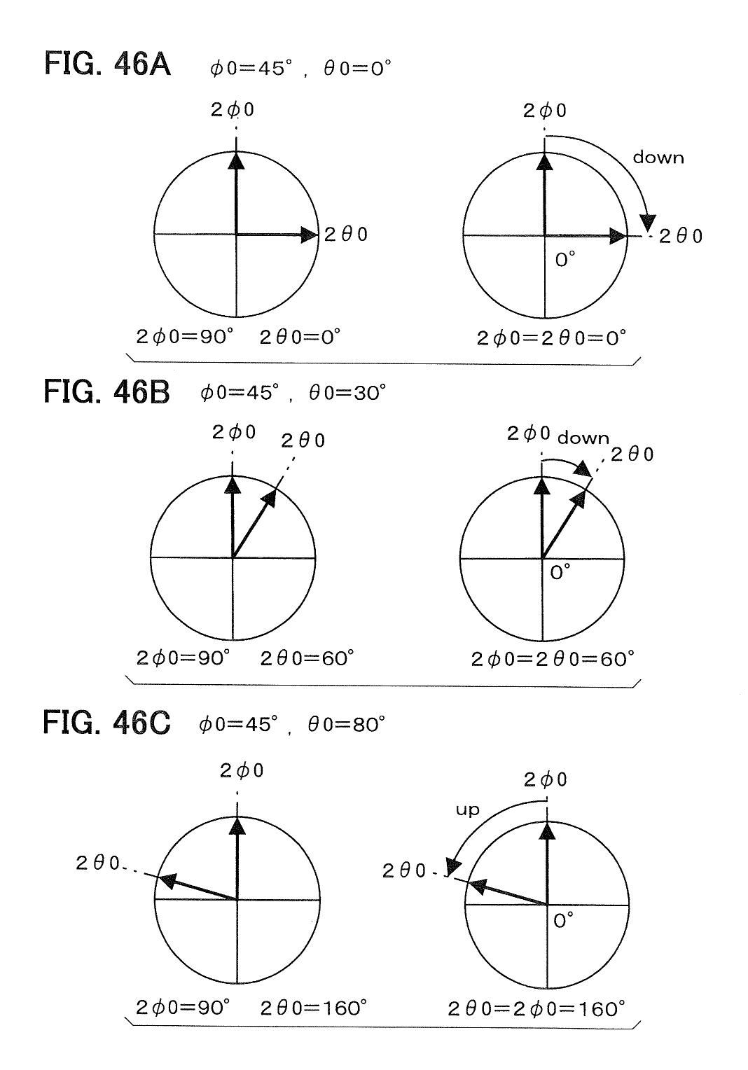

With reference to the drawings, the following describes an effect of settling the initial value φ0. FIGS. 46A through 49C show a process in which the initial value φ0 for the computed angle φ follows the initial value θ0 for the relative rotation angle θ. As mentioned above, the initial value φ0 is determined based on the angular range that covers the initial value φ0 for a relative rotation angle.

(Case of φ0=45°)

### Example 1

When the initial value θ0 for the relative rotation angle θ is 0° (FIG. 46A), the initial value for the difference (2θ−2φ) is calculated as (2θ0−2φ0)=(2×0°−2×45°=−90°. The calculation results in 2 sin(2θ0−2φ0)=−2 and therefore sin(2θ0−2φ0)=−1. An arcsine operation is performed to cause the difference (2θ0−2φ0) for the initial value to be −90°. Since the difference is −90°<0, the computed angle φ is decremented.

The computed angle φ is decremented by 1° from the initial value 45°. The difference (2θ−2φ) is decremented by 2φ(=2×1°) each time the computed angle φ is decremented by 1°. That is, the computed angle φ is decremented from 45° to 44°, . . . , 1°, and 0°. The difference (2θ−2φ) is decremented from −90° to −88°, . . . , −2°, and 0°. When the difference converges on 0°, the computed angle θ also becomes 0° and equals the initial value θ0=0° for the relative rotation angle θ. The computed angle φ correctly follows the relative rotation angle θ.

### Example 2

When the initial value θ0 for the relative rotation angle θ is 30° (FIG. 46B), the initial value for the difference (2θ−2φ) is calculated as (2θ0−2φ0)=(2×30°−2×45°)=−30°. The calculation results in 2 sin(2θ0−2φ0)=−1 and therefore sin(2θ0−2φ0)=−0.5. An arcsine operation is performed to cause the difference (2θ0−2φ0) for the initial value to be −30°. Since the difference is −30°<0, the computed angle φ is decremented.

The computed angle φ is decremented by 1° from the initial value 45°. The difference (2θ−2φ) is decremented by 2φ(=2×1°) each time the computed angle φ is decremented by 1°. That is, the computed angle φ is decremented from 45° to 44°, . . . , 31°, and 30°. The difference (2θ−2φ) is decremented from −30° to −28°, . . . , −2°, and 0°. When the difference converges on 0°, the computed angle φ also becomes 30° and equals the initial value θ0=30° for the relative rotation angle θ. The computed angle φ correctly follows the relative rotation angle θ.

### Example 3

When the initial value θ0 for the relative rotation angle θ is 80° (FIG. 46C), the initial value for the difference (2θ−2φ) is calculated as (2θ0−2φ0)=(2×80°−2×45°=70°. The calculation results in 2 sin(2θ0−2φ0)≈1.88 anφd therefore sin(2θ0−2φ0)≈0.94. An arcsine operation is performed to cause the difference (2θ0−2φ0) for the initial value to be 70°. Since the difference is 70°>0, the computed angle φ is incremented.

The computed angle φ is incremented by 1° from the initial value 45°. The difference (2θ−2φ) is decremented by 2φ(=2×1°) each time the computed angle φ is incremented by 1°. That is, the computed angle φ is incremented from 45° to 46°, . . . , 79°, and 80°. The difference (2θ−2φ) is decremented from 70° to 68°, . . . , 2°, and 0°. When the difference converges on 0°, the computed angle φ becomes 80° and equals the initial value θ0=80° for the relative rotation angle θ. The computed angle φ correctly follows the relative rotation angle θ.

(Case of φ0=135°)

### Example 1

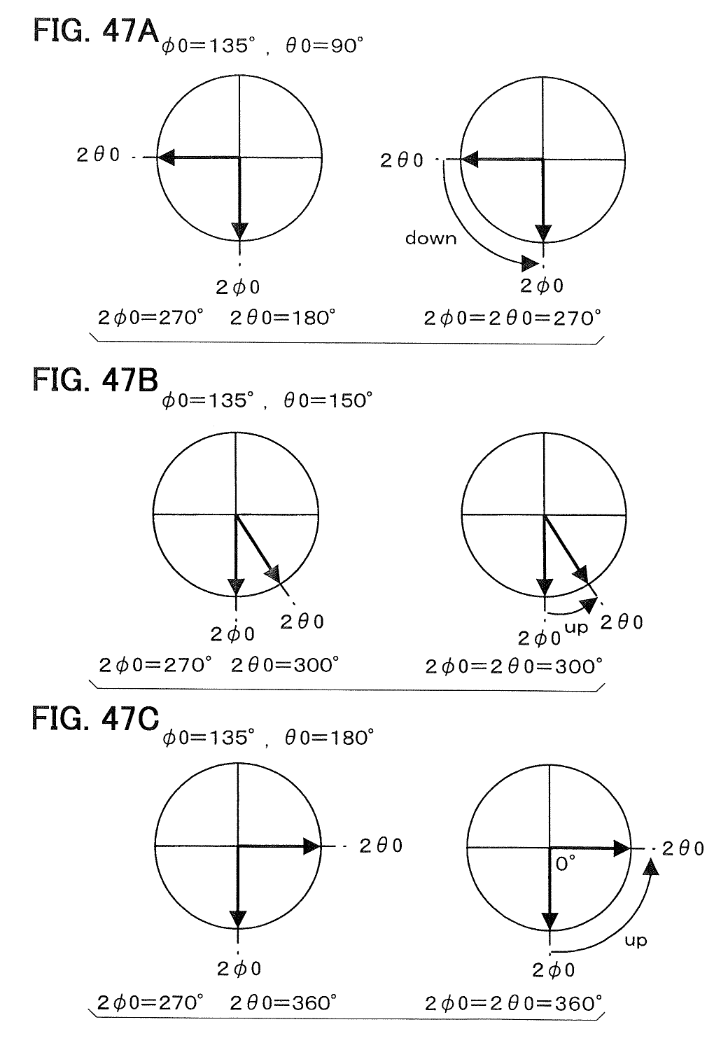

When the initial value θ0 for the relative rotation angle θ is 90° (FIG. 47A), the initial value for the difference (2θ−2φ) is calculated as (2θ0−2φ0)=(2×90°−2×135°=−90°. The calculation results in 2 sin(2θ0−2φ0)=−2 and therefore sin(2θ0−2φ0)=−1. An arcsine operation is performed to cause the difference (2θ0−2φ0) for the initial value to be −90°. Since the difference is −90°<0, the computed angle φ is decremented.

The computed angle φ is decremented by 1° from the initial value 135°. The difference (2θ−2φ) is decremented by 2φ(=2×1°) each time the computed angle φ is decremented by 1°. That is, the computed angle φ is decremented from 135° to 134°, . . . , 91°, and 90°. The difference (2θ−2φ) is decremented from −90° to −88°, . . . , −2°, and 0°. When the difference converges on 0°, the computed angle φ also becomes 90° and equals the initial value θ0=90° for the relative rotation angle θ. The computed angle φ correctly follows the relative rotation angle θ.

### Example 2

When the initial value θ0 for the relative rotation angle θ is 150° (FIG. 47B), the initial value for the difference (2θ−2φ) is calculated as (2θ0−2φ0) (2×150°−2×135°=30°. The calculation results in 2 sin(2θ0−2φ0)=1 and therefore sin(2θ0−2φ0)=0.5. An arcsine operation is performed to cause the difference (2θ0−2φ0) for the initial value to be 30°. Since the difference is 30°>0, the computed angle φ is incremented.

The computed angle φ is incremented by 1° from the initial value 135°. The difference (2θ−2φ) is decremented by 2φ(=2×1° each time the computed angle φ is incremented by 1°. That is, the computed angle φ is incremented from 135° to 136°, . . . , 149°, and 150°. The difference (2θ−2φ) is decremented from 30° to 28°, . . . , 2°, and 0°. When the difference converges on 0°, the computed angle φbecomes 150° and equals the initial value θ0=150° for the relative rotation angle θ. The computed angle φ correctly follows the relative rotation angle θ.

### Example 3

When the initial value θ0 for the relative rotation angle θ is 180° (FIG. 47C), the initial value for the difference (2θ−2φ) is calculated as (2θ0−2φ0)=(2×180°−2×135°=90°. The calculation results in 2 sin(2θ0−2φ0)=2 and therefore sin(2θ0−2φ0)=1. An arcsine operation is performed to cause the difference (2θ0−2φ0) for the initial value to be 90°. Since the difference is 90°>0, the computed angle φ is incremented.

The computed angle φ is incremented by 1° from the initial value 135°. The difference (2θ−2φ) is decremented by 2φ(=2×1°) each time the computed angle φ is incremented by 1°. That is, the computed angle φ is incremented from 135° to 136°, . . . , 179°, and 180°. The difference (2θ−2φ) is decremented from 90° to 88°, . . . , 2°, and 0°. When the difference converges on 0°, the computed angle φ becomes 180° and equals the initial value θ0=180° for the relative rotation angle θ. The computed angle φ correctly follows the relative rotation angle θ.

(Case of φ0=225°)

### Example 1

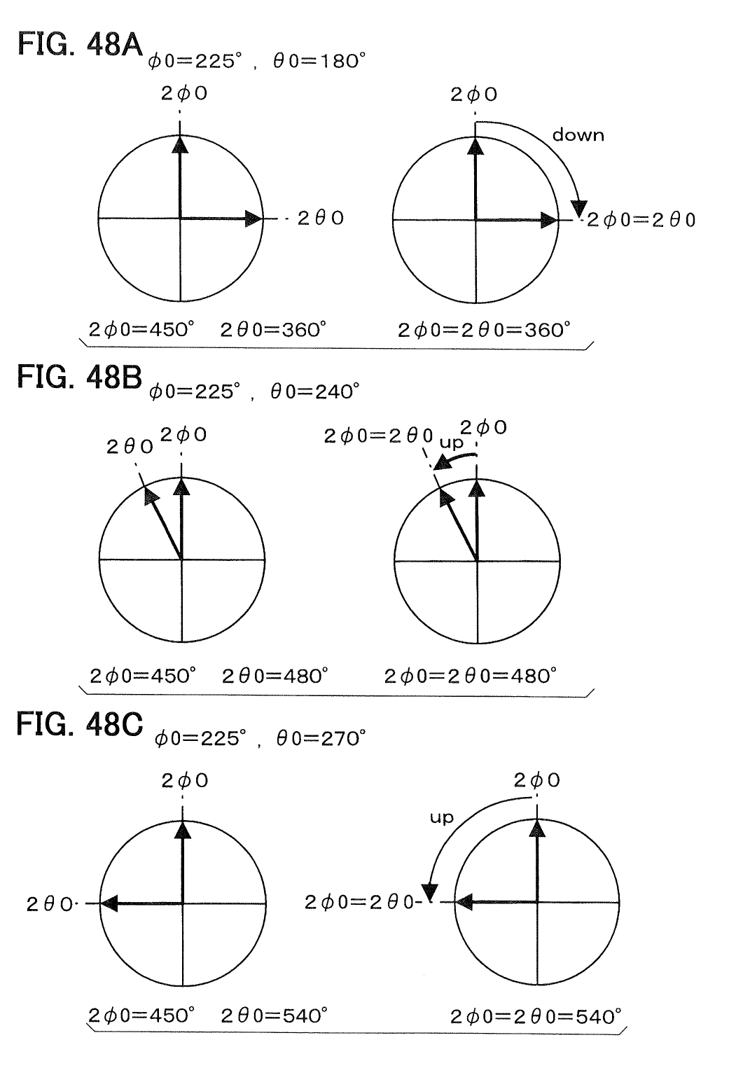

When the initial value θ0 for the relative rotation angle θ is 180° (FIG. 48A), the initial value for the difference (2θ−2φ) is calculated as (2θ0−2φ0)=(2×180°−2×225°=−90°. The calculation results in 2 sin(2θ0−2φ0)=−2 and therefore sin(2θ0−2φ0)=−1. An arcsine operation is performed to cause the difference (2θ0−2φ0) for the initial value to be −90°. Since the difference is −90 °<0, the computed angle φ is decremented.

The computed angle φ is decremented by 1° from the initial value 225°. The difference (2θ−2φ) is decremented by 2φ(=2×1°) each time the computed angle φ is decremented by 1°. That is, the computed angle φ is incremented from 225° to 224°, . . . , 181°, and 180°. The difference (2θ−2φ) is decremented from −90° to −88°, . . . , −2°, and 0°. When the difference converges on 0°, the computed angle φ also becomes 180° and equals the initial value θ0=180° for the relative rotation angle θ. The computed angle φ correctly follows the relative rotation angle θ.

### Example 2

When the initial value θ0 for the relative rotation angle θ is 240° (FIG. 48B), the initial value for the difference (2θ−2φ) is calculated as (2θ0−2φ0)=(2×240°−2×225°=30°. The calculation results in 2 sin(2θ0−2φ0)=1 and therefore sin(2θ0−2φ0)=0.5. An arcsine operation is performed to cause the difference (2θ0'2φ0) for the initial value to be 30°. Since the difference is 30°>0, the computed angle φ is incremented.

The computed angle φ is incremented by 1° from the initial value 225°. The difference (2θ−2φ) is decremented by 2φ(=2×1°) each time the computed angle φ is incremented by 1°. That is, the computed angle φ is incremented from 225° to 226°, . . . , 239°, and 240°. The difference (2θ−2φ) is decremented from 30° to 28°, . . . , 2°, and 0°. When the difference converges on 0°, the computed angle φ becomes 240° and equals the initial value θ0=240° for the relative rotation angle θ. The computed angle φ correctly follows the relative rotation angle θ.

### Example 3

When the initial value θ0 for the relative rotation angle θ is 270° (FIG. 48C), the initial value for the difference (2θ−2φ) is calculated as (2θ0−2φ0)=(2×270°−2×225°=90°. The calculation results in 2 sin(2θ0−2φ0)=2 and therefore sin(2θ0−2φ0)=1. An arcsine operation is performed to cause the difference (2θ0−2φ0) for the initial value to be 90°. Since the difference is 90°>0, the computed angle φ is incremented.

The computed angle φ is incremented by 1° from the initial value 225°. The difference (2θ−2φ) is decremented by 2φ(=2×1°) each time the computed angle φ is incremented by 1°. That is, the computed angle φ is incremented from 225° to 226°, . . . , 269°, and 270°. The difference (2θ−2φ) is decremented from 90° to 88°, . . . , 2°, and 0°. When the difference converges on 0°, the computed angle φ becomes 270° and equals the initial value θ0=270° for the relative rotation angle θ. The computed angle φ correctly follows the relative rotation angle θ.

(Case of φ0=315°)

### Example 1

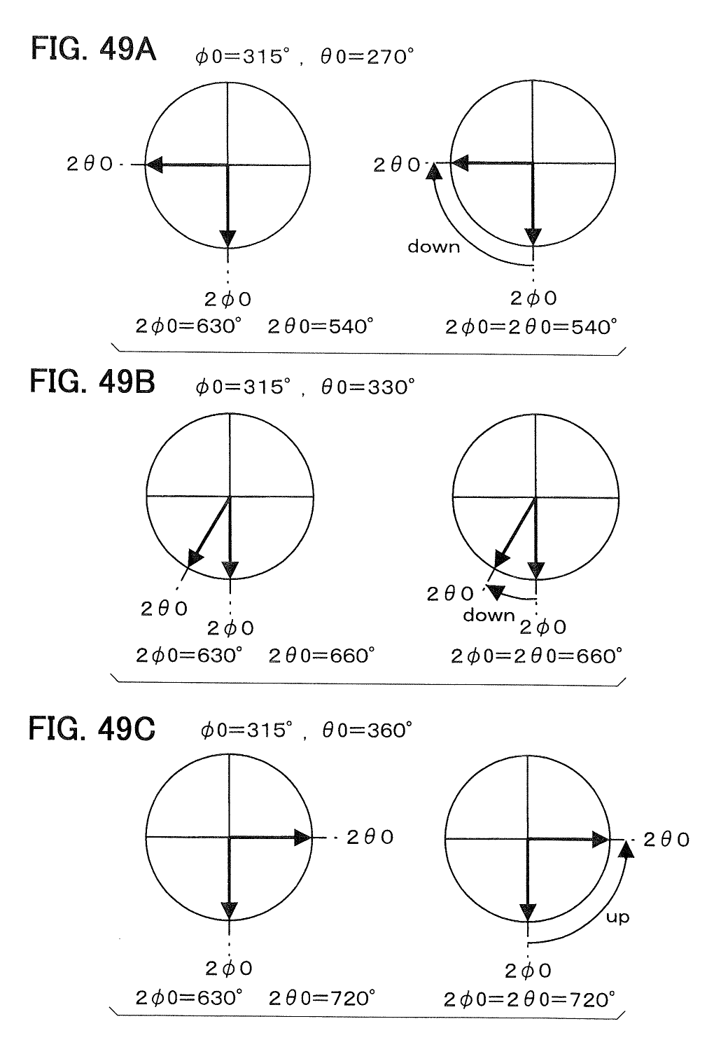

When the initial value θ0 for the relative rotation angle θ is 270° (FIG. 49A), the initial value for the difference (2θ−2φ) is calculated as (2θ0−2φ0)=(2×270°−2×315°)=−90°. The calculation results in 2 sin(2θ0−2φ0)=−2 and therefore sin(2θ0−2φ0)=−1. An arcsine operation is performed to cause the difference (2θ0−2φ0) for the initial value to be −90°. Since the difference is −90°<0, the computed angle φ is decremented.

The computed angle φ is decremented by 1° from the initial value 315°. The difference (2θ−2φ) is decremented by 2φ(=2×1°) each time the computed angle φ is decremented by 1°. That is, the computed angle φ is incremented from 315° to 314°, . . . , 271°, and 270°. The difference (2θ−2φ) is decremented from −90° to −88°, . . . , −2°, and 0°. When the difference converges on 0°, the computed angle φ also becomes 270° and equals the initial value θ0=270° for the relative rotation angle θ. The computed angle φ correctly follows the relative rotation angle θ.

### Example 2

When the initial value θ0 for the relative rotation angle θ is 330° (FIG. 49B), the initial value for the difference (2θ−2φ) is calculated as (2θ0−2φ0)=(2×330°−2×315°)=30°. The calculation results in 2 sin(2θ0−2φ0)=1 and therefore sin(2θ0−2φ0)=0.5. An arcsine operation is performed to cause the difference (2θ0−2φ0) for the initial value to be 30°. Since the difference is 30°>0, the computed angle φ is incremented.

The computed angle φ is incremented by 1° from the initial value 315°. The difference (2θ−2φ) is decremented by 2φ(=2×1°) each time the computed angle φ is incremented by 1°. That is, the computed angle φ is incremented from 315° to 316°, . . . , 329°, and 330°. The difference (20-4) is decremented from 30° to 28°, . . . , 2°, and 0°. When the difference converges on 0°, the computed angle φ becomes 240° and equals the initial value θ0=240° for the relative rotation angle θ. The computed angle φ correctly follows the relative rotation angle θ.

### Example 3

When the initial value θ0 for the relative rotation angle θ is 360° (FIG. 49C), the initial value for the difference (2θ−2φ) is calculated as (2θ0−2φ0)=(2×360°−2×315°)=90°. The calculation results in 2 sin(2θ0−2φ0)=2 and therefore sin(2θ0−2φ0)=1. An arcsine operation is performed to cause the difference (2θ0−2φ0) for the initial value to be 90°. Since the difference is 90°>0, the computed angle φ is incremented.

The computed angle φ is incremented by 1° from the initial value 315°. The difference (2θ−2φ) is decremented by 2φ(=)2×1° each time the computed angle φ is incremented by 1°. That is, the computed angle φ is incremented from 315° to 316°, . . . , 359°, and 360°. The difference (2θ−2φ) is decremented from 90° to 88°, . . . , 2°, and 0°. When the difference converges on 0°, the computed angle φ becomes 360° and equals the initial value 00=360° for the relative rotation angle θ. The computed angle φ correctly follows the relative rotation angle θ.

(Effects of the Thirteenth Embodiment)

(1) As mentioned above, the rotation sensor 1 according to the embodiment can allow the computed angle φ to accurately follow the relative rotation angle θ when the condition of |θ0−φ0|<90° is satisfied between the initial value θ0 for the relative rotation angle θ and the initial value φ0 for the computed angle φ. Before the permanent magnet 2 starts relative rotation, the initial value φ0 for the computed angle φ follows the initial value θ0 for the relative rotation angle θ and becomes equal to it. While the permanent magnet 2 is rotating, the computed angle φ can accurately follow the relative rotation angle θ.

Before the permanent magnet 2 starts relative rotation, it just needs to determine which quadrant covers the initial value θ0 for the relative rotation angle θ. It is unnecessary to determine the quadrant during the relative rotation.

It is possible to not only shorten the time to compute the relative rotation angle θ during relative rotation of the permanent magnet 2, but also reduce a processing load and power consumption of the detection circuit 50.

(2) Output signals from the Hall elements H1 and H2 are only used to determine which angular range covers the initial value θ0 for the relative rotation angle θ. There is no need for correspondence between each of output phases from the Hall elements H1 and H2 and each of those from the AMR sensors M1 and M2. Therefore, it is unnecessary to increase the accuracy of relative positions of the Hall elements H1 and H2 and the AMR sensors M1 and M2. The production yield of the rotation sensor 1 can be boosted.

(3) The Hall elements H1 and H2 are positioned so as to cause a phase difference of 90° between detection signals. It is possible to change a combination of signal levels from the Hall elements each time the relative rotation angle θ changes 90°.

Using a combination of signal levels for detection signals, the initial value determination section 253 can determine an angular range in units of 90° to which the initial value θ0 for the relative rotation angle θ belongs.

(4) The AMR sensors M1 and M2 are positioned so as to cause a phase difference of 45° between signals. Accordingly, one of the AMR sensors can output a sine-wave (sin) signal. The other AMR sensor can output a cosine-wave (cos) signal whose phase occurs 45° later than the sine-wave signal.

The sine-wave signal and the cosine-wave signal can be used to compute a relative rotation angle.

(5) The first to fourth quadrants correspond to different combinations of results of comparison between each of signal levels for detection signals from the Hall elements H1 and H2 and a threshold value. The initial value determination section 253 can highly accurately determine the quadrant.

(6) A sin 2θ signal and a cos 2θ signal output from the AMR sensors M1 and M2 are used to compute the relative rotation angle θ under such feedback control that the difference (2θ−2φ) becomes 0. The relative rotation angle θ can be highly accurately computed.

(7) The difference (2θ−2φ) can be computed using the sin 2θ signal and the cos 2θ signal output from the AMR sensors M1 and M2, the sin 2φsignal and the cos 2φ signal, the circuit for multiplying the signals, and the circuit for subtracting the signals.

(8) The Hall elements H1 and H2 and the AMR sensors M1 and M2 can be embedded in the silicon substrate 10. The rotation sensor 1 can be miniaturized.

(Margin for the Initial Value θ0 Corresponding to the Initial Value φ0)

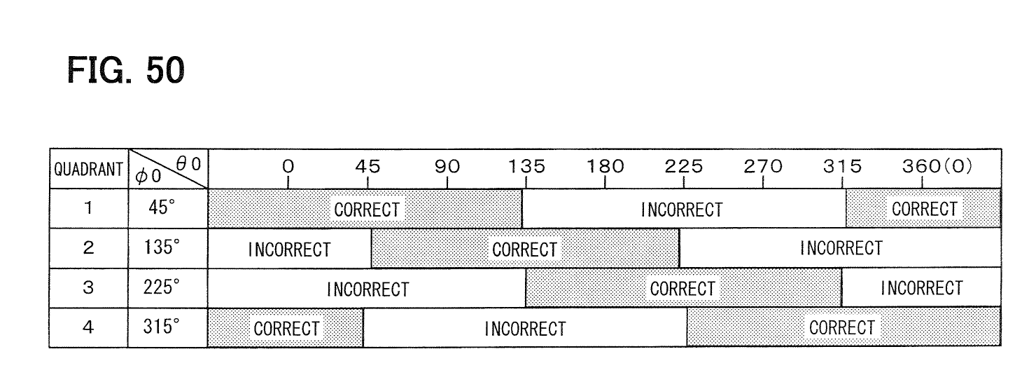

With reference to the drawings, the following describes a margin for the initial value θ0 of the relative rotation angle θ corresponding to the initial value φ0 of the computed angle φ. FIG. 50 shows a margin for the initial value θ0 corresponding to the initial value φ0.

The computed angle φ can correctly follow the relative rotation angle θ when the condition of |θ0−φ0|<90° is satisfied between the initial value φ0 of the computed angle φ and the initial value θ0 of the relative rotation angle θ. The initial value φ0 can accurately follow the initial value θ0 in a range of initial values θ0 depicted as “correct” in FIG. 50. The initial value φ0 cannot accurately follow the initial value θ0 in a range of initial values θ0 depicted as “incorrect.” As shown in FIG. 50, the range of initial values 00 that can be followed by each initial value φ0 is wider than the quadrant (see FIG. 41) corresponding to each initial value φ0. The following describes ranges of initial values θ0 the corresponding initial values φ0 can follow.

(Case of Initial Value φ0=45°)

When the initial value φ0 is 45°, an available initial values θ0 is (45°−90°) <θ0<(45°+90°), i.e., −45°<θ0<135°. With reference to φ0=0°(360°), the range is equivalent to 0°≦θ0<135° and 315°<θ0≦360°.

For example, let us suppose that the initial value φ0 of 45° is selected for the initial value θ0 of 134°. The initial value for the difference (2θ−2φ) is found as (2θ0−2φ0)=(2×134°−2×45°)=178°. The calculation results in 2 sin(2θ0−2φ0)≦0.07 and therefore sin(2θ0−2φ0)≦0.035. An arcsine operation is performed to cause the difference for the initial value to be (2θ0−2φ0)≦2°. Since the difference is 2°>0, the computed angle φ is incremented.

The computed angle φ is incremented by 1° from the initial value 45°. The difference (2θ−2φ) is decremented by 2φ(=2×1°) each time the computed angle φ is incremented by 1°. That is, the computed angle φ is incremented from 45° to 46°, . . . , 133°, and 134°. The difference (2θ−2φ) is decremented from 178° to 176°, . . . , 2°, and 0°. When the difference converges on 0°, the computed angle φ becomes 134° and equals the initial value θ0=134° for the relative rotation angle θ. The computed angle φ correctly follows the relative rotation angle θ.

The initial value θ0 for the relative rotation angle θ may be outside the first quadrant (0°≦θ0<90°) corresponding to the initial value φ0=45° for the computed angle φ. Even in such a case, the computed angle φ can accurately follow the relative rotation angle θ when the condition of |θ0−φ0|<90° is satisfied.

(Case of Initial Value (00=135°)

When the initial value φ0 is 135°, an available initial values θ0 is (135°−90°)<θ0<(135°+90°), i.e., 45°<θ0<225°.

For example, let us suppose that the initial value φ0 of 135° is selected for the initial value θ0 of 90°. The initial value for the difference (2θ−2φ) is found as (2θ0−2φ0)=(2×90°−2×135°)=−90°. The calculation results in 2 sin(2θ0−2φ0)=−2 and therefore sin(2θ0−2φ0)=−1. An arcsine operation is performed to cause the difference for the initial value to be (200-20)=−90°. Since the difference is −90°<0, the computed angle φ is decremented.

The computed angle φ is decremented by 1° from the initial value 135°. The difference (2θ−2φ) is decremented by 2φ(=2×1°) each time the computed angle φ is decremented by 1°. That is, the computed angle φ is decremented from 135° to 134°, . . . , 91°, and 90°. The difference (2θ−2φ) is decremented from −90° to −88°, . . . , −2°, and 0°. When the difference converges on 0°, the computed angle φ becomes 90° and equals the initial value θ0=90° for the relative rotation angle θ. The computed angle φ correctly follows the relative rotation angle θ.

(Case of Initial Value φ0=225°)

When the initial value φ0 is 225°, an available initial values θ0 is (225°−90°)<θ0<(225°+90°), i.e., 135°<θ0<315°.

For example, let us suppose that the initial value φ0 of 225° is selected for the initial value 00 of 150°. The initial value for the difference (2θ−2φ) is found as (2θ0−2φ0)=(2×150°−2×225°)=−150°. The calculation results in 2 sin(2θ0−2φ0)=−1 and therefore sin(2θ0−2φ0)=−0.5. An arcsine operation is performed to cause the difference for the initial value to be (2θ0−2φ0)=−150°. Since the difference is −150°<0, the computed angle φ is decremented.

The computed angle φ is decremented by 1° from the initial value 225°. The difference (2θ−2φ) is decremented by 2φ(=2×1°) each time the computed angle φ is decremented by 1°. That is, the computed angle φ is decremented from 225° to 224°, . . . , 151°, and 150°. The difference (2θ−2φ) is decremented from −150° to −148°, . . . , −2°, and 0°. When the difference converges on 0°, the computed angle φ becomes 150° and equals the initial value θ0=150° for the relative rotation angle θ. The computed angle φ correctly follows the relative rotation angle θ.

(Case of Initial Value (1)0=315°)

When the initial value φ0 is 315°, an available initial values θ0 is (315°−90°)<80<(315°+90°), i.e., 225°<θ0<405°. With reference to φ0=0° (360°), the range covers 0°≦θ0<45° and 225°<θ0≦360°.

For example, let us suppose that the initial value φ0 of 315° is selected for the initial value θ0 of 270°. The initial value for the difference (2θ−2φ) is found as (2θ0−2φ0)=(2×270°−2×315°)=−90°. The calculation results in 2 sin(2θ0−2φ0)=−2 and therefore sin(2θ0−2φ0)=−1. An arcsine operation is performed to cause the difference for the initial value to be (2θ0−2φ0)=−90°. Since the difference is −90°<0, the computed angle φ is decremented.

The computed angle φ is decremented by 1° from the initial value 315°. The difference (2θ−2φ) is decremented by 2φ(=2×1°) each time the computed angle φ is decremented by 1°. That is, the computed angle φ is decremented from 315° to 314°, . . . , 271°, and 270°. The difference (2θ−2φ) is decremented from −90° to −88°, . . . , −2°, and 0°. When the difference converges on 0°, the computed angle φ becomes 270° and equals the initial value θ0=270° for the relative rotation angle θ. The computed angle φ correctly follows the relative rotation angle θ.

As mentioned above, the rotation sensor 1 according to the embodiment can allow the computed angle φ to accurately follow the relative rotation angle θ when the condition of |θ0−φ0|<90° is satisfied between the initial value θ0 for the relative rotation angle θ and the initial value φ0 for the computed angle φ even though the initial value θ0 selected from the initial value table 53d is outside the quadrant corresponding to the initial value φ0.

When the initial value φ0 of 45° is selected, for example, the initial value θ0 is actually 45° but may be inadvertently detected as 90°. In such a case, the initial value φ0 set to 45° also coverts the initial value θ0 set to 90° and the computed angle φ can accurately follow the relative rotation angle θ.

In FIG. 50, the initial value θ0 set to 90° corresponds to the initial values φ0 set to 45° and 135°. When the initial value θ0 is 90°, for example, the initial value φ0 may be inadvertently selected as 45° that was intended to be 135°. In such a case, the computed angle φ can accurately follow the relative rotation angle θ.

The computed angle φ can accurately follow the relative rotation angle θ even when the initial value θ0 or the initial value φ0 changes due to external noise or external magnetic field. It is possible to provide the rotation sensor that hardly degrades the detection accuracy even under the influence of external noise or external magnetic field.

### Modification Example

According to a possible configuration, the initial value φ0 for the computed angle φ can be determined before relative rotation of the permanent magnet 2 and at a predetermined time after the relative rotation starts. The configuration can determine a new initial value θ0 and compute the relative rotation angle θ using the determined initial value φ0 even when the computed angle φ deviates from a follow-up route for the relative rotation angle θ during relative rotation of the permanent magnet 2 and the computed angle φ causes an error. The original accurate follow-up route can be resumed to correct an error in the computed angle φ.

### Fourteenth Embodiment

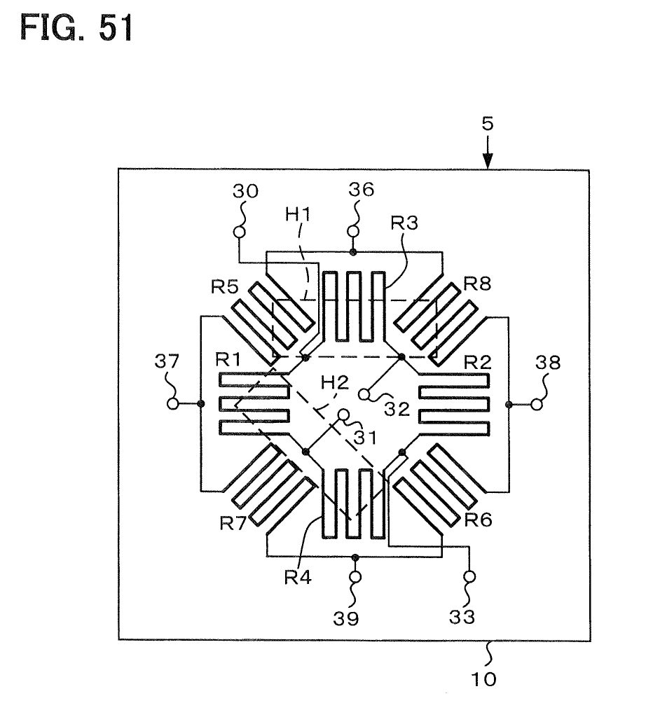

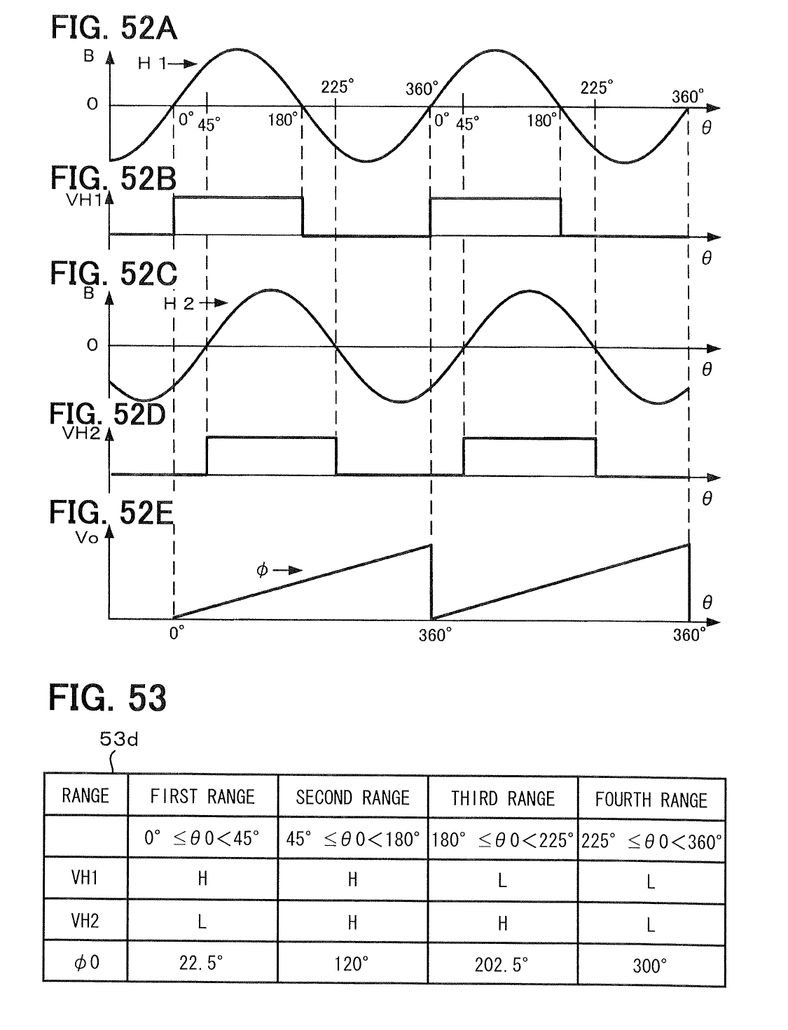

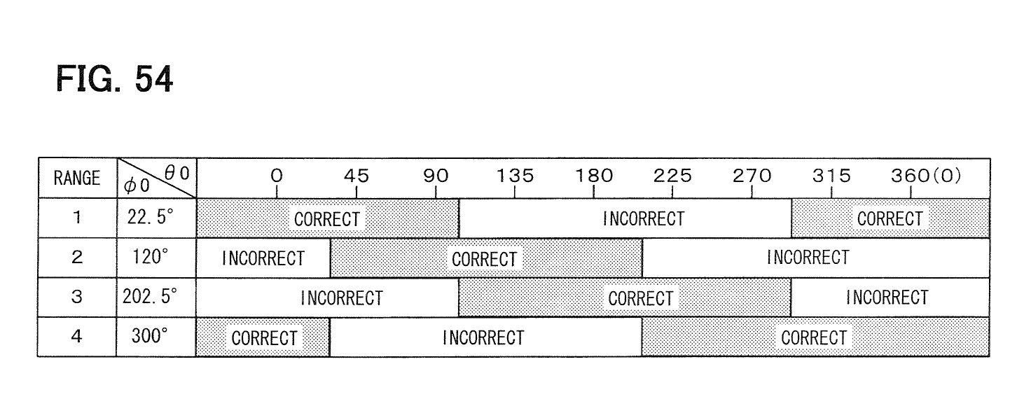

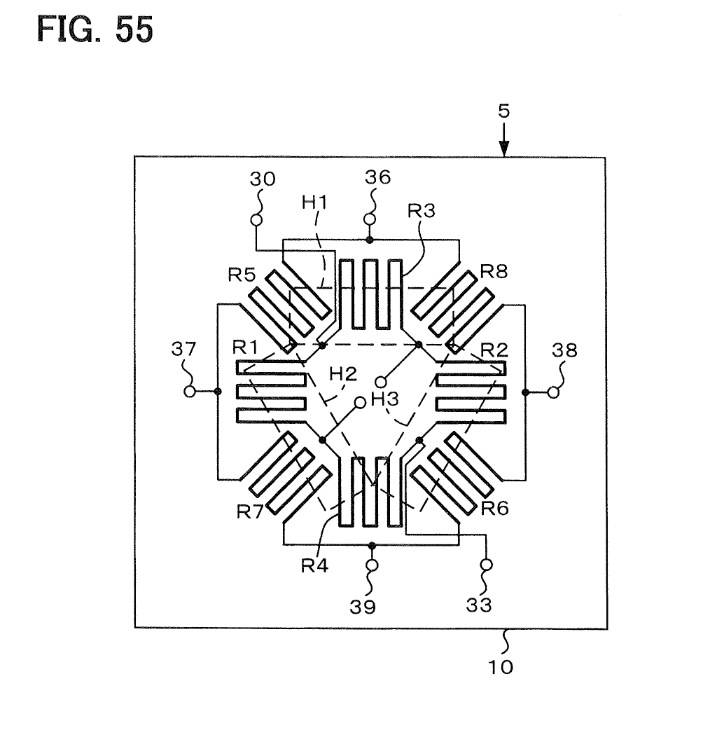

The fourteenth embodiment of the invention will be described. FIG. 51 schematically shows a structure of a sensor chip provided for a rotation sensor according to this embodiment. FIGS. 52A through 52E show output signals from the AMR sensors M1 and M2 and the Hall elements H1 and H2. FIG. 53 shows a configuration of the initial value table 53d. FIG. 54 shows a margin for the initial value θ0 corresponding to the initial value φ0.

The rotation sensor according to the embodiment uses a phase difference of 45° between output signals from the Hall elements H1 and H2. As shown in FIG. 51, the Hall elements H1 and H2 are positioned so as to form an angle of 45° between magnetism detection planes (Hall plate planes). As shown in FIGS. 52A through 52E, there is a phase difference of 45° between output signals from the Hall elements H1 and H2. In this example, the output signal from the Hall element H2 changes from the low level (L) to the high level (H) 45° later than the timing when the output signal from the Hall element H1 changes from the low level (L) to the high level (H).

As shown in FIG. 53, initial values θ0 ranging from 0° to 360° for the relative rotation angle θ can be divided into four ranges from the first to the fourth based on the levels of output signals from the Hall elements H1 and H2 shown in FIGS. 52A through 52E. As seen from FIG. 53, the first range covers 0°≦θ0<45°. The second range covers 45°≦θ0<180°. The third range covers 180°≦θ0<225°. The fourth range covers 225°≦θ0<360°. The initial value φ0 for the computed angle φ is set to a median value of each range in the initial value table 53d. The initial value φ0 for the first range is set to 22.5°. The initial value φ0 for the second range is set to 120°. The initial value φ0 for the third range is set to 202.5°. The initial value φ0 for the fourth range is set to 300°.

For example, let us suppose that the signal level VH1 of the Hall element

H1 is set to the high level (H) and the signal level VH2 of the Hall element H2 is set to the low level (L). In this case, the initial value φ0 of 22.5° is selected from the initial value table 53d.

As shown in FIG. 54, the available range of initial values θ0 the initial value φ0 can follow accurately is wide enough to exceed the first to fourth ranges. While the initial values φ0 differ from those for the first embodiment, it is possible to determine the range of initial values θ0 the initial value φ0 can follow accurately so that the condition of |θ0−φ0|<90° is satisfied similarly to the first embodiment.

The range of initial values θ0 the initial value φ0 of 22.5° can follow covers (22.5°−90°)<θ0<(22.5°+90°), i.e., −67.5°<0θ<112.5°. With reference to φ0=0°(360°), the range covers 0°≦θ0<112.5° and 292.5°<θ0<360°.

The range of initial values θ0 the initial value φ0 of 120° can follow covers (120°−90°)<θ0<(120°+90°), i.e., 30°<θ0<210°. The range of initial values θ0 the initial value φ0 of 202.5° can follow covers (202.5°−90°)<θ0<(202.5°+90°), i.e., 112.5°<θ0<292.5°. The range of initial values θ0 the initial value φ0 of 300° can follow covers (300°−90°)<θ0<(300°+90°), i.e., 210°<θ0<390°. With reference to φ0=0° (360°), the range covers 0°≦θ0<30° and 210°<θ0≦360°.

As mentioned above, the rotation sensor according to the fourteenth embodiment is configured equally to the rotation sensor according to the first embodiment except the phase difference of 45° between output signals from the Hall elements H1 and H2. The rotation sensor according to the fourteenth embodiment can provide the same effect as the rotation sensor according to the thirteenth embodiment.

### Fifteenth Embodiment

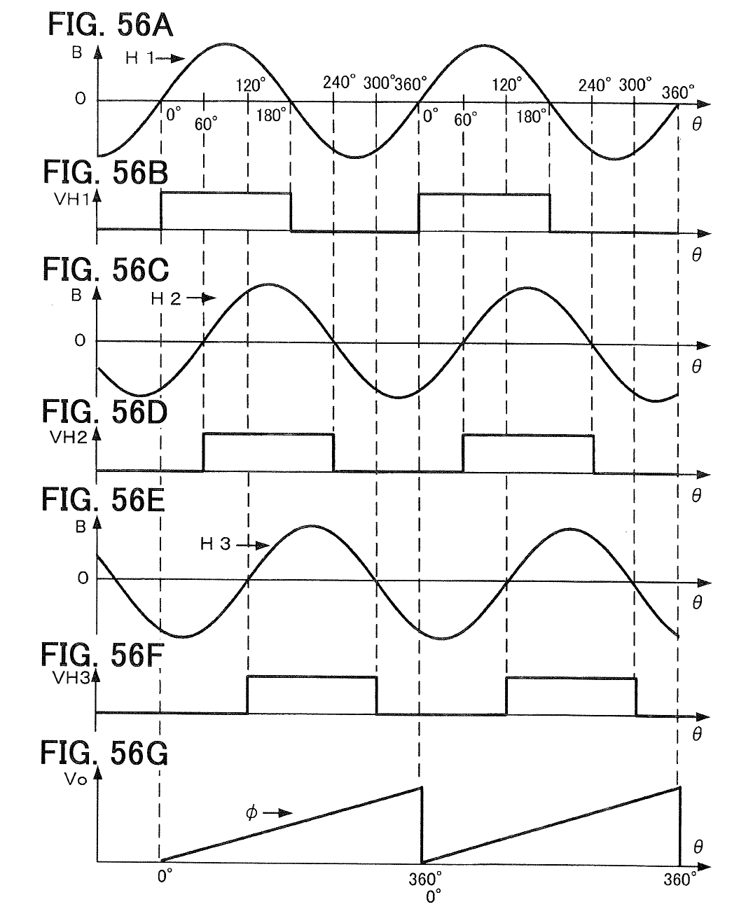

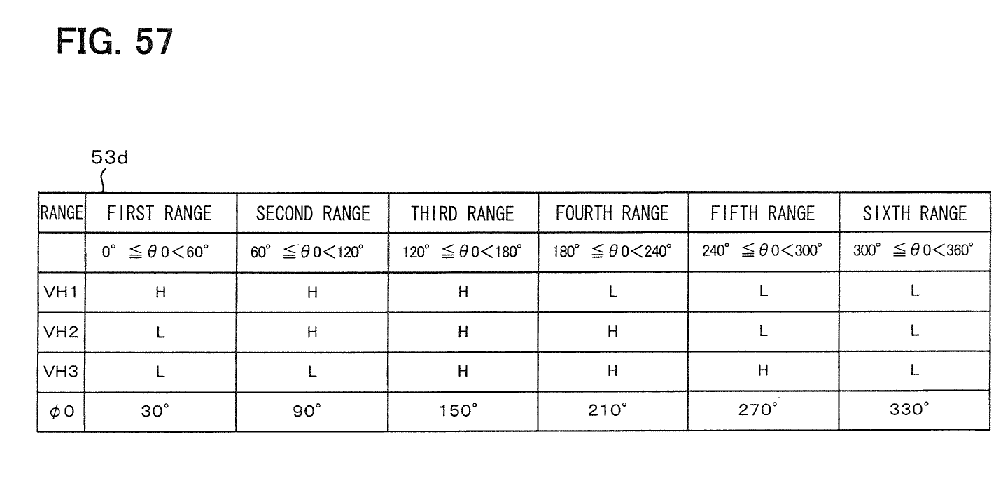

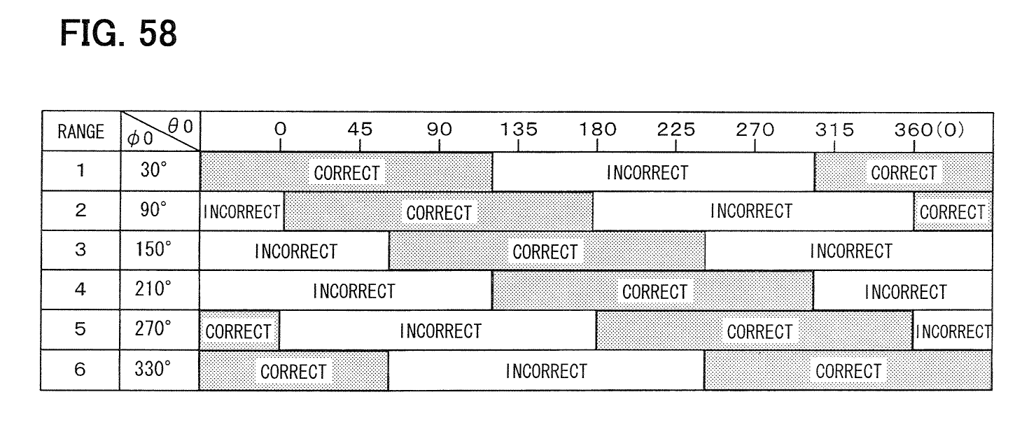

The fifteenth embodiment of the invention will be described. FIG. 55 schematically shows a structure of a sensor chip provided for a rotation sensor according to this embodiment. FIGS. 56A through 56G show output signals from the AMR sensors M1 and M2 and the Hall elements H1 through H3. FIG. 57 shows a configuration of the initial value table 53d. FIG. 58 shows a margin for the initial value θ0 corresponding to the initial value φ0.

The rotation sensor according to the embodiment includes three Hall elements H1, H2, and H3 and uses a phase difference of 60° between output signals from the Hall elements. As shown in FIG. 55, the Hall elements H1, H2, and H3 are positioned so that the adjacent magnetism detection planes (Hall plate planes) form an angle of 60°. As shown in FIGS. 56A through 56G, a phase difference of 60° exists between output signals from the Hall elements H1, H2, and H3. In this example, the output signal from the Hall element H2 changes from the low level (L) to the high level (H) 60° later than the timing when the Hall element H1 changes from the low level (L) to the high level (H). The output signal from the Hall element H3 changes from the low level (L) to the high level (H) 60° later than the timing when the output signal from the Hall element H2 changes from the low level (L) to the high level (H).

As shown in FIG. 57, initial values θ0 ranging from 0° to 360° for the relative rotation angle θ can be divided into six ranges from the first to the sixth in units of 60° based on levels of output signals from the Hall elements H1, H2, and H3 shown in FIGS. 56A through 56G. The initial value φ0 for the computed angle φis set to a median value of each range in the initial value table 53d.

For example, let us suppose that the signal level VH1 of the Hall element H1 is set to the high level (H), the signal level VH2 of the Hall element H2 is set to the low level (L), and the signal level VH3 of the Hall element H3 is set to the low level (L). In this case, the initial value φ0 of 30° is selected from the initial value table 53d.

As shown in FIG. 58, the available range of initial values θ0 the initial value φ0 can follow accurately is wide enough to exceed the first to sixth ranges. While the initial values φ0 differ from those for the thirteenth embodiment, it is possible to determine the range of initial values θ0 the initial value φ0 can follow accurately so that the condition of |θ0−φ0|<90° is satisfied similarly to the first embodiment.

The range of initial values θ0 the initial value φ0 of 30° can follow covers (30°−90°)<θ0<(30°+90°), i.e., −60°<θ0<120°. With reference to φ0=0° (360°), the range covers 0°≦θ0<120° and 300°<θ0≦360°.

The range of initial values θ0 the initial value φ0 of 90° can follow covers (90°−90°<80<)(90°+90°), i.e., 0°<θ0<180°. The range of initial values θ0 the initial value φ0 of 150° can follow covers (150°−90°)<θ0<(150°+90°), i.e., 60°<θ0<240°. The range of initial values θ0 the initial value φ0 of 210° can follow covers (210°−90°)<θ0<(210°+90°), i.e., 120°<θ0<300°. The range of initial values θ0 the initial value φ0 of 270° can follow covers (270°-90°)<θ0<(270°+90°), i.e., 180°<θ0<360°. The range of initial values θ0 the initial value φ0 of 330° can follow covers (330°-90°)<θ0<(330°+90°, i.e., 240°<θ0<420°. With reference to φ0=0° (360°), the range covers 0°≦θ0<60° and <θ0≦360°.

As mentioned above, the rotation sensor according to the fifteenth embodiment is configured equally to the rotation sensor according to the thirteenth embodiment except the phase difference of 60° between output signals from the Hall elements H1, H2, and H3. The rotation sensor according to the fifteenth embodiment can provide the same effect as the rotation sensor according to the thirteenth embodiment. The rotation sensor according to the fifteenth embodiment supports six angular ranges from the first to the sixth, two more angular ranges than four in the first embodiment. It is possible to narrow the angular range containing the initial value θ0 and therefore shorten the time for the computed angle φ to follow the initial value θ0 and converge on it.

### Sixteenth Embodiment

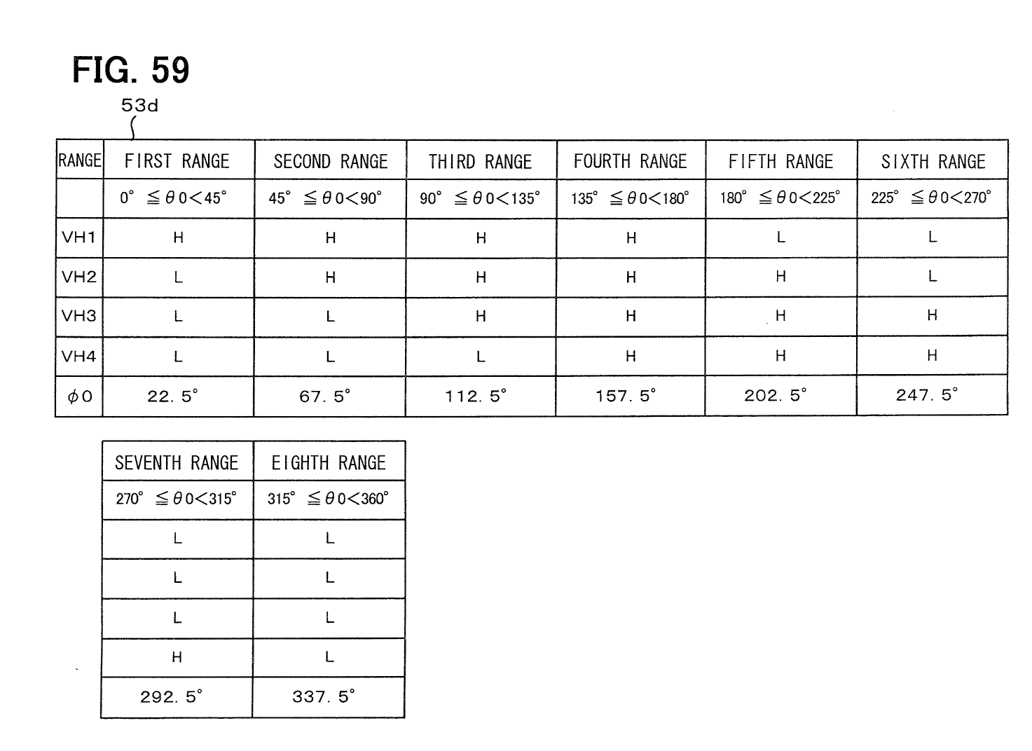

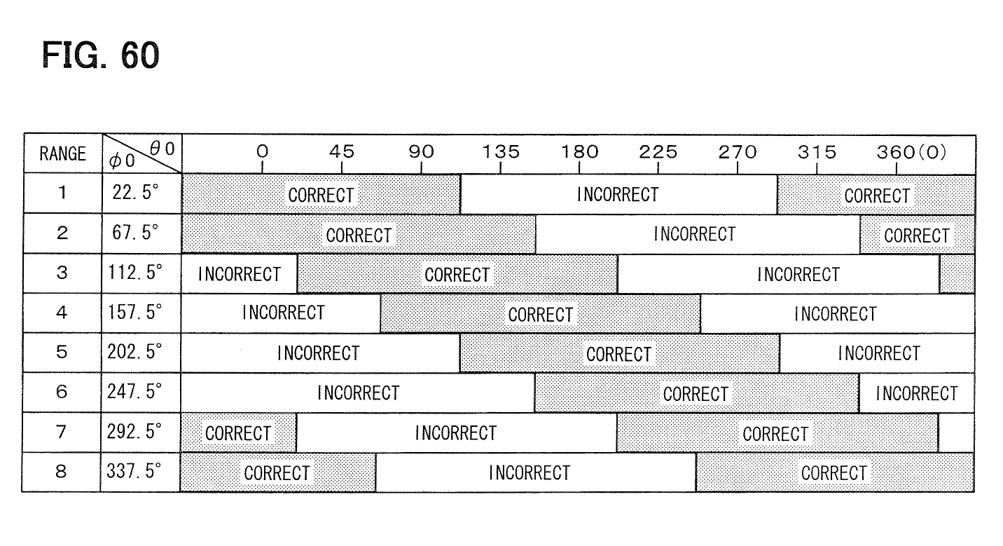

The sixteenth embodiment of the invention will be described. FIG. 59 shows a configuration of the initial value table 53d. FIG. 60 shows a margin for the initial value θ0 corresponding to the initial value φ0.

The rotation sensor according to the embodiment includes four Hall elements H1 through H4 and uses a phase difference of 45° between output signals from the Hall elements. The Hall elements H1 through H4 are positioned so that the adjacent magnetism detection planes (Hall plate planes) form an angle of 45°. A phase difference of 45° exists between output signals from the Hall elements H1 through H4. In this example, the Hall elements from H1 to H4 in order cause a delay of 45° in the timing to change an output signal from the low level (L) to the high level (H).

As shown in FIG. 59, initial values θ0 ranging from 0° to 360° for the relative rotation angle θ can be divided into eight ranges from the first to the eighth in units of 45° based on levels of output signals from the Hall elements H1 through H4. The initial value φ0 for the computed angle φ is set to a median value of each range in the initial value table 53d.

For example, let us suppose that the signal levels VH1 through VH4 of the Hall element H1 through H4 are set to the high level (H), the low level (L), the low level (L), and the low level (L), respectively. In this case, the initial value φ0 of 22.5° is selected from the initial value table 53d.

As shown in FIG. 60, the available range of initial values θ0 the initial value φ0 can follow accurately is wide enough to exceed the first to eighth ranges. While the initial values φ0 differ from those for the first embodiment, it is possible to determine the range of initial values θ0 the initial value φ0 can follow accurately so that the condition of |θ0−φ0|<90° is satisfied similarly to the first embodiment.

The range of initial values θ0 the initial value φ0 of 22.5° can follow covers (22.5°−90°)<θ0<(22.5°+90°), i.e., −67.5°<θ0<112.5°. With reference to φ0=0° (360°), the range covers 0°θ0<112.5° and 292.5°<θ0≦360°.

The range of initial values θ0 the initial value φ0 of 67.5° can follow covers (67.5°−90°)<80<(67.5°+90°), i.e., −22.5°<θ0<157.5°. With reference to φ0=0° (360°), the range covers 0°≦θ0<157.5° and 337.5°<θ0≦360°. The range of initial values θ0 the initial value φ0 of 112.5° can follow covers (112.5°−90°)<θ0<(112.5°+90°), i.e., 22.5°<θ0<202.5°. The range of initial values θ0 the initial value φ0 of 157.5° can follow covers (157.5°−90°)<θ0<(157.5°+90°), i.e., 67.5°<θ0<247.5°.

The range of initial values θ0 the initial value φ0 of 202.5° can follow covers (202.5°−90°)<θ0<(202.5°+90°), i.e., 112.5°<θ0<292.5°. The range of initial values θ0 the initial value φ0 of 247.5° can follow covers (247.5°−90°)<θ0<(247.5°+90°), i.e., 157.5°<θ0<337.5°. The range of initial values θ0 the initial value φ0 of 292.5° can follow covers (292.5°−90°)<θ0<)(292.5°+90°, i.e., 202.5°<θ0<382.5°. With reference to φ0=0° (360°), the range covers 0°≦θ0<22.5° and 202.5°<θ0<360°. The range of initial values θ0 the initial value φ0 of 337.5° can follow covers (337.5°−90°)<θ0<(337.5°+90°, i.e., 247.5°<θ0<427.5°. With reference to φ0=0° (360°), the range covers 0° θ0<67.5° and 247.5°<θ0≦360°.

As mentioned above, the rotation sensor according to the sixteenth embodiment is configured equally to the rotation sensor according to the thirteenth embodiment except the phase difference of 45° between output signals from the Hall elements H1 through H4. The rotation sensor according to the sixteenth embodiment can provide the same effect as the rotation sensor according to the thirteenth embodiment. The rotation sensor according to the sixteenth embodiment supports eight angular ranges from the first to the eighth, two more angular ranges than six in the fifteenth embodiment. It is possible to further narrow the angular range containing the initial value θ0 and therefore further shorten the time for the computed angle φ to follow the initial value θ0 and converge on it.

### Other Examples

(1) A phase difference other than 90°, 60°, and 45° may be used between output signals from the Hall elements H1 and H2. The computed angle φ can accurately follow the relative rotation angle θ when a phase difference between output signals from the Hall elements H1 and H2 exceeds 0°. The degree of freedom for Hall element layout positions can be increased because of a wide range of available angles between magnetism detection planes of the Hall elements.

(2) An element other than Hall elements can be used if the element allows an output signal level to change at one cycle while the permanent magnet 2 rotates one turn, i.e., the relative rotation angle θ changes at one cycle. For example, it is possible to use magnetism detection elements such as GMR (Giant Magneto-Resistive effect) elements and TMR (Tunnel Magneto-Resistive effect) elements or switches such as coils.

(3) An element other than AMR sensors can be used if the element allows an output signal level to change at two cycles while the permanent magnet 2 rotates one turn, i.e., the relative rotation angle θchanges at one cycle.

(4) It is possible to provide a correction section that corrects an amplitude difference, an offset, and an initial phase error between the sin 2θ signal and the cos 2θ signal output from the amplification section 51. The rotation sensor according to this configuration can further improve the accuracy of detecting the relative rotation angle θ.

(5) It is possible to provide a correction section that corrects an amplitude difference, an offset, and an initial phase error between the sine signal and the cos θ signal output from the amplification section 52. The rotation sensor according to this configuration can further improve the accuracy of detecting the relative rotation angle θ.

(6) The angle computing section 60, the initial value determination section 253, and the output section 70 can be embodied using not only hardware such as a discrete circuit but also microcomputer-based software.

(7) Pulses output from the Hall element H1 or H2 can be counted to detect multiple rotations (360° or more).

(8) The initial value determination section 253 may be replaced by the output section 70.

(9) A computed angle can be output as a digital value instead of converting it into an analog signal in the output section 70.

(10) The detection circuit 50 may be formed on the silicon substrate 10 to integrate the detection circuit 50 with the sensor chip 5.

(11) The silicon substrate 10 can be replaced by a substrate made of compound semiconductor materials such as GaAs, InAs, and InSb.

(12) The permanent magnet can be replaced by a member coated with magnetic ink. It is also possible to use a conductive member whose surface is magnetized.

(13) The vertical Hall element can be replaced by a horizontal Hall element. The horizontal Hall element can overlap with the magneto-resistance element region so that the magnetism detection section is perpendicular to the magneto-resistance element.

The rotation sensor 1 according to the present invention is available to anything that causes relative rotation. For example, the rotation sensor 1 is applicable to: a crank angle sensor that detects crank angles of a crank shaft provided for an internal-combustion engine; a cam angle sensor that detects cam angles of a cam shaft; and a steering angle sensor that detects steering angles of a steering apparatus provided for a vehicle. The rotation sensor 1 is also applicable to a sensor that detects angles of joints used for a robot.

### Seventeenth Embodiment

The seventeenth embodiment is configured similarly to the thirteenth embodiment as shown in FIGS. 31 through 50 but differs from the thirteenth embodiment in the following.

(Amplification Section 51 and Angle Computing Section 60)

According to the embodiment, the AMR sensors M1 and M2 are equivalent to magneto-electric conversion elements and are placed in a magnetic field of the relatively rotating permanent magnet (magnetism generator) 2. While the permanent magnet 2 rotates one turn, the AMR sensors M1 and M2 output a sin Nθ signal and a cos Nθ signal in accordance with the magnetic field intensity, where θ denotes a relative rotation angle against the permanent magnet 2 and N denotes a natural number. Examples of the embodiment use N=2 because the AMR sensors M1 and M2 output a sin 2θ signal and a cos 2θ signal whose signal levels change at two cycles in accordance with the magnetic field intensity while the permanent magnet 2 rotates one turn.

The amplification section 51 includes the differential amplifier circuits 51a and 51b. The differential amplifier circuit 51a differentially amplifies an output signal sin 2θ (first signal) from the AMR sensor M1. The differential amplifier circuit 51b differentially amplifies an output signal cos 2θ (second signal) from the AMR sensor M2. The angle computing section 60 functions as a tracking loop type digital angle converter. The angle computing section 60 includes the signal generation section 61, the difference calculation section 62, the positive/negative determination section 63, and the up-down counter (U/D counter) 64.

The angle computing section 60 computes the relative rotation angle 8 using signals (sin 2θ signal and cos 2θ signal) output from the AMR sensor M1 and M2. In this case, the angle computing section 60 performs feedback control so that a difference between the relative rotation angle θ for the permanent magnet 2 and the computed angle φ converges on a specified value. The angle computing section 60 uses the initial value φ0 settled by the initial value determination section 253 as the initial value φ0 for the computed angle φ to start computing the relative rotation angle θ.

The angle computing section 60 generates an A sin(2θ+α) signal and an A sin(2θ−α) signal that originate from the sin 2θ signal and the cos 2θ signal output from the AMR sensors M1 and M2 and are each modified by a predetermined shift amount α. The angle computing section 60 corrects the A sin(2θ+α) signal and the A sin(2θ−α) signal using a correction value corresponding to the shift amount α to generate a sin(2θ−2φ) signal. The angle computing section 60 computes the relative rotation angle θ by carrying out feedback control so that the difference (2θ−2φ) based on the sin(2θ−2φ) signal becomes a predetermined value.

Specifically, the signal generation section 61 uses the signal A sin(2θ+α) output from the differential amplifier circuit 51a and the signal A sin(2θ−α) output from the differential amplifier circuit 51b to generate the signal 2A sin(2θ−2φ). In these signals, A denotes amplitude and a denotes a phase difference. The signals output from the differential amplifier circuits 51a and 51b are modified by the shift amount α between phases that vary from device to device. For example, the embodiment uses the amplitude A set to 1 and the phase difference α set to 45°. The difference calculation section 62 calculates the difference (2θ−2φ) using the signal 2A sin(2θ−2φ) output from the signal generation section 61. The positive/negative determination section 63 determines whether the difference (2θ−2φ) calculated by the difference calculation section 62 is a positive or negative value. The up-down counter 64 adds (increments) or subtracts (decrements) the count value based on a determination result from the positive/negative determination section 63.

(Processes of the Signal Generation Section 61)

With reference to FIG. 41, the following describes processes performed by the signal generation section 61. Blocks 61a through 61k in FIG. 41 represent a process performed by the signal generation section 61 and a signal or data generated by the process.

The signal generation section 61 adds the signal A sin(2θ+α) and the signal A sin(2θ−α) to generate the signal 2A sin 2θcos α (61c). A known adder circuit can be used for the addition. The signal generation section 61 subtracts the signal A sin(2θ−α) from the signal A sin(2θ+α) to generate the signal 2A cos 2θsin α (61d). A known subtraction circuit can be used for the subtraction.

The signal generation section 61 then multiplies the signal A sin 2θcos α by the signal cos 2φ and (1/cos α) to generate the signal 2A sin 2θcos 2φ (61c, 61i, and 61g). The signal generation section 61 then multiplies the signal 2A cos 2θ sin α by the signal sin 2φ and (1/sin α) to generate the signal 2A cos 2θ sin 2φ (61d, 61j, and 61h). Known circuits can be used for these multiplication operations.

In the above-mentioned multiplication, (1/cos α) and (1/sin α) denote unchanged coefficients. According to the embodiment, a storage section stores the coefficients as correction values based on the device-specific value α. Reference symbols 61g and 61h denote storage sections that store data for (1/cos α) and (1/sin α), respectively. For example, the storage section is provided in the detection circuit 50 so as to be capable of reading inside or outside the angle computing section 60. A common storage section (semiconductor memory such as EPROM and EEPROM) may include the storage sections for storing (1/cos α) and (1/sin α). The storage sections may be provided outside the detection circuit 50 or the rotation sensor 1. An inspection device may be used to measure the phase shift amount α as a device-specific value at factory shipment or during any maintenance procedure. Based on the measured value α, (1/cos α) and (1/sin α) can be stored in the storage sections 61g and 61h. The measured value α may be used as a representative value measured for each lot rather than the value measured for each product.

(Effect of Settling the Initial Value φ0)

With reference to the drawings, the following describes an effect of settling the initial value φ0. FIGS. 46A through 49C show processes in which the initial value φ0 for the computed angle φ follows the initial value θ0 for the relative rotation angle θ. As mentioned above, the initial value φ0 is determined based on the angular range that covers the initial value φ0 for a relative rotation angle.

The seventeenth embodiment differs from the thirteenth embodiment in the following.

(Case of Initial Value φ0=135°)

### Example 1

### Initial Value θ0 set to 90° for the Relative Rotation Angle θ (FIG. 47A)

The initial value for the difference (2θ−2φ) is found as (2θ0−2φ0)=(2×90°−2×135°)=−90°. The calculation results in 2 sin(2θ0−2φ0)=−2, i.e., sin(2θ0−2φ0)=−1. An arcsine operation is performed to cause the difference for the initial value to be (2θ0−2φ0)=−90°. Since the difference is −90°<0, the computed angle φ is decremented.

The computed angle φ is decremented by 1° from the initial value 135°. The difference (2θ−2φ) is decremented by 2φ(=2×1°) each time the computed angle φ is decremented by 1°. That is, the computed angle φ is decremented from 135° to 134°, . . . , 91°, and 90°. The difference (2θ−2φ) is decremented from −90° to −88°, . . . , −2°, and 0°. When the difference converges on 0°, the computed angle φ becomes 90° and equals the initial value θ0=90° for the relative rotation angle θ. The computed angle φ correctly follows the relative rotation angle θ.

### Example 2

### Initial Value θ0 Set to 150° for the Relative Rotation Angle (FIG. 47B)

The initial value for the difference (2θ−2φ) is found as (2θ0−2φ0)=(2×150°−2×135°)=30°. The calculation results in 2 sin(2θ0−2φ0)=1, i.e., sin(2θ0−2φ0)=0.5. An arcsine operation is performed to cause the difference for the initial value to be (2θ0−2φ0)=30°. Since the difference is 30°>0, the computed angle φ is incremented.

The computed angle φ is incremented by 1° from the initial value 135°. The difference (2θ−2φ) is incremented by 2φ(=2×1°) each time the computed angle φ is incremented by 1°. That is, the computed angle φ is incremented from 135° to 136°, . . . , 149°, and 150°. The difference (2θ−2φ) is decremented from 30° to 28°, . . . , 2°, and 0°. When the difference converges on 0°, the computed angle φ becomes 150° and equals the initial value θ0=150° for the relative rotation angle θ. The computed angle φ correctly follows the relative rotation angle θ.

### Example 3

### Initial Value θ0 Set to 180° for the Relative Rotation Angle θ (FIG. 47C)

The initial value for the difference (2θ−2φ) is found as (2θ0−2φ0)=(2×180°−2×135°)=90°. The calculation results in 2 sin(2θ0−2φ0)=2, i.e., sin(2θ0−2φ0)=1. An arcsine operation is performed to cause the difference for the initial value to be (2θ0−2φ0)=90°. Since the difference is 90°>0, the computed angle φ is incremented.

The computed angle φ is incremented by 1° from the initial value 135°. The difference (2θ−2φ) is decremented by 2φ(=2×1°) each time the computed angle φ is incremented by 1°. That is, the computed angle φ is incremented from 135° to 136°, . . . , 179°, and 180°. The difference (2θ−2φ) is decremented from 90° to 88°, . . . , 2°, and 0°. When the difference converges on 0°, the computed angle φ becomes 180° and equals the initial value θ0=180° for the relative rotation angle θ. The computed angle φ correctly follows the relative rotation angle θ.

(Case of Initial Value φ0=225°)

### Example 4

### Initial Value θ0 Set to 270° for the Relative Rotation Angle θ (FIG. 48A)

The initial value for the difference (2θ−2φ)) is found as (2θ0−2φ0)=(2×270°−2×225°)=90°. The calculation results in 2 sin(2θ0−2φ0)=2, i.e., sin(2θ0−2φ0)=1. An arcsine operation is performed to cause the difference for the initial value to be (2θ0−2φ0)=90°. Since the difference is 90°>0, the computed angle φ is incremented.

The computed angle φ is incremented by 1° from the initial value 225°. The difference (2θ−2φ)) is decremented by 2φ(=2×1°) each time the computed angle φ is incremented by 1°. That is, the computed angle φ is incremented from 225° to 226°, . . . , 269°, and 270°. The difference (2θ−2φ) is decremented from 90° to 88°, . . . , 2°, and 0°. When the difference converges on 0°, the computed angle φ becomes 270° and equals the initial value θ0=270° for the relative rotation angle θ. The computed angle φ correctly follows the relative rotation angle θ.

(Effect of the Seventeenth Embodiment)

The seventeenth embodiment provides the same effect as the thirteenth embodiment also in the above-mentioned cases.

### Eighteenth Embodiment

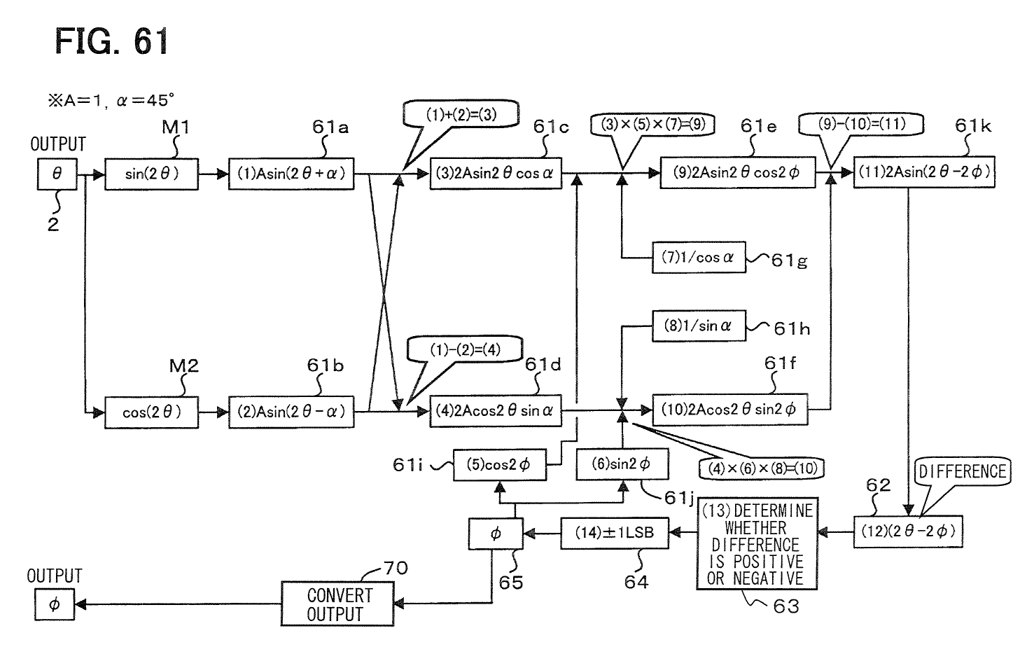

The eighteenth embodiment of the invention will be described. FIG. 61 shows signal flows between blocks in a rotation sensor according to the eighteenth embodiment.

The eighteenth embodiment differs from the thirteenth embodiment in that the Hall elements H1 and H2, and the amplification section 52 and the initial value determination section 253 in FIG. 31 are omitted from the configuration of the thirteenth embodiment. The other hardware configurations are equal to those shown in FIGS. 31 through 40 according to the thirteenth embodiment. The following description makes reference to FIGS. 31 through 40 and assumes that the Hall elements H1 and H2, the amplification section 52, and the initial value determination section 253 are omitted from FIGS. 31 through 40. Output waveforms from the AMR sensors M1 and M2 are equal to the examples in FIG. 38.

The rotation sensor according to the eighth embodiment also includes the AMR sensors M1 and M2 that are equivalent to magneto-electric conversion elements and are placed in a magnetic field of the relatively rotating permanent magnet (magnetism generator) 2. While the permanent magnet 2 rotates one turn, the AMR sensors M1 and M2 output a sin Nθ signal and a cos Nθ signal in accordance with the magnetic field intensity, where θ denotes a relative rotation angle against the permanent magnet 2 and N denotes a natural number. Examples of the embodiment also use N=2 because the AMR sensors M1 and M2 output a sin 2θ signal and a cos 2θ signal whose signal levels change at two cycles in accordance with the magnetic field intensity while the permanent magnet 2 rotates one turn.

The functions of the amplification section 51 and the angle computing section 60 are basically the same as those described in the thirteenth embodiment. The differential amplifier circuit 51a shown in FIG. 40 differentially amplifies the output signal sin 2θ (first signal) from the AMR sensor M1. The differential amplifier circuit 51b differentially amplifies the output signal cos 2θ (second signal) from the AMR sensor M2. The angle computing section 60 computes the relative rotation angle θ using signals (sin 2θ signal and cos 2θ signal) output from the AMR sensor M1 and M2. In this case, the angle computing section 60 performs feedback control so that a difference between the relative rotation angle θ for the permanent magnet 2 and the computed angle φ converges on a specified value. The eighteenth embodiment is not provided with the initial value determination section 253 as used for the thirteenth embodiment. For example, a predetermined value is used as the initial value φ0. The angle computing section 60 uses this initial value φ0 as the initial value φ for the computed angle φ used to start computing the relative rotation angle θ.

Also in this example, the angle computing section 60 generates the A sin(2θ+α) signal and the A sin(2θ−α) signal that originate from the sin 2θ signal and the cos 2θ signal output from the AMR sensors M1 and M2 and are each modified by a predetermined shift amount α. The angle computing section 60 corrects the A sin(2θ+α) signal and the A sin(2θ−α) signal using a correction value corresponding to the shift amount a to generate a sin(2θ−2φ) signal. The angle computing section 60 computes the relative rotation angle θ by carrying out feedback control so that the difference (2θ−2φ) based on the sin(2θ−2φ) signal becomes a predetermined value.

Also in this embodiment, the signal generation section 61 uses the signal A sin(2θ+α) output from the differential amplifier circuit 51a and the signal A sin(2θ−α) output from the differential amplifier circuit 51b to generate the signal 2A sin(2θ−2φ). In these signals, A denotes amplitude and a denotes a phase difference. The signals output from the differential amplifier circuits 51a and 51b are modified by the shift amount α between phases that vary from device to device. For example, the embodiment uses the amplitude A set to 1 and the phase difference α set to 45°. The difference calculation section 62 calculates the difference (2θ−2φ) using the signal 2A sin(2θ−2φ) output from the signal generation section 61. The positive/negative determination section 63 determines whether the difference (2θ−2φ) calculated by the difference calculation section 62 is a positive or negative value. The up-down counter 64 adds (increments) or subtracts (decrements) the count value based on a determination result from the positive/negative determination section 63.

With reference to FIG. 33, the following describes processes performed by the signal generation section 61. Blocks 61a through 61k in FIG. 61 represent a process performed by the signal generation section 61, a signal or data generated by the process, or a storage section for storing data.

The signal generation section 61 adds the signal A sin(2θ+α) and the signal A sin(2θ−α) to generate the signal 2A sin 2θcos α (61c). A known adder circuit can be used for the addition. The signal generation section 61 subtracts the signal A sin(2θ−α) from the signal A sin(2θ+α) to generate the signal 2A cos 2θsin α (61d). A known subtraction circuit can be used for the subtraction.

The signal generation section 61 then multiplies the signal A sin 2θcos α by the signal cos 2φ and (1/cos α) to generate the signal 2A sin 2θ cos 2φ (61c, 61i, and 61g). The signal generation section 61 then multiplies the signal 2A cos 2θsin α by the signal sin 2φ and (1/sin α) to generate the signal 2A cos 2θ sin 2φ (61d, 61j, and 61h). Known circuits can be used for these multiplication operations.

Also in this embodiment, (1/cos α) and (1/sin α) denote unchanged coefficients. According to the embodiment, a storage section stores the coefficients as correction values based on the device-specific value α. Reference symbols 61g and 61h denote storage sections that store data for (1/cos α) and (1/sin α), respectively. For example, the storage section is provided in the detection circuit 50 so as to be capable of reading inside or outside the angle computing section 60. A common storage section (semiconductor memory such as EPROM and EEPROM) may include the storage sections for storing (1/cos α) and (1/sin α). The storage sections may be provided outside the detection circuit 50 or the rotation sensor 1. Also in this embodiment, an inspection device may be used to measure the phase shift amount α as a device-specific value at factory shipment or during any maintenance procedure. Based on the measured value α, (1/cos α) and (1/sin α) can be stored in the storage sections 61g and 61h. The measured value α may be used as a representative value measured for each lot rather than the value measured for each product.

In cos 2φ (61i) and sin 2φ (61j), φ is a variable that varies with a count value from the up-down counter 64. The initial value φ0 stored in a specified storage section, for example, is used as the computed angle φ before the permanent magnet 2 starts rotating, i.e., before the rotation sensor 1 detects the relative rotation angle θ.

The signal generation section 61 subtracts the signal 2A cos 2θ sin 2φ from the signal 2A sin 2θcos 2φ to generate the signal 2A sin(2θ−2φ), i.e., a sin signal using the difference (2θ−2φ) as a variable (61k). A known subtraction circuit can be used for the subtraction.

The difference calculation section 62 performs an arcsine operation on the signal 2A sin(2θ−2φ) generated from the signal generation section 61 to find the difference (2θ−2φ) (62). The positive/negative determination section 63 determines whether the difference (2θ−2φ) found by the difference calculation section 62 is a positive value or a negative value. According to a technique, the difference (2θ−2φ) can be assumed to be positive when the signal 2A sin(2θ−2φ) is larger than 0. The difference (2θ−2φ) can be assumed to be negative when the signal 2A sin(2θ−2φ) is smaller than 0. When this technique is used, it is needless to perform an arcsine operation on the signal 2A sin(2θ−2φ).

The up-down counter 64 increments the count value by adding 1 to the least significant bit (LSB) of the counter when the positive/negative determination section 63 determines the value to be positive. The up-down counter 64 decrements the count value by subtracting 1 from the least significant bit (LSB) of the counter when the positive/negative determination section 63 determines the value to be negative. The count value from the up-down counter 64 provides a digital angle, i.e., the computed angle φ (65).

The signal generation section 61 uses the computed angle φ (count value) output from the up-down counter 64 to generate the signals cos 2φ and sin 2φ (61i and 61j). To generate these signals, the signal generation section 61 uses a table that maintains correspondence between the computed angle φ (count value) and data cos 2φ and sin 2φ. The signal generation section 61 reads data cos 2φ and sin 2φ corresponding to the computed angle φ and converts the read data into an analog signal.

The signal generation section 61 again multiplies the signal 2A sin 2θ cos α by the signal cos 2φ and (1/cos α) to generate the signal 2A sin 2θ cos 2φ. The signal generation section 61 again multiplies the signal 2A cos 2θsin α by the signal sin 2φ and (1/sin α) to generate the signal 2A cos 2θsin 2φ. That is, the difference (2θ−2φ) is fed back to the signals cos 2φ and sin 2φ to vary the signal 2A sin(2θ−2φ). This feedback is repeated until the difference (2θ−2φ) converges on 0.

The output section 70 outputs an analog signal. This signal is equivalent to an analog value converted from the computed angle φ output from the up-down counter 64. In more detail, the output section 70 latches the computed angle φ output from the up-down counter 64. The computed angle φ may be latched when the difference (2θ−2φ) becomes 0. The output section 70 converts that computed angle φ into an analog voltage Vo. The output section 70 generates and outputs an angular signal (FIG. 43E) whose voltage (Vo) linearly increases in accordance with the computed angle φ ranging from 0° to 360°.

The eighteenth embodiment needs to consider the “Problem of Not Settling the Initial Value φ0” as described in the thirteenth embodiment with reference to FIGS. 44A through 50. The problem can be solved by narrowing the detection angular range to a specified angular range. The rotation sensor according the eighteenth embodiment can be free from the problem if the sensor is configured to detect only the range of 0≦θ≦180°, for example.

### Nineteenth Embodiment

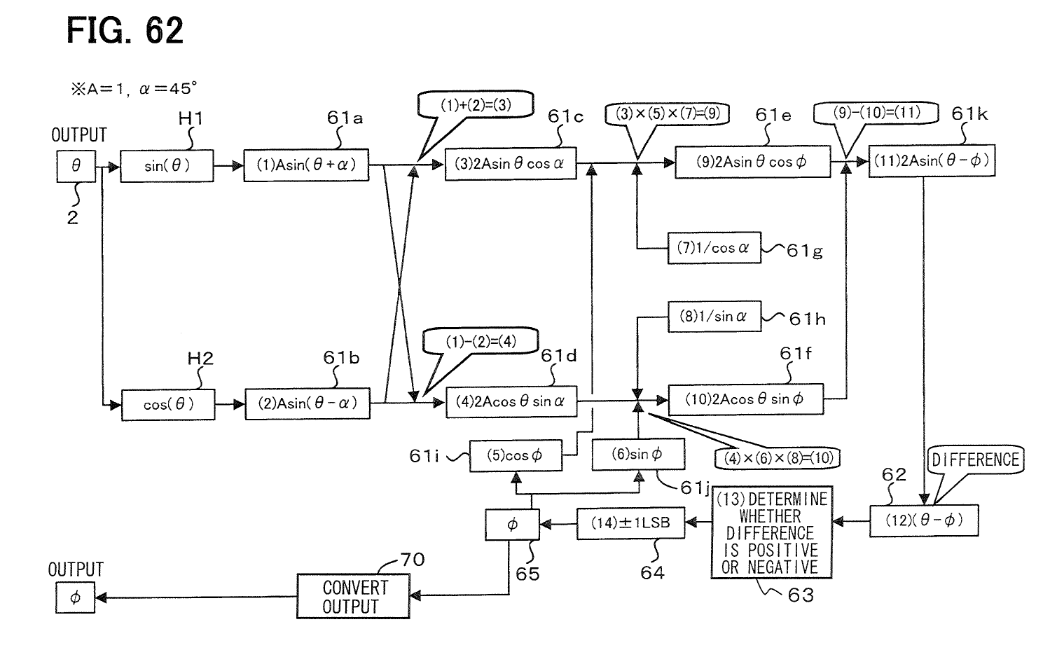

The nineteenth embodiment of the invention will be described. FIG. 62 shows signal flows between blocks in a rotation sensor according to the nineteenth embodiment.

The nineteenth embodiment omits the AMR sensors M1 and M2 according to the thirteenth embodiment and supplies the amplification section 51 with signals from the Hall elements H1 and H2. Further, the nineteenth embodiment differs from the thirteenth embodiment in that the amplification section 52 and the initial value determination section 253 in FIG. 31 are omitted. The other hardware configurations are equal to those shown in FIGS. 31 through 40 according to the thirteenth embodiment. The following description makes reference to FIGS. 31 through 40 and assumes that the AMR sensors M1 and M2, the amplification section 52, and the initial value determination section 253 are omitted from these drawings.

The rotation sensor according to the nineteenth embodiment includes the Hall elements H1 and H2 placed in the magnetic field of the relatively rotating permanent magnet (magnetism generator) 2. The Hall elements H1 and H2 are equivalent to the magneto-electric conversion elements. The Hall elements H1 and H2 output the signals sin Nθ and cos Nθ in accordance with the magnetic field intensity while the permanent magnet 2 rotates one turn, where cos Ne denotes a relative rotation angle against the permanent magnet 2 and N denotes a natural number. Examples of the embodiment use N=1 because the Hall elements H1 and H2 output a sin 2θ signal and a cos 2θ signal whose signal levels change at one cycle in accordance with the magnetic field intensity while the permanent magnet 2 rotates one turn.

The functions of the amplification section 51 and the angle computing section 60 are basically the same as those described in the thirteenth embodiment. The differential amplifier circuit 51a differentially amplifies the output signal sine (first signal) from the Hall element H1. The differential amplifier circuit 51b differentially amplifies the output signal cos θ (second signal) from the Hall element H2. The angle computing section 60 computes the relative rotation angle θ using signals (sine signal and cos θ signal) output from the Hall elements H1 and H2. In this case, the angle computing section 60 performs feedback control so that a difference between the relative rotation angle θ for the permanent magnet 2 and the computed angle φ converges on a specified value. The nineteenth embodiment is also not provided with the initial value determination section 253 as used for the thirteenth embodiment. For example, a predetermined value is used as the initial value φ0. The angle computing section 60 uses this initial value φ0 as the initial value φ for the computed angle φ used to start computing the relative rotation angle θ.

Also in this example, the angle computing section 60 generates the A sin(θ+α) signal and the A sin(θ−α) signal that originate from the sine signal and the cos θ signal output from the Hall elements H1 and H2 and are each modified by a predetermined shift amount α. The angle computing section 60 corrects the A sin(θ+α) signal and the A sin(θ−α) signal using a correction value corresponding to the shift amount α to generate a sin(θ−φ) signal. The angle computing section 60 computes the relative rotation angle θ by carrying out feedback control so that the difference (θ−φ) based on the sin(θ−φ) signal becomes a predetermined value.

Specifically, the signal generation section 61 uses the signal A sin(θ+α) output from the differential amplifier circuit 51a and the signal A sin(θ−α) output from the differential amplifier circuit 51b to generate the signal 2A sin(θ−φ). In these signals, A denotes amplitude and a denotes a phase difference. The signals output from the differential amplifier circuits 51a and 51b are modified by the shift amount α between phases that vary from device to device. For example, the embodiment uses the amplitude A set to 1 and the phase difference α set to 45°. The difference calculation section 62 calculates the difference (θ−φ) using the signal 2A sin(θ−φ) output from the signal generation section 61. The positive/negative determination section 63 determines whether the difference (θ−φ) calculated by the difference calculation section 62 is a positive or negative value. The up-down counter 64 adds (increments) or subtracts (decrements) the count value based on a determination result from the positive/negative determination section 63.

With reference to FIG. 62, the following describes processes performed by the signal generation section 61. Blocks 61a through 61k in FIG. 61 represent a process performed by the signal generation section 61, a signal or data generated by the process, or a storage section for storing data.

The signal generation section 61 adds the signal A sin(θ+α) and the signal A sin(θ−α) to generate the signal 2A sin θ cos α (61c). A known adder circuit can be used for the addition. The signal generation section 61 subtracts the signal A sin(θ−α) from the signal A sin(θ+α) to generate the signal 2A cos θ sin α (61d). A known subtraction circuit can be used for the subtraction.

The signal generation section 61 multiplies a signal A sin θ cos α by a signal cos φ and (1/cos α) to generate a signal 2A sin θ cos 2φ (61c, 61i, and 61g). The signal generation section 61 multiplies the signal 2A cos θ sin α by a signal sin and (1/sin α) to generate a signal 2A cos θ sin φ (61d, 61j, and 61h). A known multiplication circuit can be used for the multiplication.

In the above-mentioned multiplication, (1/cos α) and (1/sin α) denote unchanged coefficients. According to the embodiment, a storage section stores the coefficients as correction values based on the device-specific value α. Reference symbols 61g and 61h denote storage sections that store data for (1/cos α) and (1/sin α), respectively. For example, the storage section is provided in the detection circuit 50 so as to be capable of reading inside or outside the angle computing section 60. A common storage section (semiconductor memory such as EPROM and EEPROM) may include the storage sections 61g, 61h for storing (1/cos α) and (1/sin α). The storage sections may be provided outside the detection circuit 50 or the rotation sensor 1. An inspection device may be used to measure the phase shift amount α as a device-specific value at factory shipment or during any maintenance procedure. Based on the measured value α, (1/cos α) and (1/sin α) can be stored in the storage sections 61g and 61h. The measured value α may be used as a representative value measured for each lot rather than the value measured for each product.

In cos φ (61i) and sin φ (61j), φ is a variable that varies with a count value from the up-down counter 64. The initial value φ0 (default value) stored in a specified storage section is used as the computed angle φ before the permanent magnet 2 starts rotating, i.e., before the rotation sensor 1 detects the relative rotation angle θ.

The signal generation section 61 subtracts the signal 2A cos θ sin φ from the signal 2A sin θ cos φ to generate the signal 2A sin(θ−φ), i.e., a sin signal using the difference (θ−φ) as a variable (61k). A known subtraction circuit can be used for the subtraction.

The difference calculation section 62 performs an arcsine operation on the signal 2A sin(θ−φ) generated from the signal generation section 61 to find the difference (θ−φ) (62). The positive/negative determination section 63 determines whether the difference (θ−φ) found by the difference calculation section 62 is a positive value or a negative value. According to a technique, the difference (θ−φ) can be assumed to be positive when the signal 2A sin(θ−φ) is larger than 0. The difference (θ−φ) can be assumed to be negative when the signal 2A sin(θ−φ) is smaller than 0. When this technique is used, it is needless to perform an arcsine operation on the signal 2A sin(θ−φ).

The up-down counter 64 increments the count value by adding 1 to the least significant bit (LSB) of the counter when the positive/negative determination section 63 determines the value to be positive. The up-down counter 64 decrements the count value by subtracting 1 from the least significant bit (LSB) of the counter when the positive/negative determination section 63 determines the value to be negative. The count value from the up-down counter 64 provides a digital angle, i.e., the computed angle φ (65).

The signal generation section 61 uses the computed angle φ (count value) output from the up-down counter 64 to generate the signals cos φ and sin φ (61i and 61j). To generate these signals, the signal generation section 61 uses a table that maintains correspondence between the computed angle φ (count value) and data cos φ and sin φ. The signal generation section 61 reads data cos φ and sin φ corresponding to the computed angle φ and converts the read data into an analog signal.

The signal generation section 61 again multiplies the signal 2A sin θ cos α by the signal cos φ and (1/cos α) to generate the signal 2A sin θ cos φ. The signal generation section 61 again multiplies the signal 2A cos θ sin α by the signal sin φ and (1/sin α) to generate the signal 2A cos θ sin φ. That is, the difference (θ−φ) is fed back to the signals cos φ and sin φ to vary the signal 2A sin(θ−φ). This feedback is repeated until the difference (θ−φ) converges on 0.

The output section 70 outputs an analog signal. This signal is equivalent to an analog value converted from the computed angle φ output from the up-down counter 64. In more detail, the output section 70 latches the computed angle φ output from the up-down counter 64. The computed angle φ may be latched when the difference (θ−φ) becomes 0. The output section 70 converts that computed angle φ into an analog voltage Vo. The output section 70 generates and outputs an angular signal (same as FIG. 43E) whose voltage (Vo) linearly increases in accordance with the computed angle φ ranging from 0° to 360°.

The above-mentioned disclosure includes the following aspects.

According to a first aspect of the present disclosure, a rotation sensor includes: a magnetism generator that generates a magnetic field; a sensor chip having a magneto-resistance element region and a Hall element region, wherein the magneto-resistance element region includes a plurality of magneto-resistance elements, and the Hall element region includes a plurality of Hall elements; and a detection circuit that detects a relative rotation angle in relation to the magnetism generator according to output signals from each magneto-resistance element and each Hall element. Each magneto-resistance element provides a magneto-resistance effect with respect to the magnetic field. Each Hall element provides a Hall effect with respect to the magnetic field. The plurality of magneto-resistance elements are arranged in the magneto-resistance element region so as to cause a phase difference between output signals of the magneto-resistance elements. The plurality of Hall elements are arranged in the Hall element region so as to cause a phase difference between output signals of the Hall elements. The magneto-resistance element region and the Hall element region at least partially overlap with each other. The detection circuit includes a comparison section, an angle computing section, and an output section. The comparison section compares an output level from each Hall element with a predetermined threshold value level, and provides a comparison result for each Hall element. The angle computing section calculates a calculation angle corresponding to the relative rotation angle according to an output signal from each magneto-resistance element. The output section compares the calculation angle with a predetermined threshold value, and provides a comparison result for each magneto-resistance element. The output section outputs a signal corresponding to the relative rotation angle based on the comparison result of the output section and the comparison result of the comparison section.

The above-mentioned rotation sensor can be miniaturized because the magneto-resistance element region and the Hall element region at least partly overlap with each other. The rotation sensor outputs a signal corresponding to the relative rotation angle using not only a result of comparison between an output level from each Hall element and a threshold level, but also a result of comparison between an angle computed by the angle computing section and threshold angle. Accordingly, the detection accuracy of relative rotation angles can be improved. In other words, the result of comparison between a value computed by the angle computing section and a threshold value can compensate for an unstable factor in the result of comparison between an output level from each Hall element and a threshold level. Therefore, the detection accuracy of relative rotation angles can be improved.

As an alternative, almost a whole of the Hall element region may overlap with the magneto-resistance element region.

In this case, the rotation sensor can be miniaturized because almost all the Hall element region overlaps with the magneto-resistance element region. The same rotation sensor can be shared even though the magnetism generators use different diameters. It is unnecessary to manufacture different rotation sensors corresponding to different permanent magnet diameters. Therefore, rotation sensor manufacturing costs can be reduced.

As an alternative, the magneto-resistance element region and the Hall element region may overlap with each other in a direction of a relative rotation axis of the magnetism generator.

In this case, it is possible to reduce an area occupied by the rotation sensor around the relative rotation axis because the magneto-resistance element region and the Hall element region overlap in a direction corresponding to the direction of the relative rotation axis of the magnetism generator.

As an alternative, the magneto-resistance element region and the Hall element region may be positioned approximately parallel to a relative rotational plane of the magnetism generator.

In this case, the magneto-resistance elements and the Hall elements can detect magnetism the magnetism generator generates approximately parallel to the magneto-resistance element region and the Hall element region. This is because the magneto-resistance element region and the Hall element region are positioned approximately parallel to a relative rotational plane of the magnetism generator.

As an alternative, the magneto-resistance element region may be positioned on a top side of the sensor chip. The Hall element region is positioned on a bottom side of the sensor chip. The top side of the sensor chip faces a relative rotational plane of the magnetism generator.

In this case, a relative rotation angle can be detected even when the top side of the sensor chip faces toward a relative rotational plane of the magnetism generator.

As an alternative, the magneto-resistance element region may be positioned on a top side of the sensor chip. The Hall element region is positioned on a bottom side of the sensor chip. The bottom side of the sensor chip faces a relative rotational plane of the magnetism generator.

In this case, a relative rotation angle can be detected even when the bottom side of the sensor chip faces toward a relative rotational plane of the magnetism generator.

As an alternative, the magnetism generator may include a pair of different magnetic poles, which are divided in a radial direction of a relative rotational plane of the magnetism generator.

In this case, it is possible to detect a relative rotation angle with reference to the magnetism generator having different magnetic poles divided in a radial direction of the relative rotational plane of the magnetism generator.

As an alternative, the magnetism generator may include a pair of different magnetic poles, which are positioned in a circumferential direction of a relatively rotating body.

In this case, it is possible to detect a relative rotation angle with reference to the magnetism generator having different magnetic poles divided positioned in a circumferential direction of a relatively rotating body.

As an alternative, the sensor chip may be positioned between the pair of different magnetic poles.

In this case, magnetism generated between different magnetic poles can be applied parallel to the magneto-resistance element region and the Hall element region of the sensor chip. This is because the sensor chip is positioned between different magnetic poles positioned around the rotating body. The space occupied by the rotating body and the sensor chip can be reduced in the relative rotation axis direction of the rotating body.

As an alternative, the magnetism generator may be a plurality of pairs of different magnetic poles.

As an alternative, each of the magneto-resistance elements and the Hall elements may mainly detect a change in magnetic flux density of a magnetic field parallel to the magneto-resistance element region and the Hall element region.

In this case, it is possible to increase a magneto-resistance effect in each magneto-resistance element. This is because the sensor mainly detects a change in the magnetic flux density of a magnetic field parallel to the magneto-resistance element region. Accordingly, it is possible to increase the accuracy of detecting a relative rotation angle with reference to the magnetism generator.

As an alternative, each of the Hall elements may be positioned to cause the phase difference of 90° between output signals of the Hall elements adjacent to each other.

In this case, one of adjacent Hall elements can output a sine-wave signal (sin signal) and the other Hall element can output a cosine-wave signal (cos signal). Accordingly, it is possible to convert the sine-wave signal and the cosine-wave signal into pulse signals, use a combination of signal levels for both pulse signals, and determine to which of quadrants (angular ranges) from 0° to 90°, from 90° to 180°, from 180° to 270°, and from 270° to 360° a relative rotation angle belongs.

As an alternative, each of the magneto-resistance elements may be positioned to cause a phase difference of 45° between output signals of the magneto-resistance elements adjacent to each other.

In this case, it is possible to one of adjacent Hall elements can output a sine-wave signal (sin signal) and the other Hall element can output a cosine-wave signal (cos signal) having a phase of 45° later than the sine-wave signal. Accordingly, the sine-wave signal and the cosine-wave signal can be used to compute a relative rotation angle.

As an alternative, the plurality of magneto-resistance elements may provide a first half-bridge circuit and a second half-bridge circuit. The plurality of magneto-resistance elements are coupled with each other in a half-bridge manner so as to cause the phase difference of 90° between output signals from magneto-resistance elements adjacent to each other so that the first and second half-bridge circuits are formed. A phase difference between output signals from the first and second half-bridge circuits is 45°.

In this case, the midpoint outputs from the first and second half-bridge circuits each oscillate around half a voltage supplied to each of the half-bridge circuits and are capable of suppressing an output signal offset due to a change in the environmental temperature.

As an alternative, the magneto-resistance elements may further provide another first half-bridge circuit and another second half-bridge circuit. The first half-bridge circuit and the another first half-bridge circuit are bridged to provide a first full-bridge circuit. The second half-bridge circuit and the another second half-bridge circuit are bridged to provide a second full-bridge circuit. A phase difference between output signals from the first full-bridge circuit and the second full-bridge circuit is 45°.

In this case, the first and second half-bridge circuits can be configured as full-bridge circuits capable of providing the output signal amplitude double the half-bridge circuit configuration. The full-bridge circuit configuration can detect weak magnetism generated from the magnetism generator and improve the detection sensitivity for a relative rotation angle with reference to the magnetism generator. A gap between the magnetism generator and the sensor chip can be increased, improving the degree of freedom for the sensor chip layout.

As an alternative, the plurality of magneto-resistance elements included in the first and second half-bridge circuits may be positioned concentrically and alternately.

In this case, a layout area for the magneto-resistance element region can be decreased because the magneto-resistance elements included in the first and second half-bridge circuits are positioned concentrically and alternately.

As an alternative, a phase difference between a signal output from the output section and each of output signals from the Hall elements may be 45°, respectively.

Generally, the Hall element outputs an analog sin or cos signal at the 180° cycle and provides less sensitivity than the magneto-resistance element. A voltage easily fluctuates approximately voltage 0 V or a point to change the phase 180° due to an effect of voltage offset or random noise. When the Hall element outputs a signal, there may be case where a pulse signal (hereafter referred to as a first pulse signal) is generated by assuming the output signal corresponding to 0 V (threshold level) or higher to be set to a high level and assuming the output signal corresponding to lower than 0 V to be set to a low level. In such a case, a voltage may become unstable near a point where the first pulse signal changes the phase 180°. Unstable regions are shaded in FIG. 13. To improve the detection accuracy, the unstable regions are preferably excluded from the determination to which of the angular ranges a relative rotation angle belongs when the angular ranges result from dividing the relative rotation angle ranging from 0° to 360° by 90°. On the other hand, the angle computing section computes an angle using output signals from the high-sensitive magneto-resistance elements. The computed angle is represented in a multi-bit digital value. Half the computed angle can be assumed to be a threshold angle. The computed angle is assumed to be high when the angle is higher than or equal to the threshold angle. The computed angle is assumed to be low when the angle is lower than the threshold angle. It is possible to generate a pulse signal (hereafter referred to as a second pulse signal) free from the unstable regions. A signal corresponding to the computed angle indicates a phase difference of 45° from each output signal from the Hall elements. That is, there is the 45° phase difference between the second pulse signal and the first pulse signal. In order to determine which angular range covers the relative rotation angle, the first pulse signal is configured to use signal levels corresponding to 90° at the center and not to use signal levels corresponding to unstable 45° at both ends (90° in total). Signal levels for the second pulse signal are used for those corresponding to 45° at both ends. That is, this example can improve the accuracy of determining the angular range to which a relative rotation angle belongs.

As an alternative, a range of the relative rotation angle may be in a range between 0° and 360°. An angle of 360° is divided by the phase difference between output signals from the Hall elements to yield a value defined as n. A range between 0° and 360° is divided by n to provide n angular ranges. Combinations of the comparison results of the comparison section and the output section in each of the angular ranges are different from each other.

In this case, the relative rotation angle ranging from 0° to 360° is divided by a phase difference between output signals from the Hall elements to find a value n. A range between 0° and 360° is divided by n to provide n angular ranges. As a result, each angular range provides a unique combination of comparison results from the comparison section and the output section. The angular range determination accuracy can be improved. For example, let us suppose that there is a phase difference of 90° (n=4) between output signals from the Hall elements and that relative rotation angles are divided into four angular ranges from 0° to 90°, from 90° to 180°, from 180° to 270°, and from 270° to 360°. Under this condition, there is no possibility of incorrectly outputting 0° as a computed angle while the relative rotation angle is 180°. An accurate angle ranging from 0° to 360° can be output.

As an alternative, the angle calculating section may calculate the relative rotation angle by performing feedback control so as to decrease a difference between the relative rotation angle and a calculation angle calculated with using a plurality of output signals that are output from the plurality of magneto-resistance elements and include phase differences.

In this case, a relative rotation angle can be computed highly accurately. This is because an angle corresponding to the relative rotation angle is found by performing the feedback control so as to decrease a difference between the relative rotation angle and the computed angle. In addition, first and second comparison results and the computed angle can be used to output an angle corresponding to the relative rotation angle ranging from 0° to 360°.

As an alternative, each of the Hall elements may be a vertical Hall element. A planar direction of a magnetism detection plane of each Hall element intersects the magneto-resistance element region.

In this case, the magnetism detection plane of each Hall element can detect magnetism parallel to the magneto-resistance element region. This is because each of the Hall elements is vertical and the magnetism detection plane of each Hall element is positioned so that a planar direction of the magnetism detection plane intersects the magneto-resistance element region. Consequently, the magneto-resistance element region and the Hall element region can detect magnetism even when both element regions overlap each other. The sensor chip can be miniaturized in the planar direction (width direction).

As an alternative, each magneto-resistance element and each Hall element may be positioned on a semiconductor substrate.

In this case, the magneto-resistance elements and the Hall elements can be integrated because they are formed in the semiconductor substrate. There is no need to individually position the magneto-resistance elements and the Hall elements.

As an alternative, each Hall element may have a CMOS transistor structure.

In this case, the rotation sensor manufacturing efficiency can be improved. This is because each Hall element is structured as a CMOS transistor and manufacturing processes can be more simplified than those for the bipolar structure.

As an alternative, each Hall element may have a high-voltage CMOS transistor structure.

In this case, the magnetism detection sensitivity can be improved. This is because the N-type semiconductor region (Nwell) becomes deep and the carrier mobility is improved.

As an alternative, the Hall element may include: a semiconductor substrate having a first conductive type; a second conductive type semiconductor region that is positioned at a predetermined depth from a surface part in the semiconductor substrate; a first conductive type semiconductor region that is arranged shallower than the second conductive type semiconductor region in the second conductive type semiconductor region so as to divide the second conductive type semiconductor region; a second conductive type impurity diffusion region for a contact configured to be a power supply pair and arranged in a surface part of the second conductive type semiconductor region so as to sandwich the first conductive type semiconductor region; and a second conductive type impurity diffusion region for a contact configured to be a voltage output pair and arranged in a surface part of the second conductive type semiconductor region. At least a part of the magneto-resistance element region overlaps the Hall element region through an insulating film.

In this case, the Hall element region can be fabricated on the semiconductor substrate. The insulating film can be then formed on the surface of the Hall element region. The magneto-resistance element region can be formed on the surface of the insulating film. Accordingly, the magneto-resistance element region can be layered on the Hall element region. The rotation sensor manufacturing efficiency can be more improved than individual formation of both element regions in the planar direction (horizontal direction).

As an alternative, each of the magneto-resistance elements may be made of an NiFe thin film.

In this case, the relative rotation angle detection accuracy can be improved because a weak magnetic field can be detected.

As an alternative, each of the magneto-resistance elements may be made of an NiCo thin film.

In this case, the relative rotation angle detection accuracy can be improved because a weak magnetic field can be detected.

According to a second aspect of the present disclosure, a rotation sensor includes: a rotatable magnetism generator; a plurality of magneto-electric conversion elements positioned in a magnetic field of the magnetism generator rotating relatively with the magneto-electric conversion elements, wherein each magneto-electric conversion element outputs a signal with a signal level changing at two cycles in accordance with an intensity of the magnetic field during one rotation of the magnetism generator, and wherein the magneto-electric conversion elements are positioned so as to cause a phase difference between signals of the magneto-electric conversion elements; a detection circuit that detects a relative rotation angle with reference to the magnetism generator according to a signal output from each magneto-electric conversion element; and a plurality of detection elements, wherein each detection element outputs a detection signal with a signal level changing at one cycle in accordance with an intensity of the magnetic field during one rotation of the magnetism generator, and wherein the detection elements are positioned so as to cause a phase difference between detection signals of the detection elements. The detection circuit includes an angle computing section, an initial value determination section, and an output section. The angle computing section calculates a calculation angle corresponding to a relative rotation angle according to a signal output from each magneto-electric conversion element. The angle computing section performs feedback control so that a difference between the relative rotation angle and the calculation angle converges on a predetermined value. The initial value determination section compares a signal level for each detection signal with a predetermined threshold value, and determines an angular range that includes an initial value for the relative rotation angle. The initial value determination section determines an initial value for the calculation angle so that an absolute value of a difference between the initial value for the calculation angle and the initial value for the relative rotation angle available in the determined angular range becomes smaller than 90°. The output section outputs a signal corresponding to the calculation angle at one cycle during one rotation of the magnetism generator. The initial value determination section determines an initial value for the calculation angle only before the magnetism generator starts relative rotation. The angle computing section starts the feedback control with using an initial value for the calculation angle, the initial value being determined by the initial value determination section.

This rotation sensor can shorten the time to compute a relative rotation angle while the magnetism generator is rotating relatively. This is because the initial value determination section determines an initial value for the computed angle only before the magnetism generator starts relative rotation. A conventional rotation sensor always needs to use signal levels for the detection signals from the detection elements during relative rotation of the magnetism generator to determine the angular range covering the relative rotation angle. On the other hand, the above-mentioned sensor uses signal levels of the detection signals from the detection elements only in order to determine an initial value for the computed angle before the magnetism generator starts relative rotation. During relative rotation of the magnetism generator, the sensor need not compare a signal level of each detection signal from each detection element with a threshold value. It is possible to shorten the time to compute a relative rotation angle.

As an alternative, the initial value for the relative rotation angle may be defined as θ0, and the initial value for the calculation angle may be defined as φ0. The angle computing section is capable of calculating the initial value θ0 for the relative rotation angle within a range of (φ0−90°)<θ0<(φ0+90°).

In this case, the angle computing section can accurately compute the relative rotation angle even when an initial value for the relative rotation angle actually exceeds the angular range determined by the initial value determination section. For example, FIG. 50 shows that the initial value determination section determines the angular range to be 0≦θ0<90° and the initial value φ0 for the computed angle is settled to be 45°. In this case, the range capable of computing the initial value θ0 for the relative rotation angle can be extended up to (45°−90°)<θ0<(45°+90°), i.e., −45°<θ0<135° (0°≦θ0<135° and 315°<θ0≦360°). For example, let us suppose that the initial value determination section determines the angular range to be 0≦θ0<90° and the actual initial value θ0 is 120°. Since the angular range corresponding to the initial value φ0=45° includes 120°, the angle computing section can use the initial value φ0=45° for the computed angle φ to compute the initial value θ0=120° for the relative rotation angle θ. The relative rotation angle θ can be accurately computed even when the initial value θ0 or the initial value φ0 changes due to external noise or external magnetic field. It is possible to provide the rotation sensor that hardly degrades the detection accuracy even under the influence of external noise or external magnetic field.

As an alternative, the plurality of detection elements may be positioned so as to cause a phase difference of 90° between detection signals.

In this case, the detection elements can output detection signals having a phase difference of 90° each time the relative rotation angle with reference to the magnetism generator changes 90°. A combination of signal levels for the detection signals can be changed each time the relative rotation angle changes 90°. Accordingly, the initial value determination section can use the combination of signal levels for the output signals to determine the angular range covering the initial value for the relative rotation angle in units of 90°.

As an alternative, the plurality of magneto-electric conversion elements may be positioned so as to cause a phase difference of 45° between signals.

In this case, one of the magneto-resistance elements can output a sine-wave signal (sin signal) and the other magneto-resistance element can output a cosine-wave signal (cos signal) having a phase 45° later than the cosine-wave signal. The sine-wave signal and the cosine-wave signal can be used to compute the relative rotation angle.

As an alternative, the relative rotation angle may be in a range between 0° and 360°. An angle of 360° is divided by a phase difference between output signals from each detection element to yield a value defined as n. A range between 0° and 360° is divided by n to provide n angular ranges. Combinations of the comparison results between a signal level for each of the detection signals and a threshold value in each of the angular ranges are different from each other.

In this case, the initial value determination section can improve the angular range determination accuracy. This is because each angular range provides a unique combination of comparison results between the signal level for each of the output signals and the threshold value.

As an alternative, the relative rotation angle may be defined as θ, and the calculation angle is defined as φ. The angle computing section performs feedback control with using a signal output from each magneto-electric conversion element so as to cause a difference of (2θ−2φ) to be 0. The angle computing section utilizes an initial value determined by the initial value determination section as the initial value for the calculation angle φ when the angle computing section starts to execute the feedback control.

In this case, the relative rotation angle can be computed highly accurately. This is because the relative rotation angle is computed by performing the feedback control so as to cause the difference (2θ−2φ) to be 0.

As an alternative, the plurality of magneto-electric conversion elements may output a sin 2θ signal and a cos 2θ signal. The angle computing section generates a sin(2θ−2φ) signal based on the sin 2θ signal and the cos 2θ signal. The angle computing section calculates a difference of (2θ−2φ) based on the generated sin(2θ−2φ) signal. The angle computing section performs the feedback control so as to cause the difference of (2θ−2φ) to be 0.

In this case, the difference (2θ−2φ) can be computed through use of the sin 2θ signal and the cos 2θ signal output from the magneto-electric conversion elements. Because of sin(2θ−2φ=sin 2θcos 2φ−cos 2θsin 2φ, the difference (2θ−2φ) can be computed through use of the sin 2θ signal and the cos 2θ signal output from the magneto-electric conversion elements, the sin 2φ signal and the cos 2φ signal, a circuit for multiplying signals, and a circuit for subtracting signals.

As an alternative, the angle computing section may include a counter. The counter counts a count value corresponding to the calculation angle φ. The angle computing section determines whether the difference of (2θ−2φ) is positive or negative. The counter increases or decreases the count value of the counter based on a determination result of the difference of (2θ−2φ).

In this case, the computed angle φ can be computed highly accurately. This is because the computed angle φ can correspond to the count value of the counter.

As an alternative, the angle computing section may perform an arcsine operation on the sin(2θ−2φ) signal in order to calculate the difference of (2θ−2φ). The angle computing section determines based on a calculation result of the difference of (2θ−2φ) whether the difference of (2θ−2φ) is positive or negative.

In this case, the angle computing section can perform an arcsine operation on the sin(2θ−2φ) signal to compute the difference (2θ−2φ). Based on a computation result, the angle computing section can determine whether the difference (2θ−2φ) is positive or negative.

As an alternative, the angle computing section may determine that the difference of (2θ−2φ) is positive when the sin(2θ−2φ) signal is greater than 0. The angle computing section determines that the difference of (2θ−2φ) is negative when the sin(2θ−2φ) signal is smaller than 0.

In this case, the angle computing section need not perform an arcsine operation on the sin(2θ−2φ) signal. This is because the angle computing section can determine the difference (2θ−2φ) to be positive or negative based on whether the sin(2θ−2φ) signal is greater than 0 or not.

As an alternative, each detection element may be a Hall element.

In this case, it is possible to acquire a detection signal whose signal level changes every cycle in accordance with the magnetic field intensity while the magnetism generator rotates one turn. In addition, the rotation sensor can be miniaturized because the Hall element can be formed in the semiconductor substrate.

As an alternative, each magneto-electric conversion element may be a magneto-resistance element.

In this case, it is possible to acquire a signal whose signal level changes every two cycles in accordance with the magnetic field intensity while the magnetism generator rotates one turn. In addition, the rotation sensor can be miniaturized because the magneto-resistance element can be formed in the semiconductor substrate.

According to a third aspect of the present disclosure, a rotation sensor includes: a rotatable magnetism generator; a plurality of magneto-electric conversion elements positioned in a magnetic field generated by the magnetism generator relatively rotating, wherein each magneto-electric conversion element outputs a signal with a signal level changing at two cycles in accordance with intensity of the magnetic field during one rotation of the magnetism generator, and wherein the magneto-electric conversion elements are positioned so as to cause a phase difference between signals; a detection circuit that detects a relative rotation angle with reference to the magnetism generator according to the signal output from each magneto-electric conversion element; and a plurality of detection elements, wherein each detection element outputs a detection signal with a signal level changing at one cycle in accordance with intensity of the magnetic field during one rotation of the magnetism generator, and wherein the detection elements are positioned so as to cause a phase difference between detection signals. The detection circuit includes an angle computing section, an initial value determination section and an output section. The angle computing section calculates a calculation angle corresponding to a relative rotation angle according to the signal output from each magneto-electric conversion element. The angle computing section performs feedback control so that a difference between the relative rotation angle and the calculation angle converges on a predetermined value. The initial value determination section compares a signal level for each detection signal with a predetermined threshold value, and determines an angular range that includes an initial value for the relative rotation angle, based on a result of the comparison. The initial value determination section determines an initial value for the calculation angle so that an absolute value for a difference between an initial value for the calculation angle and an initial value for the relative rotation angle available in the determined angular range becomes smaller than 90°. The output section outputs a signal corresponding to the calculation angle at one cycle during one rotation of the magnetism generator. The initial value determination section determines an initial value for the calculation angle before the magnetism generator starts relative rotation and at a predetermined time after the magnetism generator starts relative rotation. The angle computing section starts to execute the feedback control with using the initial value for the calculation angle determined by the initial value determination section.

The above-mentioned sensor can shorten the time to compute the relative rotation angle while the magnetism generator is rotating relatively. This is because the initial value determination section determines an initial value for the computed angle before the magnetism generator starts relative rotation and at a specified time after relative rotation starts. A conventional rotation sensor always needs to use signal levels for the detection signals from the detection elements during relative rotation of the magnetism generator to determine the angular range covering the relative rotation angle. According to the second feature, the signal level for each detection signal from each detection element is used only when an initial value for the computed angle is settled before the magnetism generator starts relative rotation and at a predetermined time after the relative rotation starts. There is no need to compare the signal level for each detection signal from each detection element with a threshold value each time the magnetism generator relatively rotates. Accordingly, the time to compute the relative rotation angle can be shortened.

According to a fourth aspect of the present disclosure, a rotation sensor includes: a rotatable magnetism generator; a plurality of magneto-electric conversion elements positioned in a magnetic field generated by the magnetism generator relatively rotating, wherein the plurality of magneto-electric conversion elements output a first signal and a second signal, each of which has a signal level changing at N cycles in accordance with intensity of the magnetic field during one rotation of the magnetism generator, wherein N is a natural number, and wherein the magneto-electric conversion elements are positioned so as to cause a phase difference between the first signal and the second signal; and a detection circuit that detects a relative rotation angle with reference to the magnetism generator according to the first signal and the second signal output from each magneto-electric conversion element. The detection circuit includes an angle computing section and an output section. The angle computing section calculates a calculation angle corresponding to the relative rotation angle with using the first signal and the second signal. The angle computing section performs feedback control so that a difference between the relative rotation angle defined as θ and the calculation angle defined as φ converges on a predetermined value. The output section outputs a signal corresponding to the calculation angle. The angle computing section generate a first cycle signal and a second cycle signal, each of which is modified by a predetermined shift amount, based on the first signal and the second signal output from the plurality of magneto-electric conversion elements. The angle computing section generates a difference of (Nθ−Nφ) by correcting the first cycle signal and the second cycle signal with using a correction value corresponding to the shift amount. The angle computing section performs feedback control so that the difference of (Nθ−Nφ) approaches the predetermined value.

The above-mentioned sensor can generate the first cycle signal and the second cycle signal reflecting the predetermined shift amount a based on signals (first and second signals) that are output from the magneto-electric conversion elements and have different phases. The sensor corrects the first cycle signal and the second cycle signal using the correction value reflecting the shift amount α. In this manner, the sensor can generate difference (Nθ−Nφ) and perform the feedback control. Accordingly, the sensor can more accurately compute the relative rotation angle θ by reflecting a phase difference due to a structural error.

As an alternative, the magneto-electric conversion elements may output a sin signal and a cos signal during one rotation of the magnetism generator. The angle computing section generates a sin(Nθ+α) signal and a sin(Nθ−α) signal modified by a predetermined shift amount defined as α based on the sin signal and the cos signal. The angle computing section generates an A sin(Nθ−Nφ) signal by correcting the sin(Nθ+α) signal and the sin(Nθ−α) signal with using a correction value corresponding to the shift amount. The angle computing section performs feedback control so that a difference of (Nθ−Nφ) based on the A sin(Nθ−Nφ) signal approaches the predetermined value.

In this case, the sensor can generate the sin(Nθ+α) signal and the sin(Nθ−α) signal. These signals are based on the sin signal and the cos signal output from the magneto-electric conversion elements and reflect the predetermined shift amount α. The sensor corrects the sin(Nθ+α) signal and the sin(Nθ−α) using a correction value corresponding to the shift amount α to generate the sin(Nθ−Nφ) signal. Using this signal, the sensor can compute the difference (Nθ−Nφ). In other words, the sensor can generate a signal reflecting the shift amount α, appropriately correct the signals in accordance with the shift amount α, and appropriately compute the difference (Nθ−Nφ).

As an alternative, the rotation sensor may further include: a storage section that preliminary stores the correction value corresponding to the shift amount. The angle computing section generates the sin(Nθ−Nφ) signal by acquiring the correction value from the storage section for correction.

In this case, the sensor can read an appropriate correction value corresponding to the shift amount α and appropriately and fast perform the correction operation.

As an alternative, the angle computing section may perform feedback control with using a signal output from each magneto-electric conversion element so that a difference of (Nθ−Nφ) approaches 0.

In this case, the relative rotation angle can be highly accurately computed. This is because the angle computing section computes the relative rotation angle by performing feedback control so that a difference (Nθ−Nφ) reaches 0.

As an alternative, the angle computing section may include a counter that counts a count value corresponding to the calculation angle of φ. The angle computing section determines whether the difference of (Nθ−Nφ) is positive or negative. The counter increases or decreases the count value of the counter based on a determination result of the difference of (Nθ−Nφ).

In this case, the computed angle φ can be highly accurately computed. This is because the computed angle φ can correspond to a count value of the counter.

As an alternative, the angle computing section may include a counter that counts a count value corresponding to the calculation angle of φ. The counter increases or decreases the count value of the counter based on a determination result. The angle computing section performs an arcsine operation on the sin(Nθ−Nφ) signal to calculate the difference of (Nθ−Nφ) and, based on a calculation result of the difference of (Nθ−Nφ), determines whether the difference of (Nθ−Nφ) is positive or negative.

In this case, an arcsine operation is performed on the sin(Nθ−Nφ) signal to compute the difference (Nθ−Nφ). Based on the computation result, it is possible to accurately determine whether the difference (Nθ−Nφ) is positive or negative.

As an alternative, the angle computing section may include a counter that counts a count value corresponding to the calculation angle of φ. The angle computing section determines whether the difference of (Nθ−Nφ) is positive or negative. The counter increases or decreases the count value of the counter based on a determination result of the difference of (Nθ−Nφ). The angle computing section determines that the difference of (Nθ−Nφ) is positive when the sin(Nθ−Nφ) signal is greater than 0. The angle computing section determines that the difference of (Nθ−Nφ) is negative when the sin(Nθ−Nφ) signal is smaller than 0.

In this case, there is no need for arcsine operation on the sin(Nθ−Nφ) signal. This is because the difference (Nθ−Nφ) can be determined to be positive or negative based on whether the sin(Nθ−Nφ) signal is greater than 0 or not.

As an alternative, each magneto-electric conversion element may be a magneto-resistance element.

In this case, it is possible to successfully acquire a signal with a signal level changing at N cycles in accordance with the magnetic field intensity while the magnetism generator rotates one turn. The rotation sensor can be miniaturized because the magneto-resistance element can be formed in the semiconductor substrate.

As an alternative, the rotation sensor may further include: a plurality of detection elements. The magneto-electric conversion elements output a sin 2θ signal and a cos 2θ signal, each of which has a signal level that changes at two cycles in accordance with intensity of the magnetic field during one rotation of the magnetism generator. The plurality of detection elements output a detection signal having a signal level that changes at one cycle in accordance with intensity of the magnetic field during one rotation of the magnetism generator. The plurality of detection elements are positioned so as to cause a phase difference between detection signals. The detection circuit further includes an initial value determination section. The initial value determination section compares a signal level of each detection signal with a predetermined threshold value, and determines an angular range that includes an initial value for the relative rotation angle, based on a comparison result. The initial value determination section determines an initial value for the calculation angle so that an absolute value for a difference between an initial value for the computed angle and an initial value for the relative rotation angle available in the determined angular range becomes smaller than 90°. The output section outputs a signal corresponding to the calculation angle at one cycle during one rotation of the magnetism generator. The initial value determination section determines an initial value for the calculation angle only before the magnetism generator starts relative rotation. The angle computing section starts to execute the feedback control with using the initial value for the calculation angle determined by the initial value determination section.

In this case, the initial value determination section can shorten the time to compute the relative rotation angle when the magnetism generator rotates relatively. This is because the initial value for the computed angle is determined only before the magnetism generator starts relative rotation. A conventional rotation sensor always needs to use signal levels for the detection signals from the detection elements during relative rotation of the magnetism generator to determine the angular range covering the relative rotation angle. On the other hand, the sensor according to the fourth aspect uses signal levels of the detection signals from the detection elements only in order to determine an initial value for the computed angle before the magnetism generator starts relative rotation. During relative rotation of the magnetism generator, the sensor need not compare a signal level of each detection signal from each detection element with a threshold value. It is possible to shorten the time to compute a relative rotation angle.

As an alternative, the rotation sensor may further include: a plurality of detection elements. The magneto-electric conversion elements output a sin 2θ signal and a cos 2θ signal, each of which has a signal level that changes at two cycles in accordance with intensity of the magnetic field during one rotation of the magnetism generator. The detection elements output a detection signal having a signal level that changes at one cycle in accordance with intensity of the magnetic field during one rotation of the magnetism generator. The detection elements are positioned so as to cause a phase difference between detection signals. The detection circuit further includes an initial value determination section. The initial value determination section compares a signal level of each detection signal with a predetermined threshold value, and determines an angular range that includes an initial value for the relative rotation angle with using a comparison result. The initial value determination section determines an initial value for the calculation angle so that an absolute value for a difference between an initial value for the calculation angle and an initial value for the relative rotation angle available in the determined angular range becomes smaller than 90°. The output section outputs a signal corresponding to the calculation angle at one cycle during one rotation of the magnetism generator. The initial value determination section determines an initial value for the calculation angle before the magnetism generator starts relative rotation and at a predetermined time after the magnetism generator starts relative rotation. The angle computing section starts to execute the feedback control with using an initial value for the calculation angle determined by the initial value determination section.

In this case, the rotation sensor can shorten the time to compute a relative rotation angle while the magnetism generator makes relative rotation. This is because the initial value determination section can determine an initial value for the computed angle before the magnetism generator starts relative rotation and at a specified time after the relative rotation starts. A conventional rotation sensor always needs to use signal levels for the detection signals from the detection elements during relative rotation of the magnetism generator to determine the angular range covering the relative rotation angle. On the other hand, the sensor according the fourth aspect uses signal levels of the detection signals from the detection elements only in order to determine an initial value for the computed angle before the magnetism generator starts relative rotation and at a predetermined time after the relative rotation starts. The sensor need not compare a signal level of each detection signal from each detection element with a threshold value each time the magnetism generator makes relative rotation. It is possible to shorten the time to compute a relative rotation angle.

As an alternative, the initial value of the relative rotation angle may be defined as θ0, and the initial value of the calculation angle is defined as φ0. The angle computing section is capable of calculating the initial value θ0 for the relative rotation angle, which is available within a range of (φ0−90°)<θ0<(φ0+90′).

In this case, the angle computing section can accurately compute the relative rotation angle even when an initial value for the relative rotation angle actually exceeds the angular range determined by the initial value determination section. For example, FIG. 50 shows that the initial value determination section determines the angular range to be 0≦θ0<90° and the initial value φ0 for the computed angle is settled to be 45°. In this case, the range capable of computing the initial value θ0 for the relative rotation angle can be extended up to (45°−90°)<θ0<(45°+90°), i.e., −45°<θ0<135° (0°≦θ0<135° and 315°<θ0 360°). For example, let us suppose that the initial value determination section determines the angular range to be 0≦θ0<90° and the actual initial value θ0 is 120°. Since the angular range corresponding to the initial value φ0=45° includes 120°, the angle computing section can use the initial value φ0=45° for the computed angle φ to compute the initial value θ0=120° for the relative rotation angle θ. The relative rotation angle θ can be accurately computed even when the initial value θ0 or the initial value φ0 changes due to external noise or external magnetic field. It is possible to provide the rotation sensor that hardly degrades the detection accuracy even under the influence of external noise or external magnetic field.

As an alternative, the detection elements may be positioned so as to cause a phase difference of 90° between detection signals.

In this case, the detection elements can output detection signals having a phase difference of 90° each time the relative rotation angle with reference to the magnetism generator changes 90°. A combination of signal levels for the detection signals can be changed each time the relative rotation angle changes 90°. Accordingly, the initial value determination section can use the combination of signal levels for the output signals to determine the angular range covering the initial value for the relative rotation angle in units of 90°.

As an alternative, the relative rotation angle may be in a range between 0° and 360°. An angle of 360° is divided by a phase difference between output signals from each detection element to yield a value defined as n. A range between 0° and 360° is divided by n to provide n angular ranges. Combinations of the comparison results between a signal level for each of the detection signals and the predetermined threshold value in each of the angular ranges are different from each other.

In this case, the initial value determination section can improve the angular range determination accuracy. This is because each angular range provides a unique combination of comparison results between the signal level for each of the output signals and the threshold value.

As an alternative, each detection element may be a Hall element.

In this case, it is possible to acquire a detection signal whose signal level changes every cycle in accordance with the magnetic field intensity while the magnetism generator rotates one turn. In addition, the rotation sensor can be miniaturized because the Hall element can be formed in the semiconductor substrate.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A rotation sensor comprising:
a magnetism generator that generates a magnetic field;
a sensor chip having a magneto-resistance element region and a Hall element region, wherein the magneto-resistance element region includes a plurality of magneto-resistance elements, and the Hall element region includes a plurality of Hall elements; and
a detection circuit that detects a relative rotation angle in relation to the magnetism generator according to output signals from each magneto-resistance element and each Hall element,
wherein each magneto-resistance element provides a magneto-resistance effect with respect to the magnetic field;
wherein each Hall element provides a Hall effect with respect to the magnetic field;
wherein the plurality of magneto-resistance elements are arranged in the magneto-resistance element region so as to cause a phase difference between output signals of the magneto-resistance elements;
wherein the plurality of Hall elements are arranged in the Hall element region so as to cause a phase difference between output signals of the Hall elements;
wherein the magneto-resistance element region and the Hall element region at least partially overlap with each other;
wherein the detection circuit includes a comparison section, an angle computing section, and an output section;
wherein the comparison section compares an output level from each Hall element with a predetermined threshold value level, and provides a comparison result for each Hall element;
wherein the angle computing section calculates a calculation angle corresponding to the relative rotation angle according to an output signal from each magneto-resistance element;
wherein the output section compares the calculation angle with a predetermined threshold value, and provides a comparison result for each magneto-resistance element; and
wherein the output section outputs a signal corresponding to the relative rotation angle based on the comparison result of the output section and the comparison result of the comparison section.

2. The rotation sensor according to claim 1,
wherein almost a whole of the Hall element region overlaps with the magneto-resistance element region.

3. The rotation sensor according to claim 1,
wherein the magneto-resistance element region and the Hall element region overlap with each other in a direction of a relative rotation axis of the magnetism generator.

4. The rotation sensor according to claim 1,
wherein the magneto-resistance element region and the Hall element region are positioned approximately parallel to a relative rotational plane of the magnetism generator.

5. The rotation sensor according to claim 1,
wherein the magneto-resistance element region is positioned on a top side of the sensor chip;
wherein the Hall element region is positioned on a bottom side of the sensor chip; and
wherein the top side of the sensor chip faces a relative rotational plane of the magnetism generator.

6. The rotation sensor according to claim 1,
wherein the magneto-resistance element region is positioned on a top side of the sensor chip;
wherein the Hall element region is positioned on a bottom side of the sensor chip; and
wherein the bottom side of the sensor chip faces a relative rotational plane of the magnetism generator.

7. The rotation sensor according to claim 1,
wherein the magnetism generator includes a pair of different magnetic poles, which are divided in a radial direction of a relative rotational plane of the magnetism generator.

8. The rotation sensor according to claim 1,
wherein the magnetism generator includes a pair of different magnetic poles, which are positioned in a circumferential direction of a relatively rotating body.

9. The rotation sensor according to claim 8,
wherein the sensor chip is positioned between the pair of different magnetic poles.

10. The rotation sensor according to claim 1,
wherein the magnetism generator is a plurality of pairs of different magnetic poles.

11. The rotation sensor according to claim 1,
wherein each of the magneto-resistance elements and the Hall elements mainly detects a change in magnetic flux density of the magnetic field parallel to the magneto-resistance element region and the Hall element region.

12. The rotation sensor according to claim 1,
wherein each of the Hall elements is positioned to cause the phase difference of 90° between output signals of the Hall elements adjacent to each other.

13. The rotation sensor according to claim 1,
wherein each of the magneto-resistance elements is positioned to cause a phase difference of 45° between output signals of the magneto-resistance elements adjacent to each other.

14. The rotation sensor according to claim 1,
wherein the plurality of magneto-resistance elements provide a first half-bridge circuit and a second half-bridge circuit;
wherein the plurality of magneto-resistance elements are coupled with each other in a half-bridge manner so as to cause the phase difference of 90° between output signals from the magneto-resistance elements adjacent to each other so that the first and second half-bridge circuits are formed; and
wherein a phase difference between output signals from the first and second half-bridge circuits is 45°.

15. The rotation sensor according to claim 14,
wherein the magneto-resistance elements further provide another first half-bridge circuit and another second half-bridge circuit;
wherein the first half-bridge circuit and the another first half-bridge circuit are bridged to provide a first full-bridge circuit;
wherein the second half-bridge circuit and the another second half-bridge circuit are bridged to provide a second full-bridge circuit; and
wherein a phase difference between output signals from the first full-bridge circuit and the second full-bridge circuit is 45°.

16. The rotation sensor according to claim 15,
wherein the plurality of magneto-resistance elements included in the first and second half-bridge circuits are positioned concentrically and alternately.

17. The rotation sensor according to claim 12,
wherein a phase difference between a signal output from the output section and each of output signals from the Hall elements is 45°, respectively.

18. The rotation sensor according to claim 12,
wherein a range of the relative rotation angle is in a range between 0° and 360°;
wherein an angle of 360° is divided by the phase difference between output signals from the Hall elements to yield a value defined as n;
wherein a range between 0° and 360° is divided by n to provide n angular ranges; and
wherein combinations of the comparison results of the comparison section and the output section in each of the angular ranges are different from each other.

19. The rotation sensor according to claim 1,
wherein the angle calculating section calculates the relative rotation angle by performing feedback control so as to decrease a difference between the relative rotation angle and the calculation angle calculated with using a plurality of output signals that are output from the plurality of magneto-resistance elements and include phase differences.

20. The rotation sensor according to claim 1,
wherein each of the Hall elements is a vertical Hall element; and
wherein a planar direction of a magnetism detection plane of each Hall element intersects the magneto-resistance element region.

21. The rotation sensor according to claim 1,
wherein each magneto-resistance element and each Hall element are positioned on a semiconductor substrate.

22. The rotation sensor according to claim 1,
wherein each Hall element has a CMOS transistor structure.

23. The rotation sensor according to claim 22,
wherein each Hall element has a high-voltage CMOS transistor structure.

24. The rotation sensor according to claim 22,
wherein the Hall element includes:
a semiconductor substrate having a first conductive type;
a second conductive type semiconductor region that is positioned at a predetermined depth from a surface part in the semiconductor substrate;
a first conductive type semiconductor region that is arranged in the second conductive type semiconductor region shallower than the second conductive type semiconductor region so as to divide the second conductive type semiconductor region;
a second conductive type impurity diffusion region for a contact configured to be a power supply pair and arranged in a surface part of the second conductive type semiconductor region so as to sandwich the first conductive type semiconductor region; and
a second conductive type impurity diffusion region for a contact configured to be a voltage output pair and arranged in a surface part of the second conductive type semiconductor region, and
wherein at least a part of the magneto-resistance element region overlaps with the Hall element region through an insulating film.

25. The rotation sensor according to claim 1,
wherein each of the magneto-resistance elements is made of an NiFe thin film.

26. The rotation sensor according to claim 1,
wherein each of the magneto-resistance elements is made of an NiCo thin film.

27. A rotation sensor comprising:
a rotatable magnetism generator;
a plurality of magneto-electric conversion elements positioned in a magnetic field of the magnetism generator rotating relatively with the magneto-electric conversion elements, wherein each magneto-electric conversion element outputs a signal with a signal level changing at two cycles in accordance with an intensity of the magnetic field during one rotation of the magnetism generator, and wherein the magneto-electric conversion elements are positioned so as to cause a phase difference between signals of the magneto-electric conversion elements;
a detection circuit that detects a relative rotation angle with reference to the magnetism generator according to a signal output from each magneto-electric conversion element; and
a plurality of detection elements, wherein each detection element outputs a detection signal with a signal level changing at one cycle in accordance with an intensity of the magnetic field during one rotation of the magnetism generator, and wherein the detection elements are positioned so as to cause a phase difference between detection signals of the detection elements,
wherein the detection circuit includes an angle computing section, an initial value determination section, and an output section;
wherein the angle computing section calculates a calculation angle corresponding to a relative rotation angle according to a signal output from each magneto-electric conversion element;
wherein the angle computing section performs feedback control so that a difference between the relative rotation angle and the calculation angle converges on a predetermined value;
wherein the initial value determination section compares a signal level for each detection signal with a predetermined threshold value, and determines an angular range that includes an initial value for the relative rotation angle;
wherein the initial value determination section determines an initial value for the calculation angle so that an absolute value of a difference between the initial value for the calculation angle and the initial value for the relative rotation angle available in the determined angular range becomes smaller than 90°;
wherein the output section outputs a signal corresponding to the calculation angle at one cycle during one rotation of the magnetism generator;
wherein the initial value determination section determines the initial value for the calculation angle only before the magnetism generator starts relative rotation; and
wherein the angle computing section starts the feedback control with using the initial value for the calculation angle determined by the initial value determination section.

28. The rotation sensor according to claim 27,
wherein the initial value for the relative rotation angle is defined as θ0, and the initial value for the calculation angle is defined as φ0, and
wherein the angle computing section is capable of calculating the initial value θ0 for the relative rotation angle within a range of (φ0−90°)<θ0<(φ0+90°).

29. The rotation sensor according to claim 27,
wherein the plurality of detection elements are positioned so as to cause the phase difference of 90° between detection signals of the detection elements.

30. The rotation sensor according to claim 27,
wherein the plurality of magneto-electric conversion elements are positioned so as to cause the phase difference of 45° between signals of the magneto-electric conversion elements.

31. The rotation sensor according to claim 27,
wherein the relative rotation angle is in a range between 0° and 360°;
wherein an angle of 360° is divided by a phase difference between output signals from each detection element to yield a value defined as n;
wherein a range between 0° and 360° is divided by n to provide n angular ranges; and
wherein combinations of the comparison results between a signal level for each of the detection signals and a threshold value in each of the angular ranges are different from each other.

32. The rotation sensor according to claim 27,
wherein the relative rotation angle is defined as θ, and the calculation angle is defined as φ,
wherein the angle computing section performs feedback control with using a signal output from each magneto-electric conversion element so as to cause a difference of (2θ−2φ) to be 0; and
wherein the angle computing section utilizes an initial value determined by the initial value determination section as the initial value for the calculation angle of φ when the angle computing section starts to execute the feedback control.

33. The rotation sensor according to claim 32,
wherein the plurality of magneto-electric conversion elements output a sin 2θ signal and a cos 2θ signal;
wherein the angle computing section generates a sin(2θ−2φ) signal based on the sin 2θ signal and the cos 2θ signal;
wherein the angle computing section calculates a difference of (2θ−2φ) based on the generated sin(2θ−2φ) signal; and
wherein the angle computing section performs the feedback control so as to cause the difference of (2θ−2φ) to be 0.

34. The rotation sensor according to claim 33,
wherein the angle computing section includes a counter;
wherein the counter counts a count value corresponding to the calculation angle of φ;
wherein the angle computing section determines whether the difference of (2θ−2φ) is positive or negative; and
wherein the counter increases or decreases the count value of the counter based on a determination result of the difference of (2θ−2φ).

35. The rotation sensor according to claim 34,
wherein the angle computing section performs an arcsine operation on the sin(2θ−2φ) signal in order to calculate the difference of (2θ−2φ); and
wherein the angle computing section determines based on a calculation result of the difference of (2θ−2φ) whether the difference of (2θ−2φ) is positive or negative.

36. The rotation sensor according to claim 34,
wherein the angle computing section determines that the difference of (2θ−2φ) is positive when the sin(2θ−2φ) signal is greater than 0; and
wherein the angle computing section determines that the difference of (2θ−2φ) is negative when the sin(2θ−2φ) signal is smaller than 0.

37. The rotation sensor according to claim 27,
wherein each detection element is a Hall element.

38. The rotation sensor according to claim 27,
wherein each magneto-electric conversion element is a magneto-resistance element.

39. A rotation sensor comprising:
a rotatable magnetism generator;
a plurality of magneto-electric conversion elements positioned in a magnetic field generated by the magnetism generator relatively rotating, wherein each magneto-electric conversion element outputs a signal with a signal level changing at two cycles in accordance with an intensity of the magnetic field during one rotation of the magnetism generator, and wherein the magneto-electric conversion elements are positioned so as to cause a phase difference between signals;
a detection circuit that detects a relative rotation angle with reference to the magnetism generator according to the signal output from each magneto-electric conversion element; and
a plurality of detection elements, wherein each detection element outputs a detection signal with a signal level changing at one cycle in accordance with an intensity of the magnetic field during one rotation of the magnetism generator, and wherein the detection elements are positioned so as to cause a phase difference between detection signals,
wherein the detection circuit includes an angle computing section, an initial value determination section and an output section;
wherein the angle computing section calculates a calculation angle corresponding to a relative rotation angle according to the signal output from each magneto-electric conversion element;
wherein the angle computing section performs feedback control so that a difference between the relative rotation angle and the calculation angle converges on a predetermined value;
wherein the initial value determination section compares a signal level for each detection signal with a predetermined threshold value, and determines an angular range that includes an initial value for the relative rotation angle, based on a result of the comparison;
wherein the initial value determination section determines an initial value for the calculation angle so that an absolute value for a difference between the initial value for the calculation angle and the initial value for the relative rotation angle available in the determined angular range becomes smaller than 90°;
wherein the output section outputs a signal corresponding to the calculation angle at one cycle during one rotation of the magnetism generator;
wherein the initial value determination section determines the initial value for the calculation angle before the magnetism generator starts relative rotation and at a predetermined time after the magnetism generator starts relative rotation; and
wherein the angle computing section starts to execute the feedback control with using the initial value for the calculation angle determined by the initial value determination section.

40. A rotation sensor comprising:
a rotatable magnetism generator;
a plurality of magneto-electric conversion elements positioned in a magnetic field generated by the magnetism generator relatively rotating, wherein the plurality of magneto-electric conversion elements output a first signal and a second signal, each of which has a signal level changing at N cycles in accordance with an intensity of the magnetic field during one rotation of the magnetism generator, wherein N is a natural number, and wherein the magneto-electric conversion elements are positioned so as to cause a phase difference between the first signal and the second signal; and
a detection circuit that detects a relative rotation angle with reference to the magnetism generator according to the first signal and the second signal output from each magneto-electric conversion element,
wherein the detection circuit includes an angle computing section and an output section;
wherein the angle computing section calculates a calculation angle corresponding to the relative rotation angle with using the first signal and the second signal;
wherein the angle computing section performs feedback control so that a difference between the relative rotation angle defined as θ and the calculation angle defined as φ converges on a predetermined value;
wherein the output section outputs a signal corresponding to the calculation angle;
wherein the angle computing section generate a first cycle signal and a second cycle signal, each of which is modified by a predetermined shift amount, based on the first signal and the second signal output from the plurality of magneto-electric conversion elements;
wherein the angle computing section generates a difference of (Nθ−Nφ) by correcting the first cycle signal and the second cycle signal with using a correction value corresponding to the shift amount; and
wherein the angle computing section performs feedback control so that the difference of (Nθ−Nφ) approaches the predetermined value.

41. The rotation sensor according to claim 40,
wherein the magneto-electric conversion elements output a sin signal and a cos signal during one rotation of the magnetism generator;
wherein the angle computing section generates a sin(Nθ+α) signal and a sin(Nθ−α) signal modified by a predetermined shift amount defined as α based on the sin signal and the cos signal;
wherein the angle computing section generates an A sin(Nθ−Nφ) signal by correcting the sin(Nθ+α) signal and the sin(Nθ−α) signal with using a correction value corresponding to the shift amount; and
wherein the angle computing section performs feedback control so that a difference of (Nθ−Nφ) based on the A sin(Nθ−Nφ) signal approaches the predetermined value.

42. The rotation sensor according to claim 41, further comprising:
a storage section that preliminary stores the correction value corresponding to the shift amount,
wherein the angle computing section generates the sin(Nθ−Nφ) signal by acquiring the correction value from the storage section for correction.

43. The rotation sensor according to claim 40,
wherein the angle computing section performs feedback control with using a signal output from each magneto-electric conversion element so that a difference of (Nθ−Nφ) approaches 0.

44. The rotation sensor according to claim 40,
wherein the angle computing section includes a counter that counts a count value corresponding to the calculation angle of φ;
wherein the angle computing section determines whether the difference of (Nθ−Nφ) is positive or negative; and
wherein the counter increases or decreases the count value of the counter based on a determination result of the difference of (Nθ−Nφ).

45. The rotation sensor according to claim 41,
wherein the angle computing section includes a counter that counts a count value corresponding to the calculation angle of φ;
wherein the counter increases or decreases the count value of the counter based on a determination result; and
wherein the angle computing section performs an arcsine operation on the sin(Nθ−Nφ) signal to calculate the difference of (Nθ−Nφ) and, based on a calculation result of the difference of (Nθ−Nφ), determines whether the difference of (Nθ−Nφ) is positive or negative.

46. The rotation sensor according to claim 41,
wherein the angle computing section includes a counter that counts a count value corresponding to the calculation angle of φ;
wherein the angle computing section determines whether the difference of (Nθ−Nφ) is positive or negative;
wherein the counter increases or decreases the count value of the counter based on a determination result of the difference of (Nθ−Nφ);
wherein the angle computing section determines that the difference of (Nθ−Nφ) is positive when the sin(Nθ−Nφ) signal is greater than 0; and
wherein the angle computing section determines that the difference of (Nθ−Nφ) is negative when the sin(Nθ−Nφ) signal is smaller than 0.

47. The rotation sensor according to claim 40,
wherein each magneto-electric conversion element is a magneto-resistance element.

48. The rotation sensor according to claim 40, further comprising:
a plurality of detection elements,
wherein the magneto-electric conversion elements output a sin 2θ signal and a cos 2θ signal, each of which has a signal level that changes at two cycles in accordance with intensity of the magnetic field during one rotation of the magnetism generator;
wherein the plurality of detection elements output a detection signal having a signal level that changes at one cycle in accordance with intensity of the magnetic field during one rotation of the magnetism generator;
wherein the plurality of detection elements are positioned so as to cause a phase difference between detection signals;
wherein the detection circuit further includes an initial value determination section;
wherein the initial value determination section compares a signal level of each detection signal with a predetermined threshold value, and determines an angular range that includes an initial value for the relative rotation angle, based on a comparison result;
wherein the initial value determination section determines an initial value for the calculation angle so that an absolute value for a difference between the initial value for the computed angle and the initial value for the relative rotation angle available in the determined angular range becomes smaller than 90°;
wherein the output section outputs a signal corresponding to the calculation angle at one cycle during one rotation of the magnetism generator;
wherein the initial value determination section determines an initial value for the calculation angle only before the magnetism generator starts relative rotation; and
wherein the angle computing section starts to execute the feedback control with using the initial value for the calculation angle determined by the initial value determination section.

49. The rotation sensor according to claim 40, further comprising:
a plurality of detection elements,
wherein the magneto-electric conversion elements output a sin 2θ signal and a cos 2θ signal, each of which has a signal level that changes at two cycles in accordance with an intensity of the magnetic field during one rotation of the magnetism generator;
wherein the detection elements output a detection signal having a signal level that changes at one cycle in accordance with an intensity of the magnetic field during one rotation of the magnetism generator;
wherein the detection elements are positioned so as to cause a phase difference between detection signals;
wherein the detection circuit further includes an initial value determination section;
wherein the initial value determination section compares a signal level of each detection signal with a predetermined threshold value, and determines an angular range that includes an initial value for the relative rotation angle with using a comparison result;
wherein the initial value determination section determines an initial value for the calculation angle so that an absolute value for a difference between the initial value for the calculation angle and the initial value for the relative rotation angle available in the determined angular range becomes smaller than 90°;
wherein the output section outputs a signal corresponding to the calculation angle at one cycle during one rotation of the magnetism generator;
wherein the initial value determination section determines the initial value for the calculation angle before the magnetism generator starts relative rotation and at a predetermined time after the magnetism generator starts relative rotation; and
wherein the angle computing section starts to execute the feedback control with using the initial value for the calculation angle determined by the initial value determination section.

50. The rotation sensor according to claim 47,
wherein the initial value of the relative rotation angle is defined as θ0, and the initial value of the calculation angle is defined as φ0, and
wherein the angle computing section is capable of calculating the initial value θ0 for the relative rotation angle, which is available within a range of (φ0−90°)<θ0<(0+90°).

51. The rotation sensor according to claim 47,
wherein the detection elements are positioned so as to cause the phase difference of 90° between detection signals.

52. The rotation sensor according to claim 47,
wherein the relative rotation angle is in a range between 0° and 360°;
wherein an angle of 360° is divided by a phase difference between output signals from each detection element to yield a value defined as n;
wherein a range between 0° and 360° is divided by n to provide n angular ranges; and
wherein combinations of the comparison results between a signal level for each of the detection signals and the predetermined threshold value in each of the angular ranges are different from each other.

53. The rotation sensor according to claim 47,
wherein each detection element is a Hall element.
